(19) United States
(12) Patent Application Publication
(10) Pub. No.: US 2014/0152869 A1
(43) Pub. Date: Jun. 5, 2014

(54) Methods and Systems for Social Overlay Visualization

(71) Applicant: Simon Solotko, Austin, TX (US)

(72) Inventor: Simon Solotko, Austin, TX (US)

(21) Appl. No.: 14/232,376

(22) PCT Filed: Jul. 11, 2012
(86) PCT No.: PCT/US2012/046179

§ 371 Date: Jan. 13, 2014

Related U.S. Application Data
(60) Provisional application No. 61/507,130, filed on Jul. 13, 2011.

(51) Int. Cl. H04N 5/232

(52) U.S. Cl. CPC H04N 5/23293
USPC 348/231.3

(57) ABSTRACT

In at least some embodiments, a computer system includes a processor and a storage device coupled to the processor. The storage device stores a program that, when executed, causes the processor to generate information for social overlay visualization based on dynamic visual signals.

### CROSS-REFERENCE TO RELATED APPLICATIONS

This application is a 35 U.S.C. §371 national stage application of PCT/US2012/046179 filed Jul. 11, 2012, which claims priority to U.S. provisional patent application Ser. No. 61/507,130, filed Jul. 12, 2011, and entitled “Global Dynamic Visual Signaling”, both of which are hereby incorporated by reference in their entirety for all purposes.

### BACKGROUND

Consumers are employing wireless mobile computing devices such as smart phones and tablet computers to access online social information provided by individuals and institutions. Presently, individuals and institutions lack a mechanism for broadcasting online information about themselves, their institutions, or their interests which can be immediately recognized by nearby individuals and visually associated with them.

Solutions which can uniquely assign identity, for example, a bar code, can be extremely difficult to electronically discern at a distance. Name tags may not provide adequate data to provide a link to online data and may by revealing a named identity provide more personal information than an individual would like to reveal in all public settings. Visual digital tags, a kind of two dimensional bar code, may be difficult to discern electronically at a distance and by displaying a static identity may allow individuals to be tracked by any observer or network of observers sacrificing privacy data.

Location-based services rely upon user updates to discrete locations. Keeping location data up to date and accurate can be tedious and failure to update leads to incomplete or old check-in data. Individuals moving from one place to another drop out of a checked-in status, and these solutions do not enable a viewer to look around a room and assign information to individuals directly. GPS limits precision to 5 to 10 meters and lacks moment-to-moment consistency in estimating position, making it difficult to form maps of multiple individuals with accurate positions, relative positions, and data associations.

Yet, many individuals may wish to broadcast information about themselves, their state, and the state of their applications and life endeavors while on the go, in many public or small group settings, with the ability to choose their degree of anonymity, the nature of the information being conveyed, and set conditions about when information is revealed. Other individuals or institutions may wish to observe and respond to this information and to directly associate the information with people and spaces in their visual purview or vicinity. Individuals may be curious about the people around them, and the people around them may wish to reveal something about themselves, their business, and their ideas.

Individuals are often close together and in motion; therefore, reliable associations of data with people requires the capability to discern position within inches within a fraction of a second. Retaining a memory of such associations and interactions over time may be useful in creating a personal record allowing individuals have a memory of their social interactions and to trace the history of associations over time. Furthermore a solution which can scale by providing recognition locally and precisely but can provision identity, social data, and application state data globally would allow users to broadcast and observe while moving from place to place without the need to remain in a confined region.

### BRIEF DESCRIPTION OF THE DRAWINGS

For a detailed description of exemplary embodiments of the invention, reference will now be made to the accompanying drawings in which:

FIG. 1 illustrates an social overlay visualization system in accordance with an embodiment of the disclosure;

FIG. 2 illustrates a communication intermediary unit in accordance with an embodiment of the disclosure;

FIG. 3 illustrates a signal generation unit in accordance with an embodiment of the disclosure;

FIG. 4 illustrates an social overlay visualization interface unit in accordance with an embodiment of the disclosure;

FIG. 5 illustrates a server computer in accordance with an embodiment of the disclosure;

FIG. 6 shows various example questions or desires related to a social/online space interface in accordance with an embodiment of the disclosure;

FIG. 7 illustrates another system in accordance with an embodiment of the disclosure;

FIGS. 8A-8I illustrate dynamic visual signal patterns in accordance with embodiments of the disclosure;

FIGS. 9A-9F illustrate signal generation units in accordance with embodiments of the disclosure;

FIG. 10 illustrates a signal encapsulation and rendering technique in accordance with an embodiment of the disclosure;

FIG. 11 illustrates broadcasting and observation of dynamic visual signals in accordance with an embodiment of the disclosure;

FIG. 12 illustrates a data overlay scenario when observing multiple dynamic visual signaling devices in accordance with an embodiment of the disclosure;

FIG. 13 illustrates a data overlay technique related to the data overlay scenario of FIG. 12 in accordance with an embodiment of the disclosure;

FIG. 14 illustrates another data overlay scenario in accordance with an embodiment of the disclosure;

FIG. 15 illustrates a scenario with multiple simultaneous data overlays in accordance with an embodiment of the disclosure;

FIG. 16 illustrates a scenario with use of multiple instances of a limited signal set for distinct amebic vicinities in accordance with an embodiment of the disclosure;

FIG. 17 illustrates a scenario for multiplexing dynamic visual signals in accordance with an embodiment of the disclosure;

FIG. 18 illustrates an social overlay visualization recording operation in accordance with an embodiment of the disclosure;

FIGS. 19A and 19B illustrate vicinity change scenarios over time in accordance with embodiments of the disclosure;

FIG. 20 illustrates a hybrid signaling scenario in accordance with an embodiment of the disclosure;

FIG. 21 illustrates a hybrid signaling technique related to the hybrid signaling scenario of FIG. 20 in accordance with an embodiment of the disclosure;

FIG. 22 illustrates an infrared use scenario in accordance with an embodiment of the disclosure;

FIG. 23 illustrates a check-in data scenario in accordance with an embodiment of the disclosure;

FIG. 24 illustrates a check-in data technique related to the check-in data scenario of FIG. 23 in accordance with an embodiment of the disclosure;

FIG. 25 illustrates user interface scenario for signal generation units in accordance with an embodiment of the disclosure;

FIG. 26 illustrates a dynamic signal broadcasting hub technique in accordance with an embodiment of the disclosure;

FIG. 27A illustrates a dynamic signal broadcasting hub scenario related to the dynamic signal broadcasting hub technique of FIG. 26 in accordance with an embodiment of the disclosure;

FIG. 27B illustrates another dynamic signal broadcasting hub scenario related to the dynamic signal broadcasting hub technique of FIG. 26 in accordance with an embodiment of the disclosure;

FIG. 28 illustrates a dynamic signaling bandwidth and frame acquisition information in accordance with an embodiment of the disclosure;

FIG. 29 illustrates a scenario for addition of generational dynamic visual signals in accordance with an embodiment of the disclosure;

FIG. 30 illustrates a scenario for addition, subtraction, and re-queuing of generational dynamic visual signals in accordance with an embodiment of the disclosure;

FIG. 31 illustrates a scenario for time sequencing and scheduling of generational dynamic visual signals in accordance with an embodiment of the disclosure;

FIG. 32 illustrates a dynamic visual signal broadcasting method in accordance with an embodiment of the disclosure;

FIG. 33 illustrates a dynamic signal allocation method in accordance with an embodiment of the disclosure;

FIG. 34 illustrates another dynamic signal broadcasting method in accordance with an embodiment of the disclosure;

FIG. 35 illustrates a social data dissemination method in accordance with an embodiment of the disclosure;

FIG. 36 illustrates a social data overlay method in accordance with an embodiment of the disclosure;

FIG. 37 illustrates a method for dissemination of dynamic visual signal instructions in accordance with an embodiment of the disclosure;

FIG. 38 illustrates another method for dissemination of social data in accordance with an embodiment of the disclosure; and

FIG. 39 shows components of a computer system in accordance with an embodiment of the disclosure.

### NOTATION AND NOMENCLATURE

Certain terms are used throughout the following description and claims to refer to particular system components. As one skilled in the art will appreciate, individuals and organizations may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . . ” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection.

### DETAILED DESCRIPTION

The following discussion is directed to methods and systems for facilitating social overlay visualization. As used herein, “social overlay visualization” refers to overlaying social data on a camera-based image or series of images in real-time or near real-time. In the disclosed social overlay visualization concept there are signaling participants with signaling devices and observing participants with observing devices. The signaling participants employ at least one signaling device to broadcast: 1) an identifier or identifiers that can be used by an observing device to retrieve social data from a social data repository; and/or 2) social data. Meanwhile, observing participants employ at least one observing device to display a camera-based image or video with an overlay of social data based on signals received from nearby signaling devices. The signaling participants/devices may operate in conjunction with at least one intermediary host device to communicate with a control system for operations such as location tracking operations, signal dissemination operations, signal broadcast acknowledgement operations, signaling personalization operations, application data personalization operations, and social data personalization operations. Likewise, the observing participants/devices may operate in conjunction with at least one intermediary host device to communicate with a control system for operations such as location tracking operations, signal interpretation operations, social data retrieval operations, social data display operations, application data personalization operations, and social data personalization operations. Without limitation, the social overlay visualization techniques described herein may be referred to as a type of augmented reality.

Without limitation to other embodiments, the disclosed techniques for social overlay visualization may rely on cloud-based storage and dissemination of social data. Further, the disclosed techniques for social overlay visualization may rely on cloud-based storage and dissemination of application state data. Further, the disclosed techniques for social overlay visualization may rely on cloud-based storage and dissemination location-specific visual signal coding to signal generation units. The signal generation units may be interchangeably referred to herein as dynamic visual signal devices or simply signaling devices. Further, the disclosed techniques for social overlay visualization may rely on communication intermediary devices having both long-range wireless and short-range wireless mechanisms to route data between cloud-based servers for social overlay visualization and the signal generation units. The communication intermediary devices may be interchangeably referred to herein as host devices. Further, the disclosed techniques for social overlay visualization may rely on various social overlay visualization interface units. The social overlay visualization interface units may be interchangeably referred to herein as dynamic visual signal receiving devices or simply signal receiving devices. The social overlay visualization interface units may observe dynamic visual signals emitted by signal generation units in their vicinity, decode/convey the dynamic visual signal, access/receive stored social data for an social overlay visualization participant associated with an observed dynamic visual signal, and display an observed image or series of images with the accessed/received social data (or related information) integrated into or overlaid onto the displayed image. Without limitation to other embodiments, the social overlay visualization interface units may implement various technologies such as infrared, 3-dimensional observation, geometric shape analysis, fixed code detection, and wireless communications to expedite detection of dynamic visual signals and/or to supplement the information provided by dynamic visual signals.

In accordance with some embodiments, the disclosed social overlay visualization techniques may be described as server-side operations and client-side operations. The server-side operations include maintaining a data store of social data, dynamic signal codes and instructions, participant preferences, signal generation unit information, social overlay visualization interface unit information, social overlay visualization instructions, and/or other data/instructions. Without limitation to other embodiments, the server-side operations may include providing an interface to gather and organize social data for participants, disseminating dynamic signal coding information to signal generation units, organizing location data for signal generation units and/or social overlay visualization interface units, disseminating social data to social overlay visualization interface units. Meanwhile, the client-side operations may include signal generation unit operations and/or social overlay visualization interface unit operations responsive to information and/or instructions provide from social overlay visualization servers. The social overlay visualization servers may be cloud servers or other network servers. The communications between social overlay visualization servers and signal generation units and/or social overlay visualization interface units may be wired or wireless. Further, the communications between social overlay visualization servers and signal generation units may involve intermediary devices that forward information between social overlay visualization servers and signal generation units. The communications between a social overlay visualization server and an intermediary host device may be wired or wireless. Similarly, the communications between an intermediary host device and a signal generation unit may be wired or wireless.

There are several objects and features of the disclosed social overlay visualization techniques. Overlaying and fusing social and commercial information with visual and spatial accuracy is a major innovation in mobile personal communication. Information stored online by social networks can now be communicated to observers in real spaces, visually and logically associated with the signaling individual or commercial entity. The signaling device is able to convey identity and state information while adapting to changes in physical location by sending signals which are different and distinguishable at a distance from other nearby signaling devices. Allocation of a limited signal set in a local area creates minimal overlap allowing individuals within a local area to distinguish one another. One disclosed feature is that as individuals move from one local area to another, signal and state allocation software ensures the user signal is distinct from new nearby individuals and re-allocating signals to avoid overlap within a local area resulting in a communication system of identity and state information which can be scaled over extremely large areas with little bandwidth required per signaling device for the identity and state assignment system.

Another disclosed feature is the link between a signal broadcasting device and the dynamic signal allocation software which defines vicinities with variability in size, shape, geospatial location, and membership. As used herein, “vicinities” refer to signal maps with amebic shape of unique primary signal assignment which avoid overlap with other regions of unique primary assignment. The advantage of dynamically adjusting the composition of a vicinity is maintaining accuracy in line of sight identity association & state communication between signal broadcasting devices and signal receiving/sensing devices. In at least some embodiments, a vicinity is maintained at maximal size to maintain best potential for line of sight coverage of contained signal broadcasting devices but will diminish in size and adjust dimensions to avoid employing the same signal for multiple broadcasting devices. Another disclosed feature is mapping to a group of signaling devices who share common movement patterns, such as signaling devices whose associated users are riding on a train and are thus moving selectively with a full set or subset of other individuals in a shared movement patterns.

Another disclosed feature related to employing dynamic signals and/or generational dynamic signals is compensation for uncertainty in line of sight and timeliness of position data through mapping of multiple vicinities to a signal broadcasting device. Multiple state and vicinity mappings can be assigned to an individual corresponding to past and potential vicinity associations while maintaining a little or no overlap in any given vicinity assignment. In addition, vicinities instantiate rules specific to their location, social attributes and characteristics of individuals, varieties of state data, and characteristics of the signal broadcasting device as individuals move from vicinity to vicinity. Multiplexing dynamic signals is ordering signals such that a signal broadcasting devices and individuals may be simultaneously identified across multiple vicinities employing primary, secondary, tertiary and beyond generational signal assignments. An identity and state data can be assigned to vicinities and lines of sight likely but not guaranteed to an individual through signal multiplexing without creating false positives associated with multiple instances of the same signal in the same vicinity in the same multiplex position. Multiplexing also permits broadcast of identity mapped signals with state data, allowing applications which require assignment of identity to state data.

In the case where the observing device utilizes a nearly transparent display, the observing device may be employed to simultaneously broadcast dynamic signals and to serve as a useful primary display for the visual interface including social overlay. The primary display has the advantage of displaying a visual signal while re-displaying the background or retaining transparency and overlay social data.

For example, when employing the disclosed social overlay visualization in a game of chess, individuals can visually broadcast both the identity of the player and their game state updates/moves with generational dynamic visual signals, with the benefit that neither datum can be discerned by individuals who lack permission defined by user established rules to access that information. One feature of the disclosed social overlay visualization is that rules can be employed to limit access to social data or state data such that non-participants in a game are unaware of any identities that may be communicated, that a game of chess is being played, or even that the individuals are playing at all. Another feature is that a specific location bound to a signal broadcasting device may be assigned with multiple players viewing the game as if it exists in a commonly defined or distributed real space, enabling for example a virtual chess board to be visible as an overlay to real space.

Unlike a fixed signal, such as a digital name tag, facial features, or bar codes, each signaling device employs a dynamic visual signal that is temporarily bound thereto making it impossible to employ the signal as a determinant tracking device. In this manner, individuals can roam knowing that signals sent cannot be employed to track their movements. Unlike facial features or digital bar codes, an advantage is that small, dynamic visual signal sets are easily employed making it possible for signal receiving devices to employ lower resolution and lower cost digital cameras and to accurately detect broadcast signals at a great distance. With facial recognition technology a device must decompose facial features into fine geometries with significant accuracy from a huge set of possible angles making detection at a distance with individuals in random positions computationally intense, whereas an advantage of the invention is employing colored light shapes which have simpler geometry and significantly lower computational requirements for accurate recognition. Unlike exclusively radio frequency (RF) solutions which seek to send a detectable location beacon to a specialized RF radio in an observing device, many existing camera-equipped phones can be employed to accurately detect visual signals and run signal detection software. Physical space separates signaling elements making many visual lanes available for sending and receiving signals whereas RF solutions suffer the disadvantage of sharing frequency space or employing a broad range of expensive and potentially restricted bands which vary from country to country.

In some embodiments, signal recognition software allows the user of the signal receiving device to create a range of functions useful in everyday social life. For example, users may establish rules which are employed by the disclosed social overlay visualization system to produce visual alerts; audio alerts; automated suggestion of action; receive and respond to commercial messages, advertisements, and information; generate automated output of related social information; view a visual presentation of information provided by an individual or commercial entity employing the signaling device; display an active and graphical rendering of an avatar; display a two or three dimensional graphic; create or change online information or social relationships; modify or respond to state information such as making a game move; and/or send a message to the individual or entity assigned to the signaling device.

In at least some embodiments, social overlay visualization techniques may utilize a separate signal broadcasting device employed as a peripheral to a mobile device, which has the advantage of cross-platform compatibility and the ability to be employed with a broad range of mobile platforms and confer to those platforms the ability to broadcast identity, social data, and application state data to nearby observers. The symbiosis of the peripheral signaling device with a host mobile device provides a powerful computational platform for hosting signal management, social networking, and application software. Observing devices have the advantage of employing cameras already popular in ultra-mobile platforms simplifying design of dynamic visual signaling devices.

In some embodiments, the incorporation of a curved display surface for a dynamic visual signaling device is employed to provide a broader area of visual broadcast for device signals and geometric opportunities for signal multiplexing. On a curved form such as a bracelet time generational dynamic visual signals may be sequentially displayed in rotation around the curved form allowing for broadcast of a generational signal to a wide area, increasing the potential locations for an observing device to detect and interpret the signal. A curved surface dynamic visual signaling device provides a multiplicity of viewing positions for an observing device relative to the signaling device.

In some embodiments, dynamic visual signal technology is implemented with smart mobile devices permitting signals to be recognized by a broad range of devices not limited to one model. Dynamic visual signaling may operate as a common language between mobile platforms. Augmenting social interactions with online information enables the fusion of online and offline realities creating new modes of personal and institutional communication.

Without limitation to other embodiments, the use of multiple dynamic signaling devices by a single individual increases the number of signals available to observing devices with the benefit of permitting multiple viewing angles given multiple body or nearby signal device placements. In one example, a single identity is mapped to each signaling device, creating a multiple signals with multiple potential viewing angles while indicating the same underlying identity with the benefit of increasing the probability of the identity being detected by observing devices. Users may employ multiple instances of the signaling device to create more viewing angles for the same signal set by duplicating the signal set. In addition to the above example, multiple dynamic signaling devices may be employed by the same individual to create multiple independent identities by assigning independent profiles to each device, and/or to create the opportunity for state information to map the same identity but different state data to multiple devices.

The utilization of a camera-equipped mobile platform to observe dynamic visual signals permits signals to be collected for association with online identities while simultaneously providing the visual reference of the location of the visual signaling device upon the background scene including the objects and individuals employing dynamic visual signaling devices. The combination of visual sensing, computational capability, and visual output to detect a plurality of signal broadcasting devices simultaneously has the advantage of permitting broadcast signals to be received, interpreted, displayed and stored with individual and group dynamics, interaction, virtual object manipulation, environmental factors, and availability of online information to be taken into account. Combinations of the underlying scene and detected broadcast signals allows the position of the signal as well as the identity and social data revealed with the broadcast signal to be fused into an output which places the social data in a useful and accurate placement relative to the actual scene such that the viewer can associate social data with the correct individuals and groups.

Another feature of dynamic visual signal broadcast in a network configuration is observing devices obtain and utilize signal mapping and data for nearby users and devices. Dynamic visual signaling devices allow information about a user's state and identity to be transmitted and modified locally with direct associations between observer and broadcasters in a real-space field of view. Further, dynamic visual signaling devices encode identity and state and social data, allowing complex data to be transmitted locally and openly. Further, dynamic visual signaling devices enable control of privacy and identity protection through the abstraction of the signal and its potential for rapid change in ways not discoverable outside of the context of the signal allocation software.

In some embodiments, state and social allocation software communicates signal mapping and data for nearby users over a network such as the Internet or the Internet in conjunction with a cellular broadband network. Further, updates to social data and application state data may be made by users of host devices and by those with those in interaction, conveyed locally or updated over the network through communication to social and state database software with the advantage of permitting modification and broadcast of social and application state data back and forth between observing devices and the host devices signal broadcasting devices.

Dynamic visual signal broadcast as described herein makes information available for interaction and modification by others. One feature of conveying signals mapped to identity data is the creation of associations with social data including personal information and information about the user, their current state, messages, personal data, visualization choices, and interactive applications, sub-applications and widgets that allow users to retain, communicate, and interact. Applications may be activated by device users and the state of these applications inserted into a signal stream to form a generational signal or retained online bound to the identity associated with the dynamic visual signal broadcasting device.

Broadcasting identities and state data as described herein may be used to provide a spatial context for a device, its user and applications. Applications, for example, may be presented against a background scene (camera view) corresponding to the device or device user. The applications may enable presentation of virtual objects, messages, personal data, visualization choices, interactive applications, sub-applications and widgets that allow users retain social data and state data, to communicate, and to interact. Further, application state data may be shared among many users, as in a virtual game, a virtual event, a virtual gathering, a shared document or interactive graphic, a commercial transaction engine such as a virtual storefront, status of a financial or non-financial transaction, and web-technology based applications.

As disclosed herein, dynamic visual signaling devices are observed by smart mobile devices able to visually scan and parse identity, social data, and application state information from dynamic visual signals to create visually rich and spatially accurate visualizations and real-world overlays allowing interaction in a live, real-world context. A further advantage is creating an abstraction between real identity from projected identity from signal identity, allowing users to move and change signals while observers continue to track them, but without needing to reveal specific information such as user names or private data.

In accordance with the invention there are identities allocated visual signals from a signal vocabulary comprised of visually distinct colored and shaped elements prepared electronically and displayed visually. The identities and associated signals being maintained in a dynamic and near real-time mapping.

The signal vocabulary may be comprised of more than one visual signal. For example, signals may be dynamically generated based on location and/or proximity of participants to form at least one unique signal for each identity. Further, already allocated signals for a vicinity may be considered when generating a new signal. The signal vocabulary being allocated in multiple instances with each instance corresponding to a defined region or vicinity to permit any number of identities to be allocated a signal from a finite signal set.

The signals corresponding to each identity are maintained in a dynamic mapping system. The instances of signal allocation and their respective identities and geographic locations and spatial boundaries comprise a vicinity map, a multi-instance geographic map of allocated signal sets. The distances between instances of allocated signals are composed to generally maximize the distances between identical signals and generally minimize the overlap between boundaries.

Identities that pass into the boundary area of a new vicinity are assigned new dynamic visual signals from the signal set of the new vicinity. In other words, the identities are mapped to a new vicinity and signal. In some variations, boundary overlap or movement of an identity from one vicinity to another is managed by mapping multiple signals to a single logical identity in a visual or time sequence to maintain mappings to the vicinities applying to each signal and over time or through subsequent movement eliminating prior vicinity identity signals.

In some variations, signals are composed of multiple signal elements from a signal vocabulary comprised of colored and shaped elements, the signal elements being displayed and broadcast over a short period of time to implement time multiplexing for the dynamic visual signal. In some variations the dynamic visual signal elements are reproduced in a geometric configuration to permit multiple visual elements of a signal to be displayed and broadcast simultaneously. In some variations the signal elements being reproduced in a geometric configuration are displayed and broadcast over a short period of time to implement time multiplexing for a spatial arrangement of signal elements. In some variations, multi-element signals are produced in a spatial arrangement and correspond to a generational sequence of signals which interpreted together provide mapping to data such as identity, social data, and applications states broadcasted by the user or device. In some variations, the signals are mapped to an underlying data interpretation where the underlying data interpretation is similarly retained and may be remapped. In other words, signals may be re-assigned while the identity mapping and data interpretation remain the same. Without limitation to other embodiments, dynamic visual signals may be based on a presentation pattern comprising colored square elements in a 2D matrix array; a colored sequential array, a rotating linear color array of elements; a shaped color matrix; a color shaped color non-uniform matrix or linear array; a curve distorted color shaped array; a 3D color shaped matrix or array, a non-uniform shaped linear array or matrix; a shaped and beamed light projection; an overlapping collage or montage of spatially aligned signals; and combinations of dynamic generational signals with data-conveying and non-data conveying static elements.

In accordance with some embodiments, a signaling device may have a signaling element, geospatial location data or user provided location data, signal management software, and a network connection to state and identity server software that assigns and disseminates signals for signaling devices. Signals are temporarily assigned to mobile signaling devices and modified according to commands sent by state and identity server software. This software allocates signals among a plurality of signaling devices, assigns signals and avoids duplicate signals on nearby signaling devices.

In one embodiment the signaling device is worn around the neck or on the wrist. For example, Bluetooth connectivity between the signaling element and a mobile platform (e.g., a cell phone or smart phone) may be employed, where the signaling element is a peripheral to the mobile platform. The mobile platform may execute signal management software which accesses geospatial location data from the phone's integrated GPS and/or user supplied location data, and provides a network connection to the internet-based state and identity server software. In some embodiments, the signal management software displays signals on a local display and a secondary display of the mobile platform when a stand-alone signaling element is not available.

In accordance with some embodiments, a variable number of distinct signals is employed by the signaling device at any given time as commanded by online signal allocation software transmitted over the Internet from the online signal allocation software to the host device. The host device broadcasts the signal visually through an integrated display and transmits the signal, with additions to social data and application state data based upon local inputs, to the signal broadcasting device creating multiple points at which the broadcast signal is broadcast. Thus, multiple broadcast points may create multiple opportunities for the broadcast signal to be observed. In some variations the signaling device and its signaling display is a worn as a pendant; an electronic bracelet; an electronic watch; a display surface such as a table or a tablet; a smart phone; an evolved purse or bag; a walkie-talkie; an evolved billboard; a headset; or body conforming gear. In some variations the signaling device and the host function are integrated creating a single device for updating and interacting with applications and providing control over the broadcast of identity, social data, and application state data. In some variations, Bluetooth connectivity is replaced by other personal area network connectivity technologies to carry data and/or signaling instructions to a dynamic visual signaling device.

Further, in accordance with at least some embodiments, there is an observing signal receiving device which contains a digital camera, access to location data, network connectivity, signal recognition software, and output devices including a screen, speaker, and visual indicator. The signal receiving device receives signal assignment information for nearby signal broadcasting devices.

Signal recognition software within the receiving device may perform functions such as receiving from signal allocation software the identity, application state, and social data for nearby signal broadcasting devices, acquiring images of a real-world scene, observing and distinguishing signals and their position within the scene, spatially mapping those signals to signaling devices in close proximity, applying social and state rules to the spatially mapped devices, and forming an image overlay of identity and state information on the receiving device. The signal recognition software aligns identity and state information with a visual image of the actual scene to create a sequence of scenes with an overlay of identity, social data and associated application state information. In addition the signal recognition software allows the user of the signal receiving device to establish rules to produce visual alerts; audio alerts; automated suggestion of action; commercial messages, advertisements, and information; an automated output of related social information; a visual presentation of information provided by an individual or commercial entity employing the signaling device; a graphical rendering of an avatar; a two or three dimensional graphic; the presentation of an opportunity to create or change a relationship; the opportunity to modify or respond to state information such as making a game move; the capability to send a message to the individual or entity assigned to the signaling device; and initiating a financial transaction including the exchange of funds, bids, credits, coupons, and account information.

In some variations, the observing device collects visual sensor information in a stereoscopic array with dimensionally enhanced visual output including 3D display, head tracking, and enhanced placement of visualizations. In some variations the observing device collects infrared images in conjunction with visual images with an infrared imaging camera or camera array processing that imagery into body forms to locate positions for signaling devices worn by individuals and provide additional context for placement of visualizations and tracking when the signaling device is intermittently occluded. Augmentation with 3D infrared data via stereoscopic imaging also may permit additional depth and positional data for visualization presentation and visualization. Augmentation with 3D visual presentation permits point-of-view specific visual representation and 3D visualization based on dynamic visual signal identity, social data and application state data.

In some variations, an observing device employs a transparent display solution with reflective display elements to display social overlay data without the need for back lighting and to simultaneously broadcast dynamic visual signals to observing devices on the opposite side of the observing device (i.e., the non-user facing side of the device).

The disclosed social overlay visualization is based, at least in part, on dynamic visual signals to identify participants so as to overcome various challenges related to use of facial data or physical tags. These challenges include, but are not limited to, the feature size being small and requiring up-close observation, tags can be deterministically tracked, facial data controversy may lead to legislation, processing and connectivity challenges, not particularly sexy or fun, darkness obscures tags and facial geometry cues. The disclosed social overlay visualization also seeks to overcome issues related to gathering data from online sources, data overlay issues, awkward voyeurism of holding up a smartphone in public, supporting anonymous participants, and enabling participants to vary what can be known via social overlay visualization.

In at least some embodiments, multi-purpose (combo devices) devices are employed in the disclosed social overlay visualization to perform dynamic visual signaling device operations (e.g., to broadcast identity, state, and/or social information) while also serving as social overlay visualization interface unit or signal receiving unit. For example, visual signals may be broadcast and observed by smart mobile devices able to visually scan and parse identity, social data, and application state information from dynamic visual signals to create visually rich and spatially accurate visualizations and real-world overlays allowing interaction in a live, real-world context. The disclosed social overlay visualization creates an abstraction between real identity from projected identity from signal identity, and allows users to move and change signals while observers continue to track them, but without needing to reveal specific information such as user names or private data.

The dynamic visual signalizing devices may be worn as digital jewelry, bejeweled mobile technology devices, consumer product surfaces, electronic signage, bags and packs, vehicles, doors, buildings—virtually any surface where identity, online information, and real space matter. The disclosed social overlay visualization paves the path for a new age of digital memories and social computing, one available at all times, infusing online information into daily life and transforming social and real world awareness.

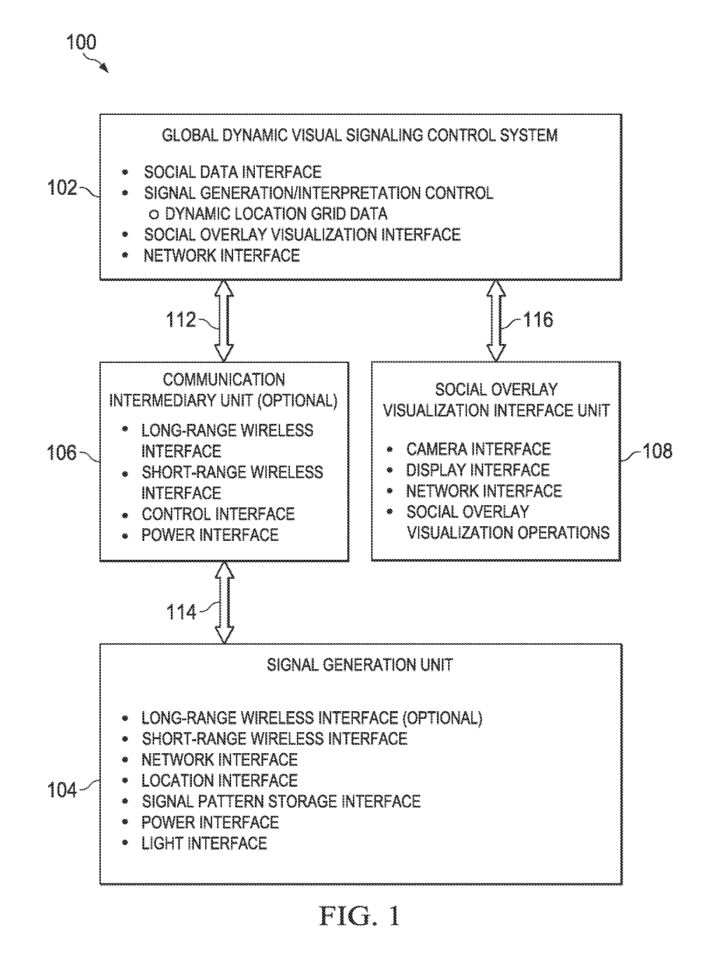

FIG. 1 illustrates a social overlay visualization system 100 in accordance with an embodiment of the disclosure. As shown, the social overlay visualization system 100 comprises a global dynamic visual signaling control system 102. Without limitation to other embodiments or components, the global dynamic visual signaling control system 102 may correspond to social overlay visualization servers, routers, bridges, firewalls, data stores, wired communication interfaces, and/or wireless communication interfaces. In other words, the global dynamic visual signaling control system 102 may perform at least some of the server-side operations described herein. As shown, the global dynamic visual signaling control system 102 may provide a social data interface to gather, update, and maintain social data. The global dynamic visual signaling control system 102 also may provide signal generation/interpretation control based on dynamic location grid data. Further, the global dynamic visual signaling control system 102 also may provide a social overlay visualization interface that expedites or otherwise facilitates dissemination of social overlay visualization instructions and/or data. Further, the global dynamic visual signaling control system 102 also may provide a network interface that expedites or otherwise facilitates communications between the global dynamic visual signaling control system 102 and other components of the social overlay visualization system 100.

As shown, the social overlay visualization system 100 also may comprise a signal generation unit 104 and a social overlay visualization interface unit 108. Without limitation to other embodiments, the signal generation unit 104 may comprise an optional long-range wireless interface, a short-range wireless interface, a network interface, a location interface, a signal pattern storage interface, a power interface, and a light interface. The signal generation unit 104 may perform client-side operations as described herein including, but not limited to, receipt of visual signal coding and/or visual signal instructions from the global dynamic visual signaling control system 102, location tracking operations, dynamic visual signal generation operations based on visual signal coding and/or location information. Meanwhile, the social overlay visualization interface unit 108 may comprise a camera interface, a display interface, a network interface, and a social overlay visualization operations interface. In at least some embodiments, the social overlay visualization interface unit 108 performs client-side operations as described herein including, but not limited to, observation and tracking of dynamic visual signals emitted by the signal generation unit 104, interpretation of the dynamic visual signals, encapsulation of observed dynamic visual signals for transport to the global dynamic visual signaling control system 102, receiving or accessing social data related to a participant identified based on the observed dynamic visual signals, and/or displaying images or a series of images with social data overlay onto or into a displayed image.

In at least some embodiments, an optional communication intermediary unit 106 may be employed between the global dynamic visual signaling control system 102 and the signal generation unit 104. As shown, the communication intermediary unit 106 may comprise a long-range wireless interface, a short-range wireless interface, a control interface, and a power interface. The communication intermediary unit 106 is able to send information to or receive information from the global dynamic visual signaling control system 102 using a long-range wireless interface (e.g., a 3G/4G wireless interface or Wi-Fi interface). Further, the communication intermediary unit 106 is able to send information to or receive information from the signal generation unit 104 using a short-range wireless interface (e.g., Bluetooth).

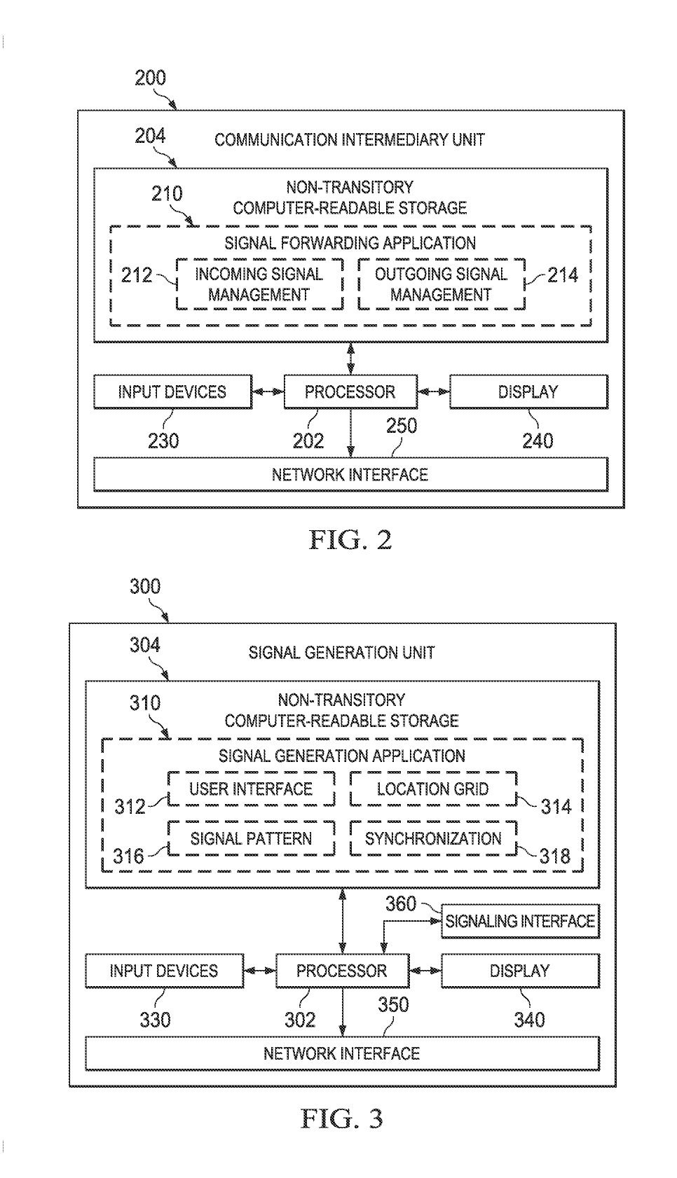

FIG. 2 illustrates a communication intermediary unit 200 in accordance with an embodiment of the disclosure. The communication intermediary unit 200 may correspond to, a cell phone, a smart phones, a tablet computer, a laptop computer, or other mobile device. As shown, the communication intermediary unit 200 comprises a processor 202 coupled to a non-transitory computer readable storage 204 storing a signal forwarding application 210. The communication intermediary unit 200 also comprises input devices 230, a display 240, and a network interface 250 coupled to the processor 202. The computer system 200 is representative of a mobile device, a tablet computer, and/or a laptop computer configured to forward signals between social overlay visualization servers and a signal generation unit (e.g., signal generation unit 104).

The processor 202 is configured to execute instructions read from the non-transitory computer readable storage 204. The processor 202 may be, for example, a general-purpose processor, a digital signal processor, a microcontroller, etc. Processor architectures generally include execution units (e.g., fixed point, floating point, integer, etc.), storage (e.g., registers, memory, etc.), instruction decoding, peripherals (e.g., interrupt controllers, timers, direct memory access controllers, etc.), input/output systems (e.g., serial ports, parallel ports, etc.) and various other components and sub-systems.

In some examples, the non-transitory computer readable storage 204 corresponds to random access memory (RAM), which stores programs and/or data structures during runtime of the computer system 200. For example, during runtime of the computer system 200, the non-transitory computer readable storage 204 may store the signal forwarding application 210 for execution by the processor 202 to perform the signal forwarding operations described herein. The signal forwarding application 210 may be distributed to the computer system 200 via a network connection or via a local storage device corresponding to any combination of non-volatile memories such as semiconductor memory (e.g., flash memory), magnetic storage (e.g., a hard drive, tape drive, etc.), optical storage (e.g., compact disc or digital versatile disc), etc. Regardless the manner in which the signal forwarding application 210 is distributed to the computer system 200, the code and/or data structures corresponding to the signal forwarding application 210 are loaded into the non-transitory computer readable storage 204 for execution by the processor 202.

The input devices 230 may comprise various types of input devices for selection of data or for inputting of data to the computer system 200. As an example, the input devices 230 may correspond to a touch screen, a key pad, a keyboard, a cursor controller, or other input devices.

The network interface 250 may couple to the processor 202 to enable the processor 202 to communicate with a server computer. For example, the network interface 250 may enable the communication intermediary unit 200 to receive social overlay visualization data or instructions from a server (e.g., dynamic visual signal coding) and/or to forward location data from a signal generation unit (e.g., signal generation unit 104, 300) as part of a social overlay visualization process as described herein. In different embodiments, the network interface 250 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards such as code division multiple access (CDMA), global system for mobile communications (GSM), long-term evolution (LTE), worldwide interoperability for microwave access (WiMAX), and/or other air interface protocol radio transceiver cards, and other well-known network devices. The network interface 250 may enable the processor 202 to communicate with the Internet or one or more intranets. With such a network connection, it is contemplated that the processor 202 might receive information from the network, or might output information to the network in the course of performing the communication intermediary unit operations described herein. Such information, which is often represented as a sequence of instructions to be executed using processor 202, may be received from and outputted to the network, for example, in the form of a computer data signal embodied in a carrier wave.

Such information, which may include data or instructions to be executed using processor 202 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well known to one skilled in the art. The baseband signal and/or signal embedded in the carrier wave may be referred to in some contexts as a transitory signal.

The processor 202 executes instructions, codes, computer programs, scripts which it accesses from hard disk, floppy disk, optical disk (these various disk based systems may all be considered secondary storage), read-only memory (ROM), random access memory (RAM), the network interface 250, or the input devices 230. While only one processor 202 is shown, multiple processors may be present. Thus, while instructions may be discussed as executed by a processor, the instructions may be executed simultaneously, serially, or otherwise executed by one or multiple processors.

In accordance with at least some embodiments, the signal forwarding application 210 comprises an incoming signal management module 212 and an outgoing signal management module 214. The incoming signal management module 212 enables the communication intermediary unit 200 to handle incoming signals (e.g., from social overlay visualization servers) related to social overlay visualization and to route the incoming signals to their target signal generation units. The outgoing signal management module 212 enables the communication intermediary unit 200 to handle outgoing signals (e.g., from signal generation units or the communication intermediary unit 200 itself) related to social overlay visualization and to route the outgoing signals to their target social overlay visualization server or servers. In some embodiments, the communication intermediary unit 200 also may comprise a GPS mechanism or other position tracking mechanism. The location tracking information provided by the communication intermediary unit 200 may be associated with a nearby signal generation unit and may be used to assign or update a dynamic visual signal to be emitted by the signal generation unit.

FIG. 3 shows a signal generation unit 300 in accordance with an embodiment of the disclosure. The signal generation unit 300 may emit dynamic visual signals as described herein. As an example, the signal generation unit 300 may correspond to a cell phone, a smart phone, a tablet computer, a personal digital assistant (PDA), or other mobile devices. Additionally or alternatively, the signal generation unit 300 may be integrated with an electronic watch, a bracelet, jewelry, clothing, hats, purses, or other objects that social overlay visualization participants may be wearing or carrying.

As shown, the signal generation unit 300 comprises a processor 302 and a non-transitory computer-readable storage 304 that stores a signal generation application 310. The signal generation unit 300 also may comprise input devices 330, a display 340, a network interface 350, and a signaling interface 360 coupled to the processor 302. Without limitation to other embodiments, the description of the processor 202, the non-transitory computer-readable storage 204, the input devices 230, the display 240, and the network interface 250 given for the communication intermediary device 200 of FIG. 2 may apply respectively to the processor 302, the non-transitory computer-readable storage 304, the input devices 330, the display 340, and the network interface 350.

In accordance with at least some embodiments, the signal generation application 310 comprises a user interface module 312, a location grid module 314, a signal pattern module 316, and a synchronization module 318 to support signal generation for social overlay visualization as described herein. The user interface module 312, when executed by the processor 302, enables a user to activate or deactivate generation of dynamic visual signals by the signal generation unit 300. Further, execution of the user interface module 312 by the processor 302, may enable the user to select a preferred color scheme or signaling option via the signal generation unit 300. The location grid module 314, when executed by the processor 302, combines location tracking information of the signal generation unit 300 (e.g., based on GPS or other mechanism) with an identifier associated with the signal generation unit 300. Alternatively, the operations of the location grid module 314 may be integrated with a communication intermediary unit (e.g., communication intermediary unit 106 or 200) such that these operations do not need to be performed by the signal generation unit 300.

The signal pattern module 316 stores and/or processes dynamic visual signal pattern information provided by social overlay visualization servers or a global dynamic visual signaling control system 102. As an example, whenever dynamic visual signaling is activated, a signaling interface 360 of the signal generation unit 300 may receive or access the signal pattern maintained by the signal pattern module 316 and emit a corresponding signal. The signal pattern module 316, when executed by the processor 302, also may store information about the capabilities of the signaling interface 360 and/or user preferences that may be used to determine the dynamic visual signal pattern. In some embodiments, the signaling interface 360 may be part of or may be integrated with a display 340.

The synchronization module 318, when executed by the processor 302, performs synchronization of signal generation data and/or instructions. The synchronization operations may occur, for example, in response to a schedule, in response to a server-side request or operation, or in response to a client-side request or operation. As an example, synchronization operations may occur as a social overlay visualization participant associated with the signal generation unit 300 moves around (from one social overlay visualization vicinity to another).

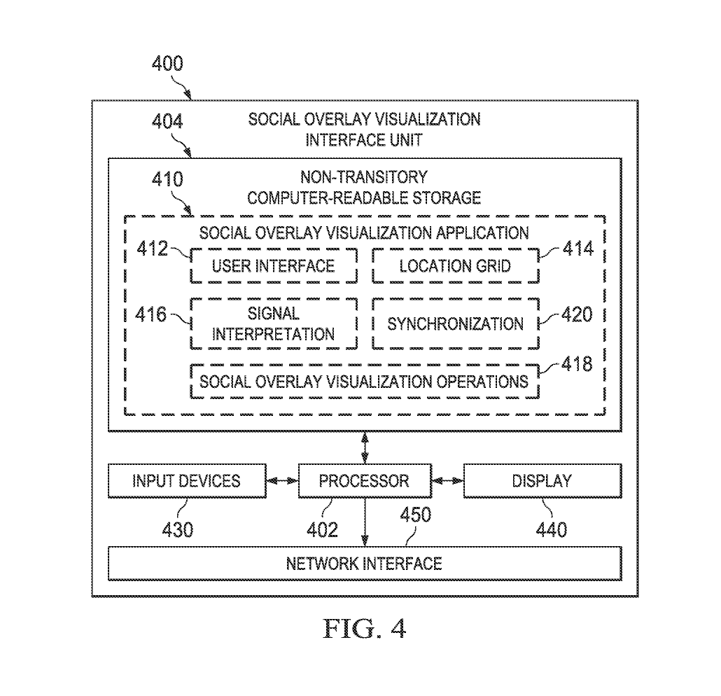

FIG. 4 shows a social overlay visualization interface unit 400 in accordance with an embodiment of the disclosure. The social overlay visualization interface unit 400 may observe/detect dynamic visual signals and display camera images or video with social data associated with observed dynamic visual signals (or participants associated with observed dynamic visual signals) overlayed on the camera images or video images. As an example, the social overlay visualization interface unit 400 may correspond to a cell phone, a smart phone, a tablet computer, a personal digital assistant (PDA), or other mobile devices. Additionally or alternatively, the social overlay visualization interface unit 400 may correspond to social overlay visualization glasses or visors.

As shown, the social overlay visualization interface unit 400 comprises a processor 402 and a non-transitory computer-readable storage 404 that stores a social overlay visualization application 410. The social overlay visualization interface unit 400 also may comprise input devices 430, a display 440, and a network interface 450 coupled to the processor 402. Without limitation to other embodiments, the description of the processor 202, the non-transitory computer-readable storage 204, the input devices 230, the display 240, and the network interface 250 may apply respectively to the processor 402, the non-transitory computer-readable storage 404, the input devices 430, the display 440, and the network interface 450.

In accordance with at least some embodiments, the social overlay visualization application 410 comprises a user interface module 412, a location grid module 414, a signal interpretation module 416, a social overlay visualization operations module 418, and a synchronization module 420 to support social overlay visualization operations as described herein. The user interface module 412, when executed by the processor 402, enables a user to activate or deactivate social overlay visualization operations of the social overlay visualization interface unit 400. Further, execution of the user interface module 412 by the processor 402, may enable the user to select one of a plurality of social overlay visualization formats, color schemes, or other options supported by the social overlay visualization interface unit 400. The location grid module 414, when executed by the processor 402, combines location tracking information of the social overlay visualization interface unit 400 (e.g., based on GPS or other mechanism) with an identifier associated with the social overlay visualization interface unit 400. The location tracking information is used to assign the social overlay visualization interface unit 400 to a social overlay visualization vicinity that reduces complexity of dynamic visual signaling (i.e., the number of participants within a vicinity is limited and thus the number of identifiers that need to be assigned to participants and interpreted is likewise limited).

The signal interpretation module 416, when executed by the processor 402, stores and/or processes instructions for detecting and/or interpreting dynamic visual signal patterns emitted by signal generation units 104 or 300. Further, the signal interpretation module 416 may encapsulate data regarding observed dynamic visual signals for transmission to social overlay visualization servers. In such case, the social overlay visualization servers may interpret observed dynamic visual signals and forward related social data back to the social overlay visualization interface unit 400 for display.

The social overlay visualization operations module 418, when executed by the processor 402, supports various social overlay visualization operations related to the social overlay visualization techniques described herein. Without limitation to other embodiments, the social overlay visualization operations module 418 may receive or access social data related to an observed dynamic visual signal in the same vicinity as the social overlay visualization interface unit 400 and display a social overlay visualization image based on the social data.

The synchronization module 420, when executed by the processor 402, performs synchronization of social overlay visualization data and/or instructions. The synchronization operations may occur, for example, in response to a schedule, in response to a server-side request or operation, or in response to a client-side request or operation. As an example, synchronization operations may occur as a social overlay visualization participant associated with the social overlay visualization interface unit 400 moves around (from one social overlay visualization vicinity to another).

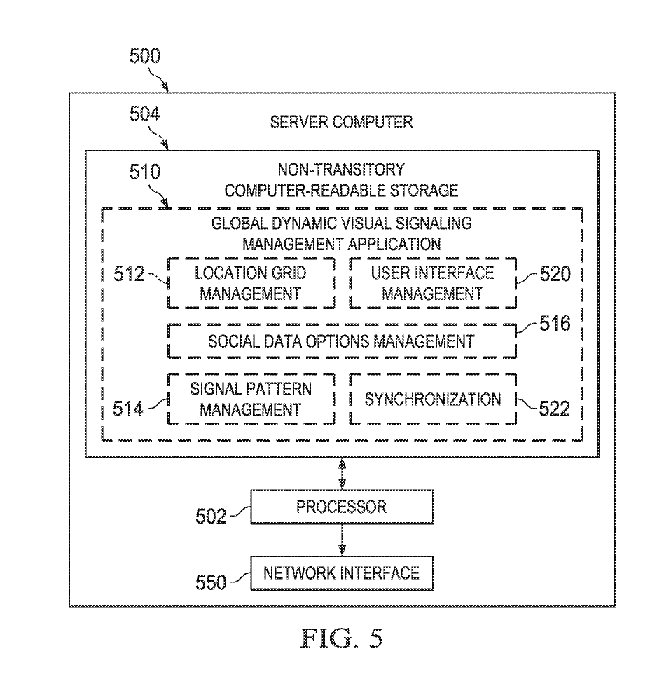

FIG. 5 shows a server computer 500 in accordance with an embodiment of the disclosure. The server computer 500 may perform server-side social overlay visualization operations as disclosed herein. In accordance with some embodiments, the server computer 500 may be configured to perform all server-side social overlay visualization operations. Alternatively, the server computer 500 may be configured to perform limited or specialized server-side social overlay visualization operations. Further, the server computer 500 may be configured to perform server-side social overlay visualization operations for a particular social overlay visualization vicinity or vicinities. In at least some embodiments, the server computer 500 performs at least some of the operations described for the global dynamic visual signaling control system 102.

As shown, the server computer 500 comprises a processor 502 and a non-transitory computer-readable storage 504 that stores a global dynamic visual signaling management application 510. The server computer 500 also may comprise a network interface 550 coupled to the processor 502. Without limitation to other embodiments, the description of the processor 202, the non-transitory computer-readable storage 204, and the network interface 250 may apply respectively to the processor 502, the non-transitory computer-readable storage 504, and the network interface 550.

In accordance with at least some embodiments, the global dynamic visual signaling management application 510 comprises a location grid management module 512, a signal pattern management module 514, a social data options management module 516, a user interface management module 520, and a synchronization module 522 to support server-side social overlay visualization operations as described herein. The location grid management module 512, when executed by the processor 502, manages social overlay visualization vicinity assignments based on location tracking information for signal generation units 104 (or 300), location tracking information for optional communication intermediary units 106 (or 200), and/or location tracking information for social overlay visualization interface units 108 (or 400).

The signal pattern management module 514, when executed by the processor 502, manages the dynamic assignment of dynamic visual signal patterns to signal generation units 104 or 300 based on their location and/or other rules. The social data options management module 516, when executed by the processor 502, manages social data entry options and dynamic selection options for social overlay visualization participants. The user interface management module 520, when executed by the processor 502, manages the user interface options for participant devices associated with social overlay visualization techniques described herein. The synchronization module 522, when executed by the processor 502, manages server-side operations for synchronization of data and/or instructions for the social overlay visualization techniques described herein.

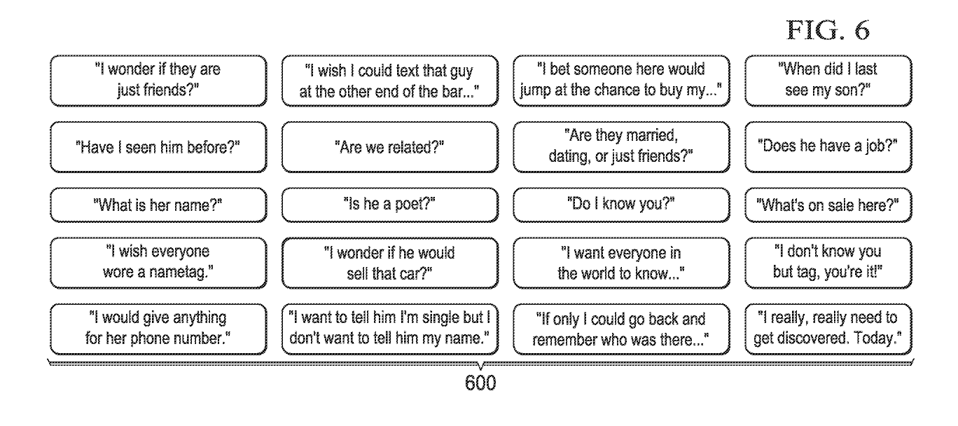

FIG. 6 shows various example questions or desires 600 related to a social/online space interface in accordance with an embodiment of the disclosure. The questions or desires 600 show various reasons why individuals may decide to become participants in social overlay visualization as described herein.

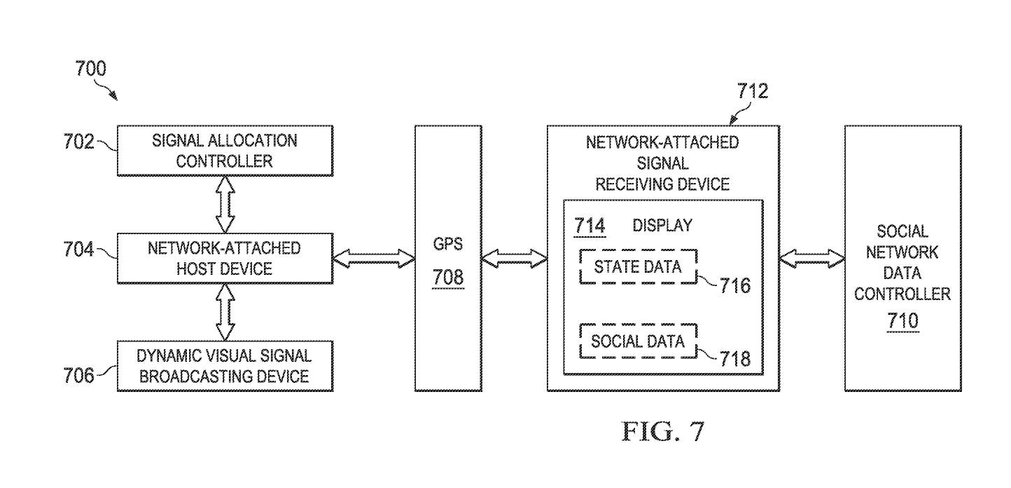

FIG. 7 illustrates another system 700 in accordance with an embodiment of the disclosure. As shown, the system 700 comprises a signal allocation controller 702 that allocates dynamic visual signals to a network-attached host device 704. The network-attached host device 704 forward the allocated dynamic visual signals to a dynamic visual signal broadcasting device 706. The network-attached host device 704 and the dynamic visual signal broadcasting device 706 report identifiers, position data and non-local state and social data to network-based signal allocation controller 702. Further, the host device 704 may modify received signals by adding local state, social data, and/or application logic. The host device 704 also may retain the syntax required for observing devices to parse the signal. Further, the host device 704 may pass final signals and signal metadata to the signal broadcasting device 706 to provide instructions for signal sequences, timing, and repeat parameters. Signal allocation software provides signals to host devices and integrated host & signaling devices.

Signal allocation controller 702 provides signaling information and instructions to the host device 704 or to combination host/signaling devices 704, 706. The signal allocation controller 702 determines global signal maps and allocates available signals to registered dynamic signal broadcasting devices. Signal maps can themselves be dynamic, including “what-if” and other conditional logic for modifying signal mapping. Data is returned to the signal broadcasting device 706 and supporting client application over the network, such as a LAN or a cellular network and the Internet.

The system 700 also comprises a social network data controller 710 that controls the dissemination of social data to a network-attached signal receiving device 712. As shown, the network-attached signal receiving device 712 may comprise a display 714 to display state data 716 and/or social data 718 based on observed dynamic visual signals broadcast by the dynamic visual signal broadcasting device 706. The social overlay visualization operations of the network-attached signal receiving device 712 and the signaling operations of the dynamic visual signal broadcasting device 706 may be based at least in part on location tracking information. Such location tracking information may be provided by a GPS system 708 in communication with the network-attached signal receiving device 712 and the dynamic visual signal broadcasting device 706. The GPS system 708 and acquired location data is employed to define signal maps employing mapping functions and tools including spatial maps and vicinities.

The signal receiving device 712 employs location data to identify nearby devices and vicinities sourcing their associated signals and social data. The signal broadcasting devices 706 are assigned to vicinities and dynamic visual signals are allocated based at least in part on the proximity of signal broadcasting devices 706 to other vicinities. In some embodiments, the signal broadcasting 706 device employs a client application to receive current location and vicinity signal coding and state maps for nearby vicinities from the signal allocation controller 702.

The signal receiving device 712 may employ a client application to overlay information decoded from signals on a visual representation or overlay of real space. In some embodiments, the participant identifier data may be translated into social network identities and their metadata to form a social overlay visualization social network, where online social, promotional, or informational data is fused with reality in near real-time maps and visualizations. As an example, the signal receiving device 712 may receive camera input, visually process this input and identify the identity, social, and state data broadcast from the remote device. This forms a foundation for directional mapping of nearby signal broadcasting devices suitable for spatial mapping and overlay.

Without limitation to other embodiments, the signal allocation controller 702 and the social network data controller 710 may be part of the global dynamic visual signaling control system 102 and/or may correspond to operations of server computer 500. Further, the network-attached host device may correspond to a communication intermediary unit 106 or 200. Further, the dynamic visual signal broadcasting device 706 may correspond to a signal generation unit 104 or 300. Further, the network-attached signal receiving device 712 may correspond to a social overlay visualization interface unit 108 or 400.

The disclosed social overlay visualization technology allows individuals dwelling and walking from place to place to communicate information to others with managed access and non-determinant markers. In some embodiments, the disclosed social overlay visualization techniques may rely on the dynamic visual signal broadcasting device 706 to share signals, and mobile platforms (e.g., the signal receiving device 712) such as camera cell-phones and tablets with visual sensors to receive and visualize online social networks, viewed as an overlay to a real-world environment. The dynamic signal broadcasting device 706 makes it possible to share identity and state information with others. That information can then be employed to gather additional metadata on the state or identity of the agent or signaling device, including identity data, social network information, health information, identity relationship information, emergency information, entertainment information, advertisements, promotions, document references, and online information links. Once metadata is gathered it can then be displayed or stored on a mobile device (e.g., the signal receiving device 712), displayed as an overlay with the scene in real time as in augmented reality, and/or displayed as an overlay with the scene at a later time as in an annotated photo. The metadata data can also be applied based on a set of rules to supply automated alerts, notifications, messaging services, or other information.

In some embodiments, the disclosed social overlay visualization techniques implement a set of visual signals composed of colored and shaped signals that are visually distinct. A benefit of the disclosed social overlay visualization is the association of social data with the allocation of visual signals to moving, dispersed individuals. Unlike facial recognition techniques where the data, once captured by a third party, enables perpetual tracking and data accumulation, the disclosed social overlay visualization provides protection from long-term tracking with signals that are dynamically assigned and that change frequently and unpredictably. Hence an individual will have one signal at one moment, and another signal at another moment such that a third party cannot continually track the individual. Even in the event that sensitive data becomes associated with a signal, such as a user's true name, that signal will change and the map will be lost, protecting the signaling individual from out-of-network observation, enabling rapid changes in privacy state through user-commanded changes to social data being broadcast. Further, participants will have the ability to drop out of the social overlay visualization system by disabling signaling altogether.

In at least some embodiments, the disclosed social overlay visualization techniques allow participants to enter and leave a single instantiation of the signaling system while retaining their ability to broadcast social data associated with their identity. Participants are assigned new signals as they pass from one vicinity to another, and their history of vicinity mapped identity and state signals is stored in a generational signaling queue until time, position, and network observed data indicate that prior vicinity mapped signals are no longer required.

In accordance with embodiments, the disclosed social overlay visualization techniques support a web map that enables participants to associate information from the cloud with large inanimate objects or places. For example, the web map may correspond to an overhead (e.g., birds eye) view that is useful and descriptive. A web map with a first-person view is also possible. The disclosed social overlay visualization techniques also support a visual search feature that allows participants to take a picture of objects, transmit that image to a web application, and receive search data. For example, the visual search feature can perform image matching or rely on visual signals including visually decoded bar codes, text, and distinctive logos. The disclosed social overlay visualization techniques also support a socialization feature that connects information from the cloud with small social agents that move around constantly. Since people are small and often close together, reliable associations of data with people may require accuracy within inches. Once the disclosed social overlay visualization techniques are implemented reality will be integrated with information in a way that is personal, relevant, immediate, and life changing. Those who choose to participate will integrate the tools and features of social overlay visualization into their everyday lives as if they are second nature. A new social space, existing at once online and offline, will connect people to one another like never before.

In at least some embodiments, the disclosed social overlay visualization techniques use network accessible identity and state information stored and served by dynamic visual signal allocation software and social data allocation software. The disclosed software tools enable identity, signal coding, state data, and social data to be available on a large scale network of dynamic visual signal broadcasting and receiving devices. Furthermore, the disclosed software tools maintain a dynamic real-time map of signals and their identity and state associations and enable dissemination of real-time updates for signal broadcasting devices and signal receiving devices over a multiplicity of geospatial areas and visual vicinities.

Further, in some embodiments, the disclosed social overlay visualization techniques employ colored and shaped signals in a dynamic visual signaling system that may be detected over a large distance as the colored/shaped signals contain large and visually distinct features with lower angle of incidence sensitivity and computational requirements. The colored/shaped signals described herein are visible at distance and are more easily detected than alternative methods of assigning identity to individuals such as facial recognition or visually complex static tags and bar codes.

Further, in some embodiments, the disclosed social overlay visualization techniques employ dynamic visual signal vicinity groups and dynamic visual signaling devices to instantiate an instance of a visual signal system occupying an amebic geospatial area called a vicinity. One feature of amebic visual vicinities is that they may become larger or smaller, move through space, and ultimately may be generational giving them a time dimension to increase the amount of signal data available to observers increasing the probability of accurate detection and social data association. Instances of the signal set with little or no overlap within vicinities represents high probability line-of-sight. Multiplexing compensates for the potential for observers to view signaling devices which are entering, exiting, and have some likelihood that they will be observed outside of their primary vicinity by observers employing dynamic visual signal receiving devices. Multiplexing increases the size of a region over which observers can obtain accurate identity association. The desired number of individuals, clustering of individuals, velocity of individuals, position and attributes of other vicinities are incorporated in dynamic signal allocation and multiplexing. The use of multiple dynamic signaling devices by a single individual increases the number of signals available to observing devices with the benefit of permitting multiple viewing angles given multiple body or nearby signal device placements. In one instance, a single identity is mapped to each signaling device, creating a multiple signals with multiple potential viewing angles while indicating the same underlying identity with the benefit of increasing the probability of the identity being detected by observing devices. Users may employ multiple instances of the signaling device to create more viewing angles for the same signal set by duplicating the signal set. In addition, multiple dynamic signaling devices may be employed by the same individual to create multiple independent identities by assigning independent profiles to each device, and to create the opportunity for additional state information mapping the same identity but different state data to multiple devices.

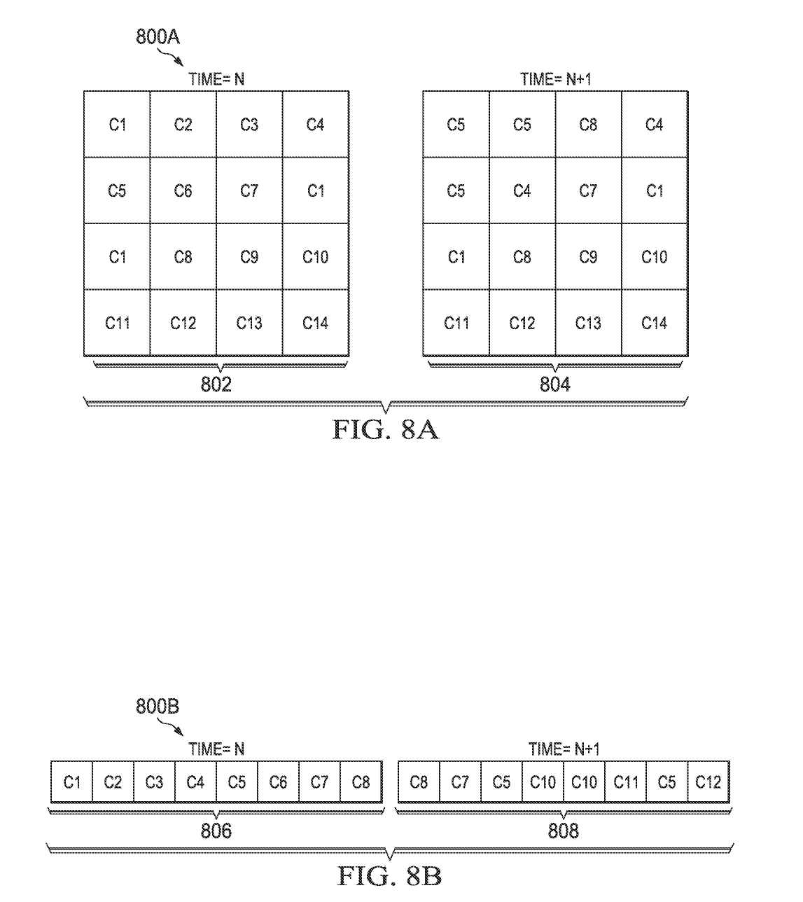

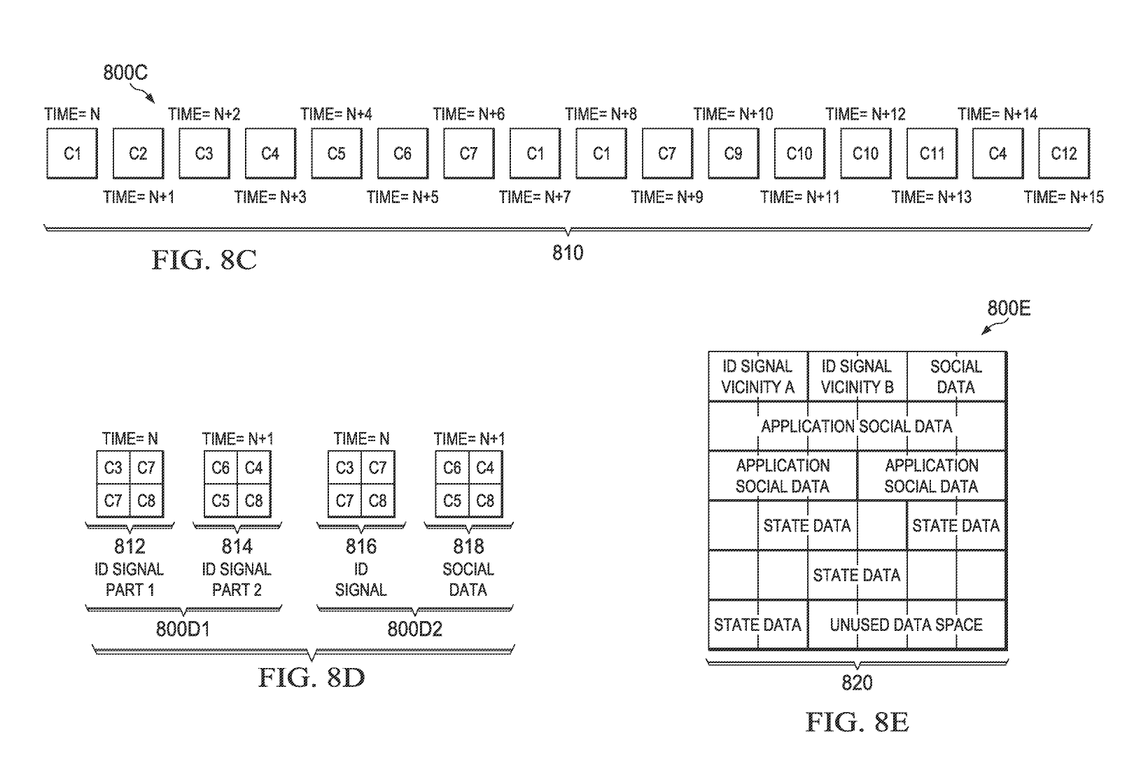

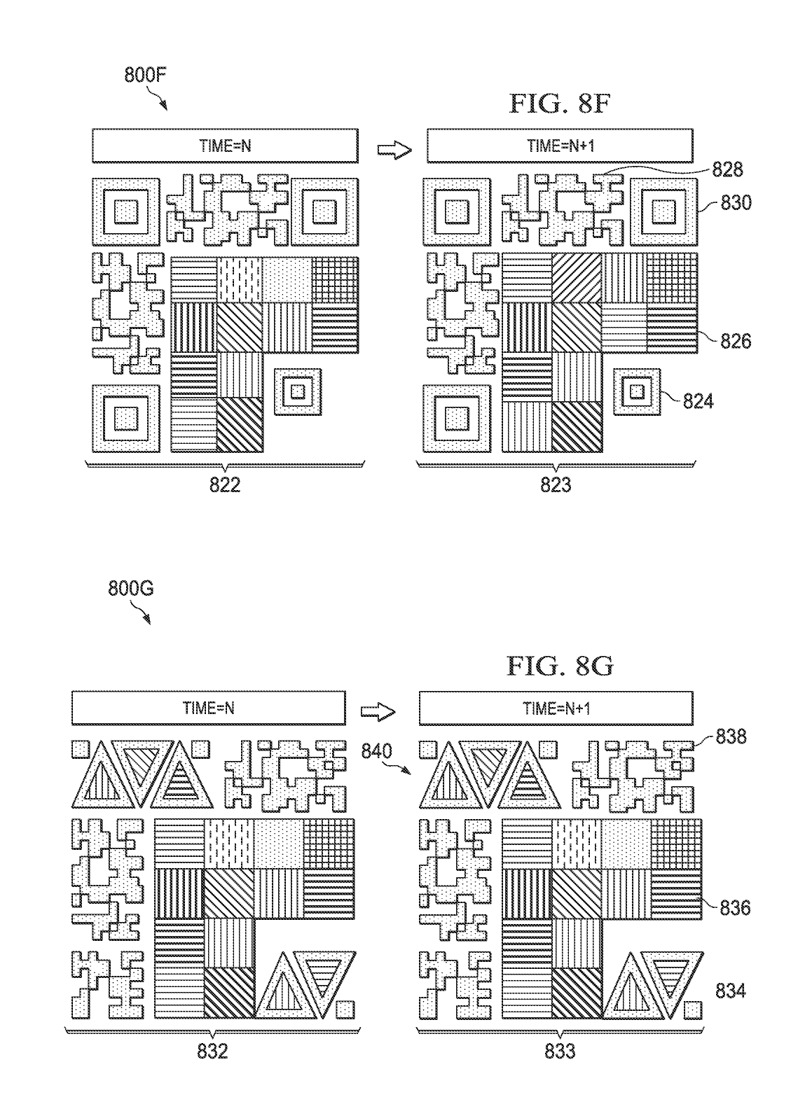

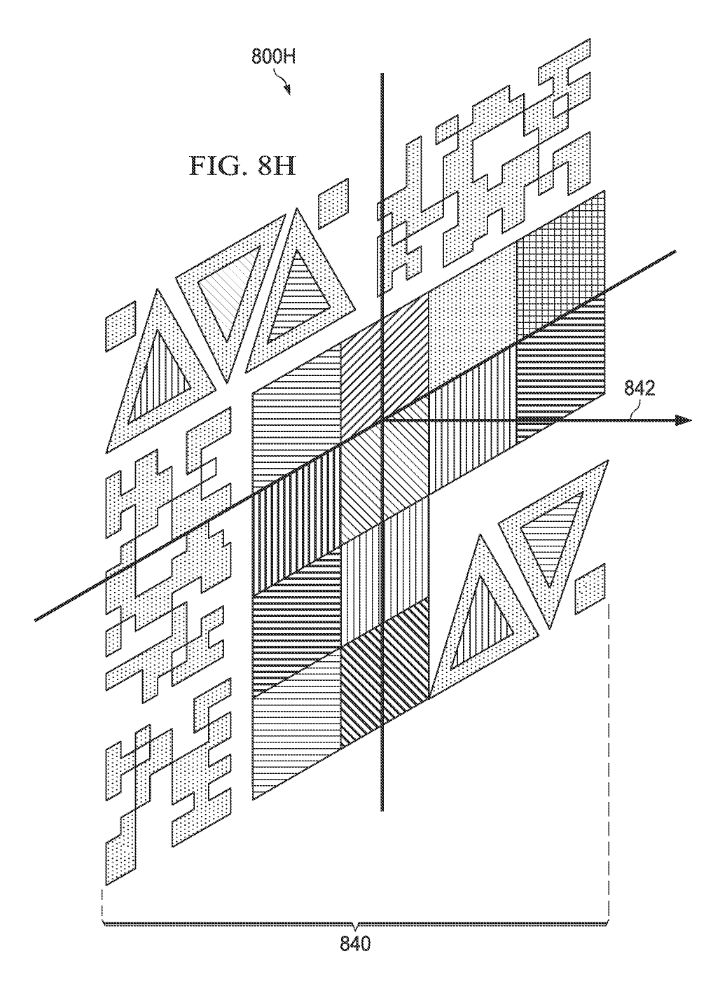

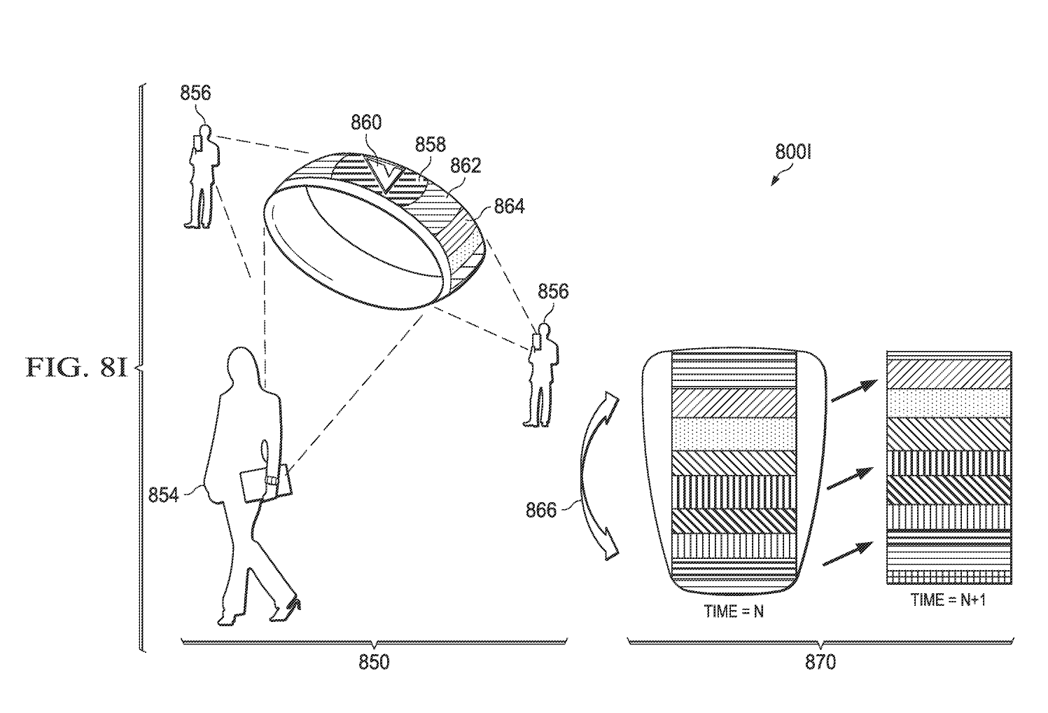

FIGS. 8A-8I illustrate various dynamic visual signal patterns in accordance with embodiments of the disclosure. In FIG. 8A, a dynamic visual signal pattern 800A corresponds to a generational pattern using a 4×4 color matrix. In other words, the dynamic visual signal pattern 800A comprises a first 4×4 color matrix 802 and a second 4×4 color matrix 804. The first 4×4 color matrix 802, corresponding to time N, displays one of a plurality of distinct colors (e.g., C1-C16) detectable by an observing device. Later, the second 4×4 color matrix 804, corresponding to time N+1, displays an updated color scheme. Thus, the dynamic visual signal pattern 800A shows that the amount of information provided by a 4×4 color matrix to an observing device can be increased by changing the color scheme over time. Although not required, the first and second 4×4 color matrices 802 and 804 may be displayed by a single 4×4 color matrix generator.

In FIG. 8B, a dynamic visual signal pattern 800B corresponds to a generational pattern using a 1×8 color matrix. In other words, the dynamic visual signal pattern 800B comprises a first 1×8 color matrix 806 and a second 1×8 color matrix 808. The first 1×8 color matrix 804, corresponding to time N, displays one of a plurality of distinct colors (e.g., C1-C16) detectable by an observing device. Later, the second 1×8 color matrix 808, corresponding to time N+1, displays an updated color scheme. Thus, the dynamic visual signal pattern 800B shows that the amount of information provided by a 1×8 color matrix to an observing device can be increased by changing the color scheme over time. Although not required, the first and second 1×8 color matrices 806 and 808 may be displayed by a single 1×8 color matrix generator.

In FIG. 8C, a dynamic visual signal pattern 800C corresponds to a generational pattern using a 1×1 color matrix. As shown, a plurality of 1×1 color matrices 810, corresponding to times N to N+15, display one of a plurality of distinct colors (e.g., C1-C16) detectable by an observing device. Thus, the amount of information provided by a 1×1 color matrix to an observing device can be increased by changing the color scheme over time. Although not required, the plurality of 1×1 color matrices 810 may be displayed by a single 1×1 color matrix generator.

In FIG. 8D, two dynamic visual signal patterns 800D1 and 800D2 correspond to time generational patterns using a 2×2 color matrix. The dynamic visual signal pattern 800D 1 comprises a first 2×2 color matrix 812 and a second 2×2 color matrix 814. The first 2×2 color matrix 812, corresponding to time N, displays one of a plurality of distinct colors (e.g., C1-C16) detectable by an observing device. Later, the second 2×2 color matrix 814, corresponding to time N+1, displays an updated color scheme. Thus, the amount of information provided by a 2×2 color matrix to an observing device can be increased by changing the color scheme over time. Although not required, the first and second 2×2 color matrices 812 and 814 may be displayed by a single 2×2 color matrix generator. For the dynamic visual signal pattern 800D 1, the first 2×2 color matrix 812 may correspond to a first part of an identifier signal while the second 2×2 color matrix 814 may correspond to a second part of an identifier signal.

The number of unique assignments for a visual signal vocabulary is the number of unique combinations of signal elements composing a signal. The density a vicinity can achieve with unique assignment is the number of visual signals in a vocabulary divided by the area of a vicinity. An example signaling pattern with 8 elements is given herein to illustrate the effect of multiplexing on the size of the signal vocabulary. In this example, 8 elements are employed to create a large signal vocabulary. If the 8 elements do not change over time, then a vicinity would be limited to 8 unique assignments. However, by changing these elements in a 2×2 matrix, (e.g., changing the colors over a period of time), then the total number of unique assignments may be increased, for example, to (8×8×8×8)×(8×8×8×8)=16,777,216. Thus, dynamic and/or generational signaling supports a much larger area than line of sight might permit in the vast majority of locations.

Returning to FIG. 8D, the dynamic visual signal patterns 800D2 comprises a first 2×2 color matrix 816 and a second 2×2 color matrix 818. The first 2×2 color matrix 816, corresponding to time N, displays one of a plurality of distinct colors (e.g., C1-C16) detectable by an observing device. Later, the second 2×2 color matrix 818, corresponding to time N+1, displays an updated color scheme. Although not required, the first and second 2×2 color matrices 816 and 818 may be displayed by a single 2×2 color matrix generator. For the dynamic visual signal pattern 800D2, the first 2×2 color matrix 816 may correspond to an identifier signal while the second 2×2 color matrix 818 may correspond to social data.

In this example, the first signal in time is a 2×2 matrix of 8 possible elements conveying identity with a vocabulary of 4096 combinations from the number of unique combinations of 8 signal elements in a 2×2 matrix. The second signal is employed for social data corresponding to the identity in the first signal. The 4096 unique combinations for identity data would allow a vicinity to encompass at most 4096 unique assignments to signal broadcasting devices in a single vicinity. Vicinities can be split or members allocated to new vicinities to manage the number of available signals in a vicinity.

In FIG. 8E, a dynamic visual signal pattern 800E corresponds to a time generational pattern using an 8×8 color matrix 820. The 8×8 color matrix 820 displays one of a plurality of distinct colors (e.g., C1-C16) detectable by an observing device. Over time, the color scheme of the 8×8 color matrix 820 may be updated to convey additional information. Thus, the amount of information provided by the 8×8 color matrix 820 to an observing device can be increased by changing the color scheme over time. In at least some embodiments, portions of the 8×8 color matrix 820 may be assigned to convey particular types of information. Without limitation to other embodiments, for the dynamic visual signal pattern 800E, the different blocks of the 8×8 color matrix 820 may correspond to an identifier signal for vicinity A, an identifier signal for vicinity B, social data, application social data, state data, and unused data space.

In another example, spatial multiplexing of dynamic visual signals may be applied to a 6×6 matrix configuration with each row in 6 segments demonstrating how each element in a dynamic visual signal (in this case, 36 total) is composed of identity, state, and social data applied to a data array which is stored as social data with a geometric layout for parsing and applicable application processing by observing devices.

The disclosed dynamic visual signal technology allows information about a user's state and identity to be transmitted and modified locally with direct associations between observer and broadcasters in a real-space field of view. In some embodiments, the disclosed dynamic visual signaling technology encodes identity, application state, and/or social data, allowing complex data to be transmitted locally and openly, yet with control of privacy identity protection. State and social data refer to data associated with a user or thing's identity which are conveyed over a network through state and social allocation software employing dynamic visual signal technology for local broadcast to nearby observers.

Updates to social and state data are made primarily by users of host devices which permit them to modify data associated with themselves and with the state of systems which they have chosen to share through signal broadcast. As used herein, “social data” refers to personal information and information about users, their current state, messages, visualization choices, interactive applications, sub-applications and widgets that allow users to retain information, communicate, and interact in a personal manner. As used herein, “state data” refers to information about virtual objects and applications, their current state, messages, visualization choices, interactive applications, sub-applications and widgets that allow users to retain information, communicate, and interact in a non-personal manner. State data may be shared among many users, as in a virtual game, a virtual event, a virtual gathering, a shared document or interactive graphic, a commercial transaction engine such as a virtual storefront, status of a financial or non-financial transaction, and web-technology based applications.

In FIG. 8F, a dynamic visual signal pattern 800F corresponds to a generational pattern using a color matrix 826. Without limitation to other embodiments, the color matrix 826 has an inverted L shape with a plurality of elements, where each element displays one of a plurality of distinct colors (e.g., C1-C16) detectable by an observing device. The dynamic visual signal pattern 800F comprises a first signaling scheme 822 and a second signaling scheme 823 that employ the color matrix 826. Over time, the color scheme of the color matrix 826 may be updated to convey additional information. Thus, the amount of information provided by the color matrix 826 to an observing device can be increased by changing the color scheme over time. In at least some embodiments, the first and second signaling schemes 822 and 824 also include fixed markers 824, 828, and 830. The fixed markers 824, 828, and 830 may be used to provide orientation information or other information regarding how to interpret the color matrix 826. Alternatively, the fixed markers 824, 828, and 830 may be used to provide social data, state data or other types of data described herein.

The inclusion of visual cues or markers for spatial alignment and signaling element recognition by an observing device enables the separating the dynamic signals from background observations. Furthermore, inclusion of color calibrating features allows observing devices to control for variation in ambient light improving the accuracy of assignment of an observed signal to a known signal value within the dynamic signal library. Combining a dynamic signal into a static tag structure such as a QR code has the benefit of adding dynamic visual signaling capabilities to existing tag-based solutions including substantially increasing bandwidth, provision of dynamic identity information without being bound to static tag data, and enhanced data richness through local, dynamic state data with dynamic identity and state signal data. In some embodiments, the combined static and dynamic signal is composed of a signal layout composed of multiple elements containing static and dynamic visual signals. The static visual signals have the advantage of being similar to existing tags but with the addition of dynamic visual signals which, when conveyed with the static signal, are able to alter the meaning of data contained in the static elements.

The inclusion of locating geometries permits enhancement of visual recognition through detection of multiple geometric elements which are useful in guiding the observing device to the location of the dynamic visual signal elements as well as the static elements. The inclusion of orienting and rectifying geometries assists the observing device's decoding application in rectifying static and dynamic signals to confirm that they are indeed signaling devices and to interpret and present an oriented visual signal for interpretation and decoding. The inclusion of color calibrating features assists in color recognition of the visual signal both increasing accuracy of signal decode and improving the potential breadth and quantity of the dynamic signals vocabulary of the system.

In FIG. 8G, a dynamic visual signal pattern 800G corresponds to a generational pattern using a color matrix 836. Without limitation to other embodiments, the color matrix 836 has an inverted L shape with a plurality of elements, where each element displays one of a plurality of distinct colors (e.g., C1-C16) detectable by an observing device. The dynamic visual signal pattern 800G comprises a first signaling scheme 832 and a second signaling scheme 833 that employ the color matrix 836. Over time, the color scheme of the color matrix 836 may be updated to convey additional information. Thus, the amount of information provided by the color matrix 836 to an observing device can be increased by changing the color scheme over time. In at least some embodiments, the dynamic visual signal pattern 800F also includes fixed markers 838. Additionally or alternatively, the dynamic visual signal pattern 800F also may include dynamic markers 834 and 840. The fixed markers 838 and/or the dynamic markers 834 and 840 may be used to provide orientation information or other information regarding how to interpret the color matrix 836. Alternatively, the fixed markers 838 and/or the dynamic markers 834 and 840 may be used to provide social data, state data or other types of data described herein.

In FIG. 8H, a dynamic visual signal pattern 800H corresponds to a signaling scheme 840 having a particular orientation 842. The orientation 842 of the signaling scheme may vary over time as an object associated with the signaling scheme 840 moves.

Receiving devices for dynamic visual signals detect the presence of a dynamic visual signal and its orientation expressed as a plane in 3 dimensional space of the dynamic visual signal employing visual cues including the shape of the dynamic visual signal, the comparative shape of dynamic visual signals, the comparative shape of geometric cues, the relative position of geometric features and dynamic signals, and social data from the vicinity indicating anticipated configurations and signaling elements of nearby dynamic visual signaling devices.

The final orientation and rectification of the dynamic visual signal has the benefit of aligning the visual signal against a feature grid which permits spatial parsing and analysis and decoding of each element of the signal including dynamic visual signals, static tag elements, calibrating features, and signal multiplexing for decoding into a digital data structure. This data structure is then transferred into a detected signals database of the signal receiving device and stored for subsequent interpretation, assignment of identity information, and creation of state information. Orientation data and visual cue metadata are also retained in the data structure for positioning and alignment of visual overlays on the background scene. Generational dynamic visual signals are interpreted through the repeated application of dynamic visual signal orientation with retained cue and position data binding each generational interval of the dynamic signaling device and addition to the prior time intervals of a digital data structure. The digital data structure may exist for some time without being bound to a specific identity or state with the benefit of allowing signal receiving devices to buffer signals and signal history prior to interpretation, social data associations, state data associations and visualizations associated with the signaling device.

In FIG. 8I, a dynamic visual signal pattern 800H corresponds to a signaling scheme 850 adapted for a bracelet signaling device 854. The bracelet signaling device 854 comprises a plurality of color bars 858, 862, 864 that are viewable from different angles 856 by observers. The bracelet signaling device 854 also may comprise at least one fixed marker 860 that provides orientation information or other information regarding how to interpret the color bars 858, 862, 864. In the signaling scheme 870, the bracelet signaling device 854 implements a time multiplexing signaling scheme, where the colors bars of the bracelet signaling device 854 at time=N+1 are updated or shifted compared to the colors bars of the bracelet signaling device 854 at time=N. In some embodiments, the signaling scheme 870 may implement a predetermined direction of shifting 866 that enables an observer with an incomplete view of the bracelet signaling device 854 to ascertain all of the color bars even with the incomplete view.

The incorporation of a curved display surface for a dynamic visual signaling device has the advantage of providing a broader area of visual broadcast for device signals and geometric opportunities for signal multiplexing. On a curved form, such as a bracelet, generational dynamic visual signals may be sequentially displayed in rotation around the curved form allowing for broadcast of a generational signal to a wide area, increasing the potential locations for an observing device to detect and interpret the signal. A curved surface dynamic visual signaling device has the advantage of improved ergonomics while providing a multiplicity of viewing positions for an observing device relative to the signaling device. The inclusion of locating geometries and shape variation of dynamic visual signals on the curved display surface has the advantage of indicating order and sequence of generational signals. The curved surface of the device profile is able to statically convey generational signals and can rotate through the curve the generational signal with signals progressing through time across the surface of the curved display with geometric markers indicating orientation and allowing the reference ID and state matrix contained of the observing device to be easily synchronized to the observed signal. The generational signal may pass through and carry along static display spaces and geometric markers with the benefit of multi-use of the display surface and providing visual cues for or orientation of the dynamic visual signal. A time display, information display, or visual computing interface may be an overlay on a static display space through which the generational signal passes as it traverses the surface of the curved display.

Another feature of a curved surface is improved area of broadcast with multiple observer positions having line of sight to dynamic visual signal broadcast. Multiple signal observing devices may simultaneously receive a generational dynamic visual signal through a wide angle around the curved display surface of the dynamic visual signal device. Another feature is portability on extremities like arms and wrists which being distant from body of the individual employing the signaling device can be less occluded by their body increasing the visibility of the broadcast dynamic visual signal.

Dynamic visual signals may be fully defined, generational, and visualized by an online system which diminishes the computational requirement on the host device. Rather than send instructions specifying the construction of the dynamic visual signal, the signal may be encapsulated and rendered as a video codec or image sequence allowing standard video playback hardware to be employed for reproduction of the dynamic visual signal. Parameters for the reproduction device are furnished to signal allocation software allowing the signal to be rendered at an appropriate geometry and scale for the playback device. Dynamic visual signals rendered and encrypted into a streaming video for transmission and playback through a dynamic visual signal broadcasting device or streamed to a multi-purpose visual display system have the advantage of streaming and playback on a general purpose display including an electronic billboard, a PC, nearby displays and digital banners, and personally worn displays. Rendering to a video codec also permits dynamic visual signal broadcasting devices to be configured with affordable and standardized video playback hardware diminishing the amount of device-specific coding required for interpretation of dynamic visual signals. Inserting local state data into a dynamic visual signal encapsulated in a video stream is more complex and not well suited for applications where changing local state data will be an important part of device interaction and generational dynamic visual signal reproduction. Producing and batching large quantities of signal output adds efficiency to allocation software and may process multiple signals at each stage in the encapsulation and rendering processing pipeline. Playback on remote devices including a curved display surface will have the advantage of displaying signals and generational signals over a broader field of view through the movement of signal elements over the broadcast display surface with sequences traversing the surface over time.

Dynamic visual signaling devices convey state data by transmitting dynamic visual signals with specific meaning in a shared context. A shared context is established when a dynamic signal broadcasting device conveys its identifying signal and the signal receiving device associates that signal with that individual and the corresponding social and state data the user or system has designated for proliferation by that individual. As an example, a game of tic-tac-toe implemented as a software application, sub-routine, or webtechnology/HTML based application of the broadcasting and receiving device may correspond to a state system, where the system is a game, a projected visualization of the game is permitted by the user to be associated with their broadcast identity, the projected visualization is interactive and the current set of taken moves and turns comprises a state of the game, and the game state together with any visualization, interactive, and collaborative data dictating the current status of the game comprises the state of that game.

The designation of the state system, the fact that it is a particular tic-tac-toe application may be directly broadcast as a segment of a generational signal, or the identity and a portion of the state data may be resident in the online social data allocation system and disseminated to observing devices as state and social data. Changes in the state of the game, for example, one player places an X in the center square, are added to the local data of the application. This data may be then uploaded to the social data system or queued for insertion into a generational signal. State data may be itself dynamic with rules set by signal allocation software or static or merely associated with a dynamic identity. The system is able to accommodate these multiple paths for passing data from broadcasting to observing device with the benefit of providing private, local-only broadcast of social data and state, or flexible connectivity with online data and applications in the case of local changes in state data being available to online social and state data systems. State data may be broadcast, for example, to convey information such as the current state or changes in state in the context of an application, sub-routine, or web technology/HTML based application including a game, a visualization, media content including music and video, an interactive graphic, and/or a form associated with a dynamic visual signaling device to one or more observing individuals.

As an example, a dynamic visual signaling device user may activate his device on a visual signaling network and publish a game of tic-tac-toe over that network. Thereafter, a generational dynamic visual signal containing an identity string and a state string representing the current state of a Tic-Tac-Toe application is broadcast for viewing and interaction by observers. The signal is recognized by a dynamic visual signal receiving device and a map to online data published for the sending device is established. Parsed data includes a designation for the state systems published by the sending device including the game of Tic-Tac-Toe. The dynamic visual signal receiving device accesses the published states for the recognized device and interprets the dynamic visual signal according to the signal associations defined by signal allocation software and the rules for the published state systems including the game of Tic-Tac-Toe. The dynamic visual signal receiving device also interprets the dynamic visual signal and creates a visualization, interactive interface, or overlay allowing the game of Tic-Tac-Toe to be viewed, joined, shared, or republished according to the rules established by the originating user and the rules of the state system.

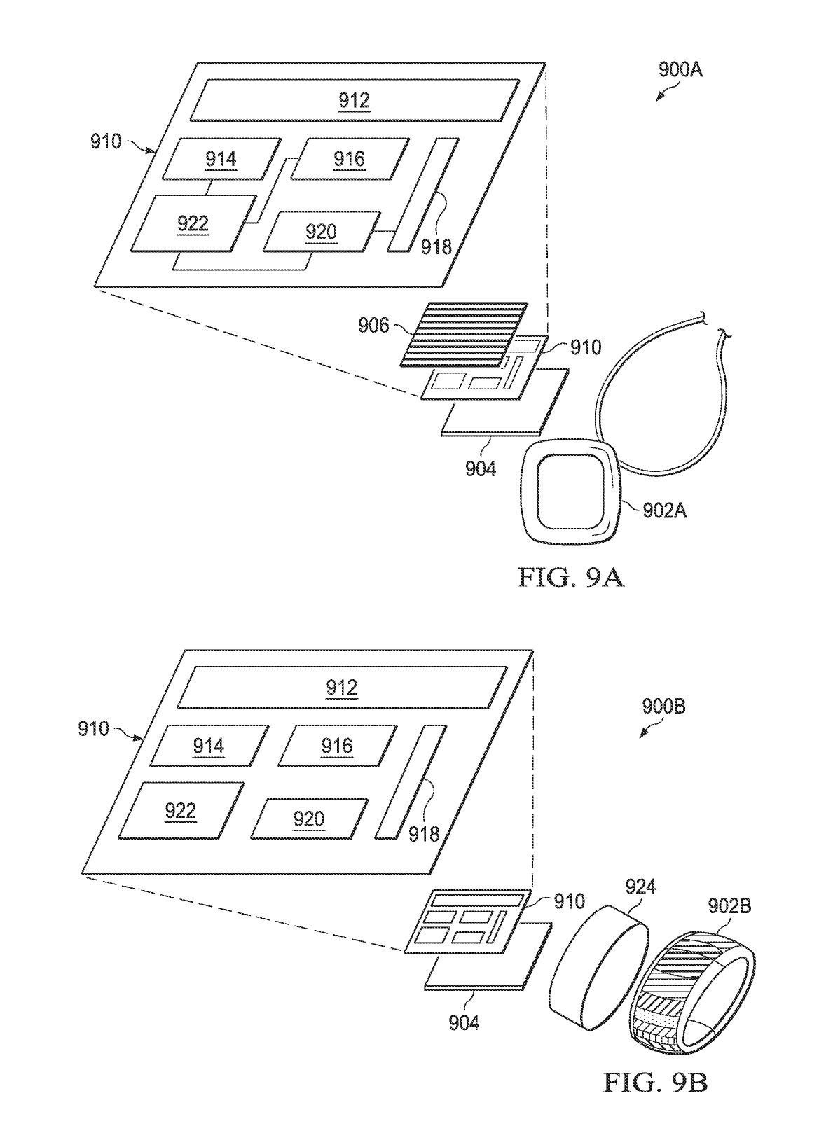

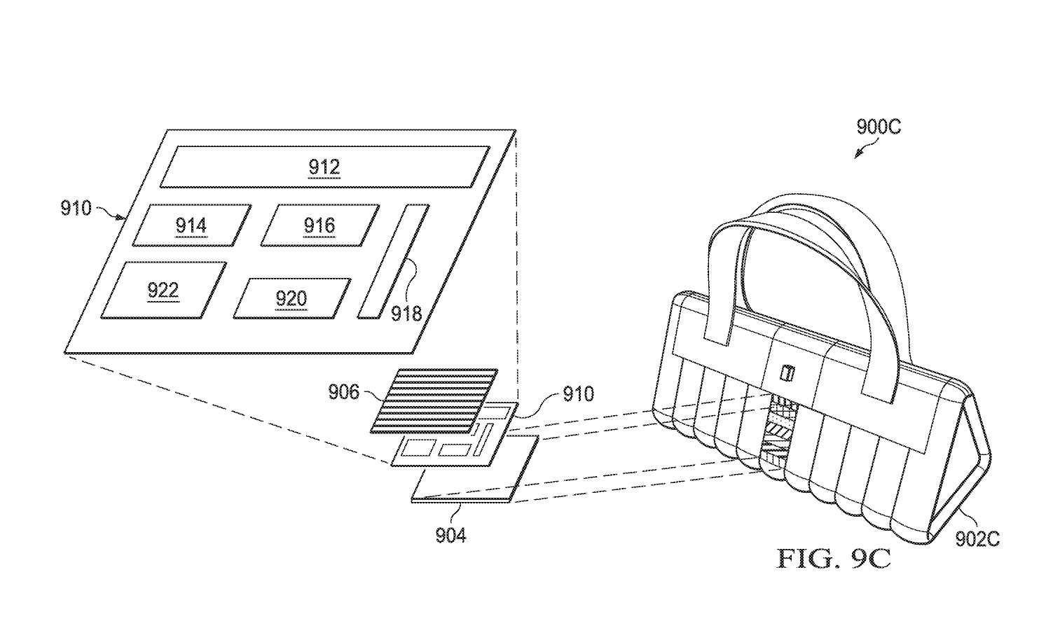

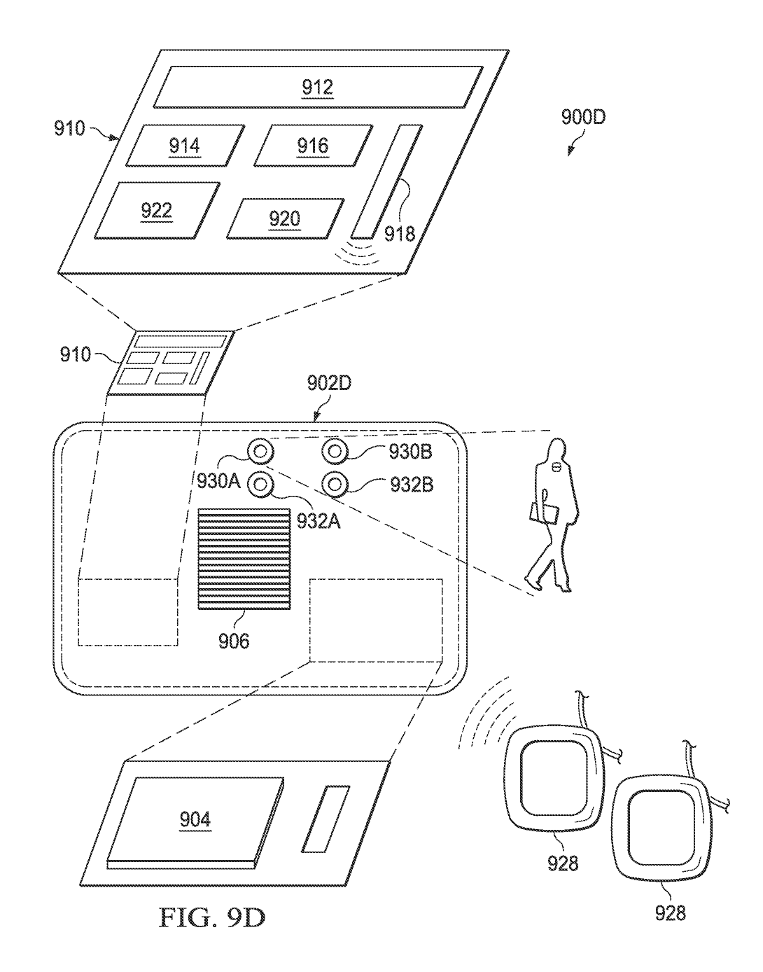

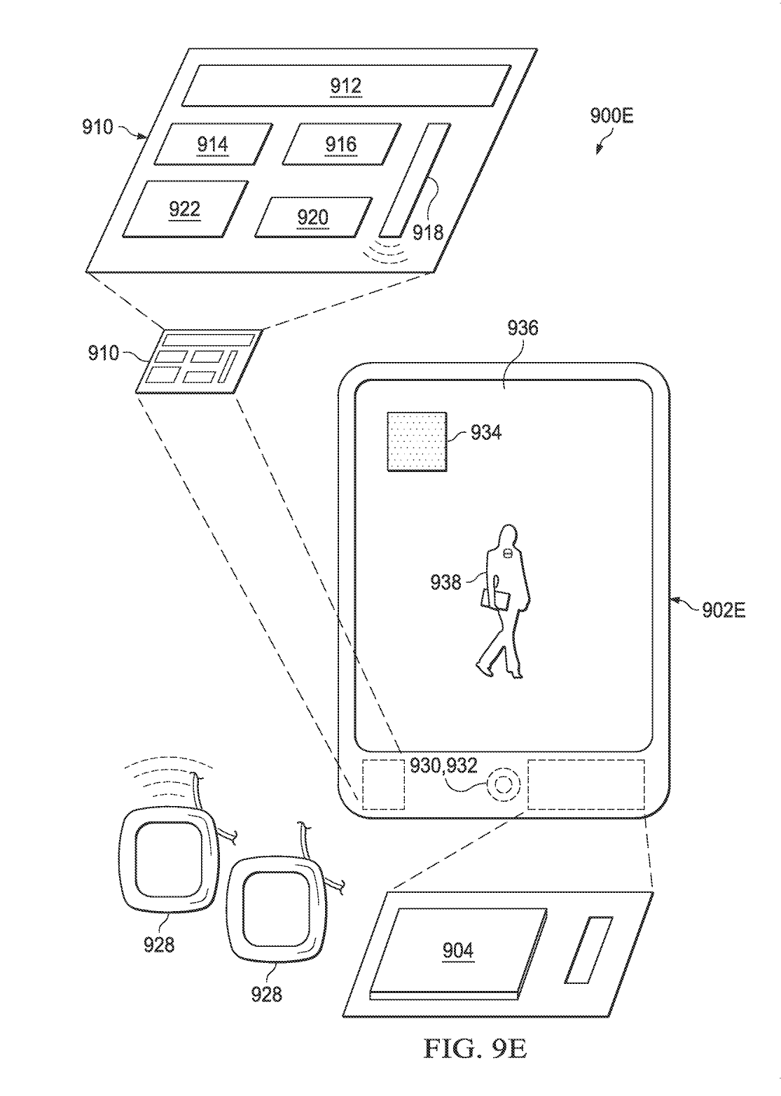

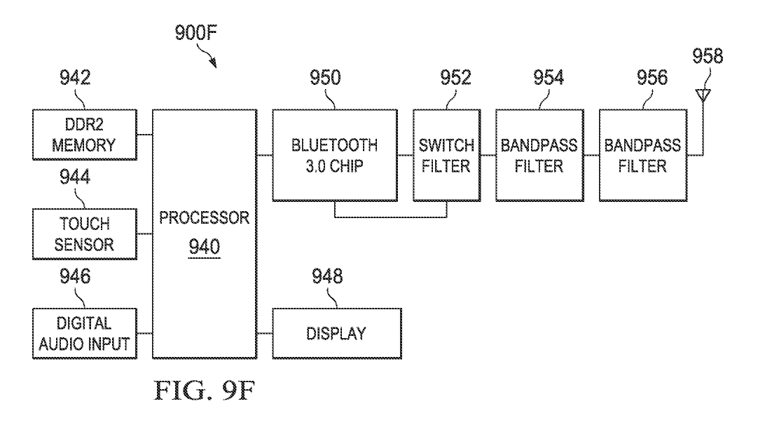

FIGS. 9A-9F illustrate signal generation units in accordance with embodiments of the disclosure. In FIG. 9A, a signal generation unit 900A may correspond to a pendant with various electronics to enable programming and broadcasting of dynamic visual signals. More specifically, the signal generation unit 900A may comprise a touch sensitive liquid crystal signal broadcasting display 906 or a curved display as well as a circuit board 910 and a battery 904 for powering the electronics of the signal generation unit 900A. The touch sensitive liquid crystal signal broadcasting display 906 and other electronics may be housed in a case 902A with or without I/O buttons. Without limitation to other embodiments, the circuit board 910 may comprise a display connector 912, a Bluetooth 3.0 networking processor 920 and antenna 918 providing connectivity to smart mobile platforms such as a cell phone or ultra-mobile PC. The circuit board 910 also may comprise a processor 922 for managing signaling commands and providing additional second-screen capability. The circuit board 910 also may comprise a memory 914 to store data, instructions, and/or display data. The circuit board 910 also may comprise a display controller 916. The functions of the circuit board 910 may be integrated into an application-specific integrated circuit (ASIC) or system on a chip (SoC). The signal generation unit 900A can be worn as a pendant, attached to a mobile device with a magnet, or attached to a mobile device case which integrates a compartment for housing the signal generation unit 900A. Alternatively, the signal generation unit 900A may be worn as a wrist watch or bracelet where the signaling mechanism may wrap around the wrist providing multiple visible angles for dynamic visual signal broadcast.

In FIG. 9B, a signal generation unit 900B may correspond to a bracelet with various electronics to enable programming and broadcasting of dynamic visual signals. More specifically, the signal generation unit 900B may comprise a touch sensitive curved display 924 as well as a circuit board 910 and a battery 904 for powering the electronics of the signal generation unit 900B. The touch sensitive curved display 924 and other electronics may be housed in a case 902B with or without I/O buttons. The components of the circuit board 910 and their operations are the same or are similar to those described for FIG. 9A. The signal generation unit 900B may be worn as a wrist watch or bracelet where the signaling mechanism may wrap around the wrist providing multiple visible angles for dynamic visual signal broadcast.

In FIG. 9C, a signal generation unit 900C may correspond to a purse or bag with various electronics to enable programming and broadcasting of dynamic visual signals. More specifically, the signal generation unit 900C may comprise a touch sensitive liquid crystal signal broadcasting display 906 or a curved display as well as a circuit board 910 and a battery 904 for powering the electronics of the signal generation unit 900C. The touch sensitive liquid crystal signal broadcasting display 906 and other electronics may be housed in a case 902C with or without I/O buttons. The components of the circuit board 910 and their operations are the same or are similar to those described for FIG. 9A. The signal generation unit 900C may be carried as a bag where the signaling mechanism may be placed on multiple surfaces to enable a broad area of visibility.

In FIG. 9D, a signal generation unit 900D may correspond to a pendant or wearable object with various electronics to enable programming and broadcasting of dynamic visual signals. More specifically, the signal generation unit 900D may comprise a touch sensitive liquid crystal signal broadcasting display 906 or a curved display as well as a circuit board 910 and a battery 904 for powering the electronics of the signal generation unit 900D. The touch sensitive liquid crystal signal broadcasting display 906 and other electronics may be housed in a case 902D with or without I/O buttons. The components of the circuit board 910 and their operations are the same or are similar to those described for FIG. 9A. The signal generation unit 900D also may comprise a camera interface 930A and/or a 3D camera interface 930B. Further, the signal generation unit 900D may comprise an infrared interface 932A and/or a 3D infrared interface 932B. The signal generation unit 900D may be worn as a wrist watch or bracelet where the signaling mechanism may wrap around the wrist providing multiple visible angles for dynamic visual signal broadcast. Further, the camera interfaces 930A, 930B and the infrared interfaces 932A, 932B may be positioned on the signal generation unit 900D to enable observation and detection of signals broadcast by other signaling devices.

In some embodiments, the signal generation unit 900D may operate as a 3D signal receiving device with infrared sensor technology integrated into a mobile platform. The infrared sensor technology may, for example, add image overlay of human body forms and sizes via heat signature over multiple frames of capture with the benefits of: 1) determining and corroborating dynamic visual signal broadcasting device placement; 2) signal detection when dynamic signaling devices are worn by individuals; 3) estimating distance from individuals and improving social data overlay placement and orientation; and 4) sensing direction of movement. Furthermore, the signal generation unit 900D may employs a stereoscopic camera array with the benefits of: 1) receiving stereoscopic input for multiple signal broadcasting devices within a scene co-collected with a stereoscopic background scene; 2) providing distance data for observed signals via triangulation of signals observed for overlay placement and 3D mapping of broadcasting devices within a 3D geospatial map; and 3) improving angle of view for broader area of collection of visual data for detection and identification of nearby dynamic signaling devices.

In FIG. 9E, a signal generation unit 900E may correspond to a portable electronic device such as a cell phone, a smart phone, a tablet, a personal digital assistant (PDA), or other portable device with various electronics to enable programming and broadcasting of dynamic visual signals. More specifically, the signal generation unit 900E may comprise a touch sensitive liquid crystal signal broadcasting display 936 or a curved display as well as a circuit board 910 and a battery 904 for powering the electronics of the signal generation unit 900E. The touch sensitive liquid crystal signal broadcasting display 906 and other electronics may be housed in a case 902E with or without I/O buttons. The components of the circuit board 910 and their operations are the same or are similar to those described for FIG. 9A. In at least some embodiments, a portion 934 of the touch sensitive liquid crystal signal broadcasting display 936 is dedicated to dynamic visual signaling. The signal generation unit 900E also may comprise a camera interface 930 and/or infrared interface 932 on the opposite side relative to the user for use in capturing images, video, and/or dynamic visual signals.

For signal generation units 900E with a non-transparent display, the primary display area of the mobile platform itself has the benefit of broadcasting dynamic signals though it suffers from the possibility that it will be pointed toward the user and not directed toward observing signal sensing devices. Meanwhile, for signal generation units 900E with a transparent display, a reflective display may be employed for display of social overlay data without the need for backlighting. Further, simultaneous dynamic signal broadcast to observing devices is possible even in well-lit or outside areas as the reflective display elements are actually brighter with increased ambient light. In some embodiments, signal generation units 900E with transparent display technology are able to employ the primary display to simultaneously broadcast dynamic signals and to provide the social overlay visualization interface including display of social data over real-world images 938 captured by a signal generation unit 900E. The display 936 may either redisplay the background or retain transparency and overlay social data. In some embodiments, signal generation units 900E may operate as a combination signal broadcasting and receiving device in a multi-purpose mobile platform with a transparent-display employed for social data overlay on the observing side of the device, a wide angle lens producing optically distorted images into a digital camera requiring post-processing for spatial correction and interpretation of the dynamic visual signal.

In FIG. 9F, a signal generation unit 900F comprises various components to enable programming and broadcasting of dynamic visual signals. As shown, the signal generation unit 900F comprises a processor 940 coupled to DDR memory 942, a touch sensor 944, and a digital audio input 946. The signal generation unit 900F also may comprise a display 948, a Bluetooth 3.0 chip 950 (e.g., with integrated flash memory), a switch/filter 952, bandpass filters 954 and 956, and antenna 958.

The components shown for signal generation unit 900F may be integrated on a circuit board (e.g., circuit board 910) and may be powered by a battery (e.g., battery 904). The circuit board may provide interconnection between the processor 940 and the Bluetooth chip 950, the memory 942, the display 948, and/or other components. Further, some or all of the components of the signal generation unit 900F may be part of a system on a chip (SoC). In some embodiments, the processor 940 correspond to a multi-core low power RISC architecture processor with I/O interfaces to support the signaling display, memory, sensory inputs (e.g., audio, touch, and gesture), and other peripherals (e.g., Bluetooth 3.0 radio connectivity). The computing requirement for the processor 940 may be based on criteria such as display size, network connectivity, use as a application platform, and/or complexity/speed of dynamic visual signal vocabulary. In at least some embodiments, the signal generation unit 900F has the capability to run applications and broadcast a set of hundreds of generational signals on a VGA class display based on a low power computing platform. The platform described for the signal generation unit 900F is suitable for pendants, bracelets, fashion accessories, bags, cell phones, smart phones, or other signal generation units including those described herein.

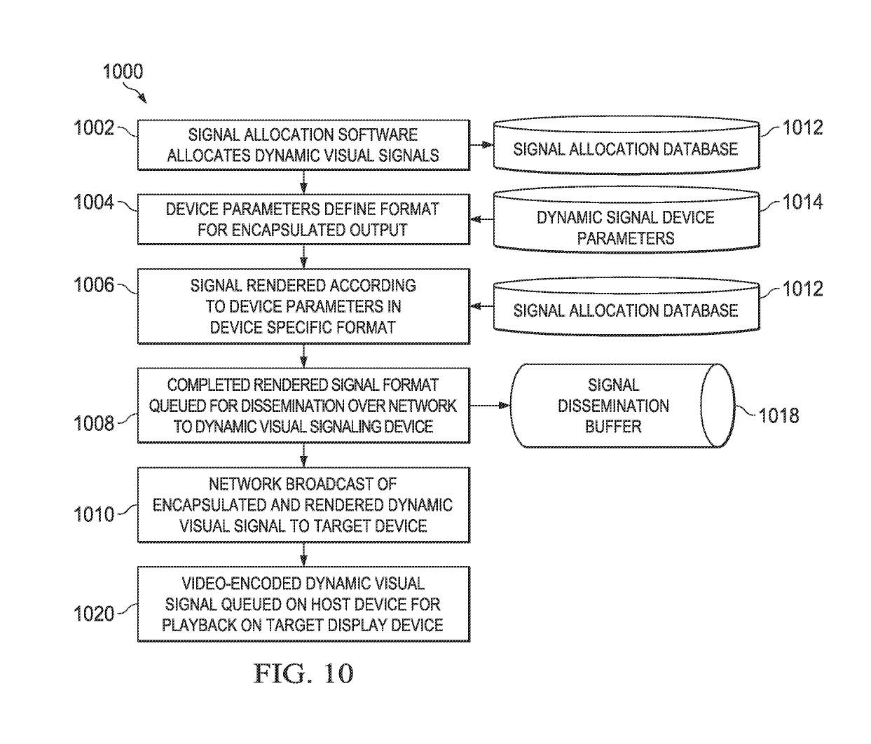

FIG. 10 illustrates a signal encapsulation and rendering technique 1000 in accordance with an embodiment of the disclosure. As shown, the signal encapsulation and rendering technique 1000 comprise signal allocation software allocating dynamic visual signals (block 1002). The allocated dynamic visual signals may be stored in a signal allocation database 1012. At block 1004, device parameters define the format for encapsulated output. The device parameters may be provided by a dynamic signal device parameters database 1014. At block 1006, a signal is rendered according to device parameters in a device-specific formal. The rendered signal may be based on information obtained from the signal allocation database 1012. At block 1008, a completed rendered signal format is queued for dissemination over a network to dynamic visual signaling device. In some embodiments, the completed rendered signal format may be stored in a signal dissemination buffer 1018. At block 1018, a network broadcasts encapsulated and rendered dynamic visual signals to target devices. At block 1020, video-encoded dynamic visual signals are queued on host devices for playback on target display device.

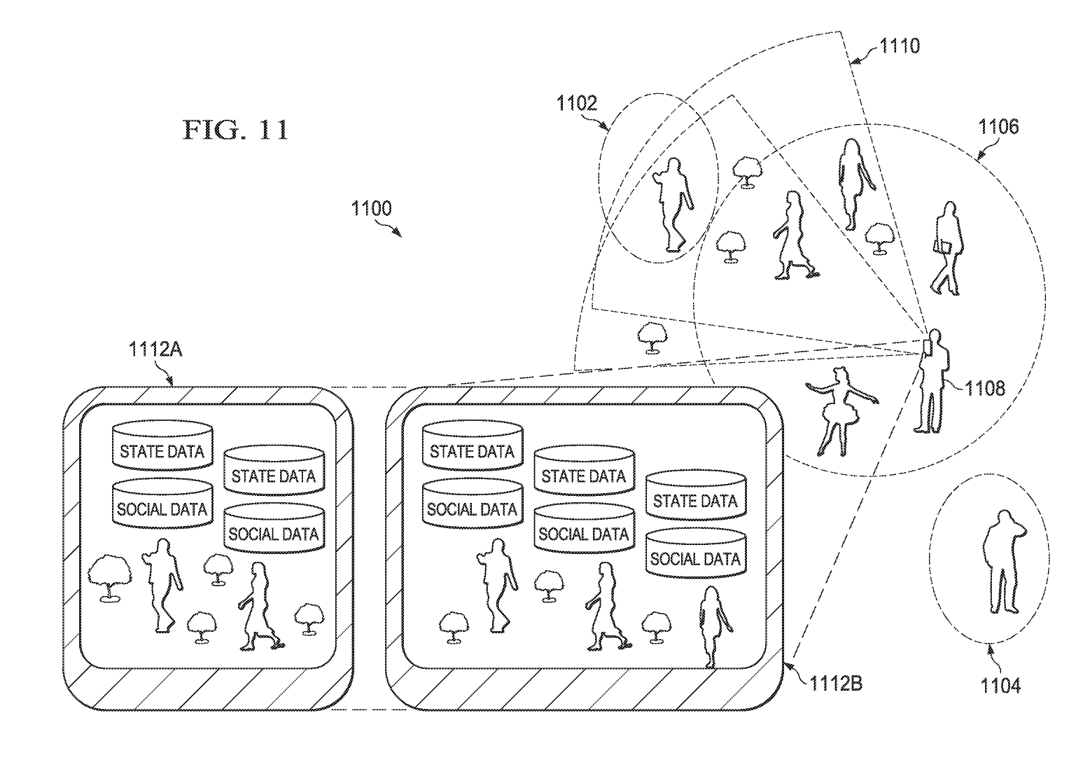

FIG. 11 illustrates a scenario 1100 of broadcasting and observation of dynamic visual signals in accordance with an embodiment of the disclosure. In the scenario 1100, vicinities 1102, 1104, and 1106 are in near proximity and contain signaling individuals. Further, scenario 1100 shows an observer 1108 in vicinity 1104. The observer 1108 has an observational field of view that includes vicinities 1102 and 1104. In scenario 1100, the observer 1108 employs an observing device 1112 to observe state data and/or social data overlaid on the background scene (e.g., natural or manmade objects) for various signaling individuals within vicinities 1102 and 1104. The background scene frame may be formed by imaging the background scene employing the visual sensor of the observing device and forming a background scene frame in a display buffer. The observing device 1112 accesses or receives social data and state data for multiple signaling device devices (e.g., from an online social data allocation software). The state data and/or social data in the observed frame is displayed in relation to the broadcasting individuals through reference points and offsets relative to the location of the broadcasting device in the background scene frame. As the observer 1108 shifts the position of the observing device 1112, the display of state data and/or social data overlay is updated by relocating the social data to new points of reference defined by the new positions of observed signals against the new position of the background scene frame. In some embodiments, the background scene frame may be combined with the state data and/or social data overlay in the frame buffer and output to the display of the observing device 1112.

In some embodiments, dynamic signal multiplexing is employed to compensate for uncertainty in line of sight and timeliness of position data through mapping of multiple vicinities to a signal broadcasting device. A benefit of providing the signal allocation data for individuals in multiple vicinities to an observing device is permitting social data to be available to an observing device regardless of prior locations of broadcaster and observer. Multiple state and vicinity mappings can be thus assigned to an individual corresponding to past and potential vicinity associations while maintaining little or no overlap in any given vicinity assignment. In addition, vicinities instantiate rules specific to their location, social attributes/characteristics of individuals, varieties of state data, and characteristics of the signal broadcasting device as individuals move from vicinity to vicinity. Multiplexing dynamic signals orders signals such that a signal broadcasting device/individual may be simultaneously identified across multiple vicinities employing primary, secondary, tertiary and beyond generational signal assignments. An identity and set of state data can be assigned to vicinities and lines of sight likely to belong to an individual through signal multiplexing without creating false positives associated with multiple instances of the same signal in the same vicinity in the same multiplex position.

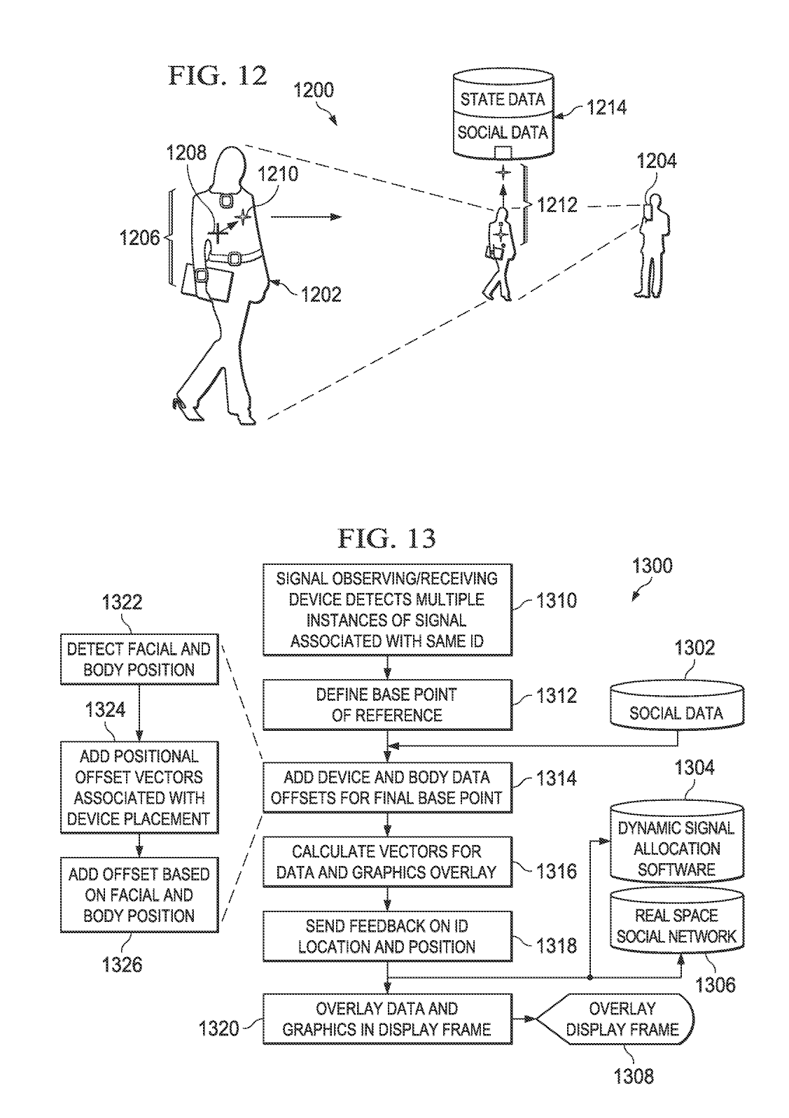

FIG. 12 illustrates a data overlay scenario 1200 when observing multiple dynamic visual signaling devices in accordance with an embodiment of the disclosure. In scenario 1200, one signaling individual 1202 employs a plurality of signaling devices 1206, 1208, and 1210, where one of the signaling devices 1206, 1208, and 1210 is more visible to an observing device 1204 in a particular line of sight 1212. In scenario 1200, the observing device 1204 interprets an observed signal and the scene to align and overlay social data, state data and/or graphics. In some embodiments, the observing device 1204 may use a mean point of device placement and add offsets for points of interest such as likely device placement (e.g., belt, wrist, chest) and facial location. Such points of interest may be used for display of social data and graphics overlay improving the observer's ability to clearly distinguish the background scene and individuals in the context of overlay data and graphics (e.g., the facial location may be avoided when displaying social data or graphics. Overlay placement vectors for social data, state data, and/or graphics display may be calculated and used, for example, to adjust for device locations and for data and graphic-specific offsets.

FIG. 13 illustrates a data overlay technique 1300 related to the data overlay scenario 1200 of FIG. 12 in accordance with an embodiment of the disclosure. In data overlay technique 1300, a signal observing/receiving device detects multiple instances of signals associated with the same identifier (block 1310). At block 1312, a base point of reference is defined. At block 1314, device and body offsets are added for a final base point. When performing the step of block 1314, various steps may be performed including detecting a facial and body position (block 1322), adding positional offset vectors associated with device placement (block 1324), and adding offset based on facial and body position (block 1326). Further, information from social data database 1302 may be considered when performing the step of block 1314. At block 1316, vectors are calculated for data and graphics overlay. At block 1318, feedback on identifier location and position is sent. For example, the feedback sent for block 1318 may be sent to dynamic signal allocation software 1304 and to a real space social network 1306. At block 1320, data and graphics is overlaid in a display frame, which is represented by block 1308.

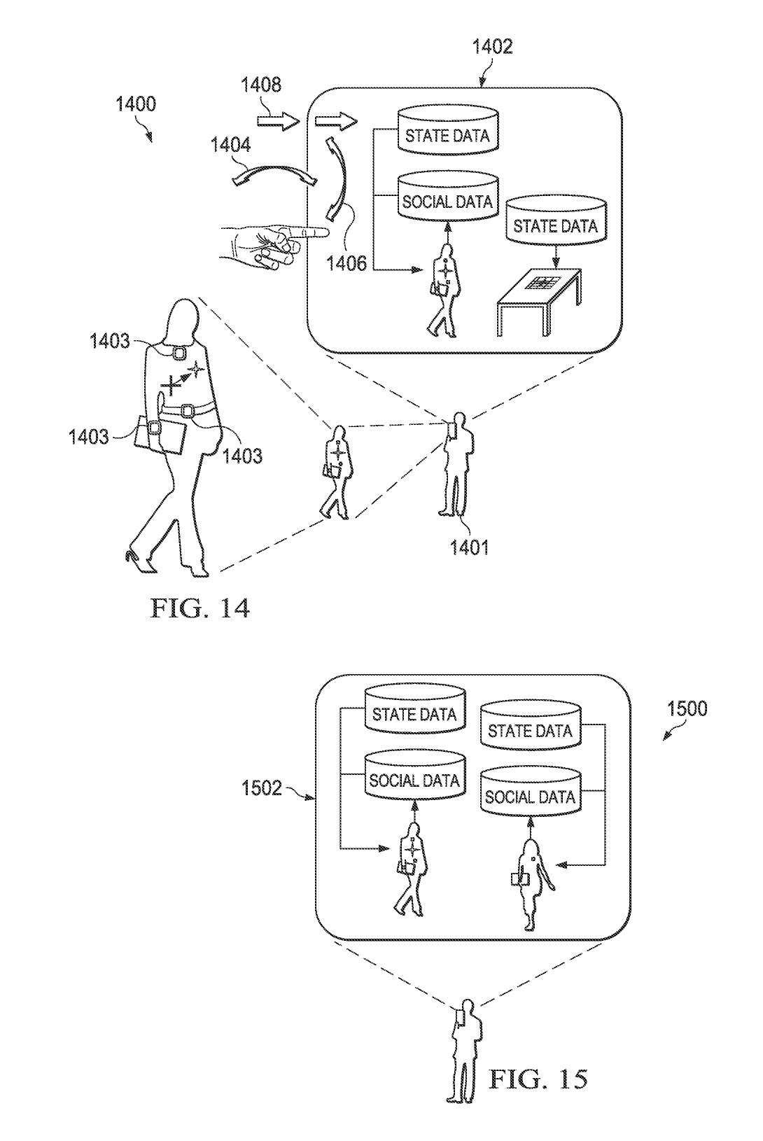

FIG. 14 illustrates a data overlay scenario 1400 in accordance with an embodiment of the disclosure. In the data overlay scenario 1400, dynamic visual signals from signal broadcasting devices 1403 are observed by an individual employing dynamic visual observing/sensing device 1401. In response to the observed dynamic visual signals, data overlays state, social data, and/or graphics are displayed on a screen 1402 with the benefit of displaying a multiplicity of information types and visualizations associated with individuals, places, time, geospatial areas, the state of real and virtual objects, and alternate versions of real objects or visuals. A further benefit is that the dynamic signal broadcasting devices 1403 worn by a single individual and assigned to a single referent identity may have their positions combined to form a center point. Further, offsets based on device positions, and overlay placement vectors for positioning data and graphics of the overlay on the background scene 1402 may be used. Another feature of the observing signal sensing device is ability of the user to create rules for information display and customize a multiplicity of display options. The rules and customizations include but are not limited to degree of transparency of the data and graphics overlays, data order and priorities, interactive data options, automated data extraction, analysis and flagging, level of zoom and perspective on the scene, overlay placement vector parameters, order and priority of data display are actively managed by the host software according to user preferences.

In some embodiments, the observing device 1401 may employ a graphical user interface to display social data derived from dynamic visual signals. Further, the social data may be navigated by touch with gestures including a horizontal swipe 1404 over data to navigate additional data, a vertical swipe 1406 to exchange additional data types, a single tap 1408 to select or hyperlink through data, and a double tap 1410 to expand or activate data and visualizations. For interactive data and graphics (e.g., a game of chess), specific touch strokes and voice commands are employed to interact with the object and modify the state.

In some embodiments, the overlay of visualizations on screens of dynamic visual signaling devices derived from signals broadcast of dynamic visual signaling devices creates state and social representations upon a background image which may be manipulated to improve the ability of the user to interact with state data systems and social data systems. State data and social data may be presented as surfaces, 3D visual objects, interactive models, additional visual representations, and/or related depictions with the benefit of providing a visual interface to state systems and social systems displayed as interactive applications or application widgets on an observing device. Hand gestures including rotational swiping, up and down switching, and touch manipulate visualizations and provide input to state and social systems and the interactive applications deployed to represent them on observing devices. Hand gestures have the benefit of allowing data and visualizations to be manipulated in a visual space directly upon a background scene with defined points of reference, to signaling devices with offsets permitting proper placement and modification of the visualization, surfaces, objects, and interactive models with respect to the observing device and background scene. Interactive models and visualizations can include advertisements, game boards, visual representations of people such as a virtual presence or avatar, a visualization of a person's face, a broadcast or stored video, 3D models, 3D models of interactive objects, 3D models of movable and form-modifiable objects and other useful visualizations associated with state and social data, systems, and applications.

In the case that the signal receiving device employs multiple sensors, where at least one sensor is employed for collecting the ID and state signals, the ID and state signals are visually fused employing a time and spatial alignment algorithm to align the ID and state signals with the base image. In this case the observing system collects ID and state signals and defines the location of those signals in the composition of an overlay, applying to that overlay base image data collected by the other sensors. In this instance, the base image may be 2D or 3D stereoscopic image forming a base image and the ID and state overlay may also be stereoscopic forming a 2D or 3D overlay. These two images are fused to create a 2D or 3D image combining the base scene and social data and multiple state overlays associated with the identity of the dynamic visual signaling device.

FIG. 15 illustrates a scenario 1500 with multiple simultaneous data overlays in accordance with an embodiment of the disclosure. In scenario 1500, adjustments in offsets and base points of interest allow social data to be aligned with dynamic visual signals in observing device overlays 1502 to improve visualization of social and state data where multiple overlay visualizations are present. Overlay placement vectors for social data and state data may be modified to accommodate additional visual elements by calculating the spatial requirements of each element in their unmodified position, determining the magnitude of overlap of visual elements, and creating offset vectors. Offset vectors are added to overlay placement vectors in 2D or 3D space or entered into a 3D space spacing algorithm to minimize overlap while maintaining closest proximity to the associated signaling device will minimize occlusion viewed in 2D and may be employed to manage rotation around multiple 3D visualizations from multiple base points associated with multiple identities. The set of offset vectors creates the input to the observing device social overlay engine which employs the offset vectors for placement of the state and social data and visualizations.

Generally GPS data will not be reliable enough or of adequate accuracy to determine distance and provide z-values for observed identities and the display of data and visualizations by observing devices. However, dynamic visual signal element size as observed over time is useful in providing estimates of relative distance of observed devices. In addition, calibrating features of dynamic visual signals are clearly useful in simple comparisons to calibrating features and observed sizes of signaling elements. Determining which identities, social, and state data are presented in front of others can therefore be enhanced by measures of the size and pixel count of observed signals with the benefit of providing data adequate for setting initial priority for front to back placement when overlap of visualizations is required or desired by users. Avatar placement or visualizations intended for placement in a fixed proximity to the device benefit from occlusion processing with dynamic visual signals allowing visualization for nearest identities to be initially set forward emulating true perspective. Users have the ability to pan, zoom, and interact with multiple objects visually aligned to dynamic visual signals with managed occlusion in 3D space. Background scenes fused with panoramic and 3D enhancement technology similarly benefit from the z values and placement of social and state data in 3D space allowing background scenes with a degree of 3D placement of objects in the background scene to have improved visual correspondence with associated social and state data for observed dynamic visual signal identities and their social and state data. Similar to gestures which allow for interaction with state and social data, gestures may be employed for moving data into foreground and background placement such as the creation of specific buttons and spaces placed in close proximity to social and state data, and swiped up or down through social and state data to represent bring forward and move backwards.

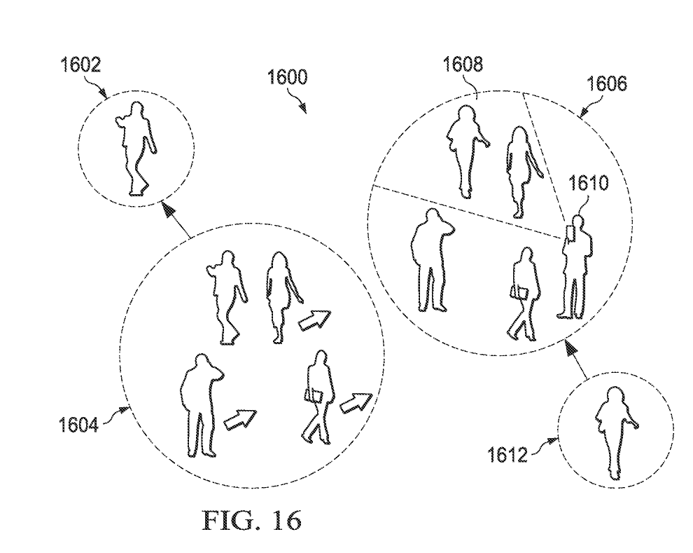

FIG. 16 illustrates a scenario 1600 with use of multiple instances of a limited signal set for distinct amebic vicinities in accordance with an embodiment of the disclosure. In scenario 1600, as signal broadcasting devices/individuals move from one vicinity to another they are assigned a unique signal within their present vicinity. For example, scenario 1600 shows a signal broadcasting device/individual move from vicinity 1604 to vicinity 1602. Further, multiple signal broadcasting devices/individuals move from vicinity 1604 to vicinity 1606. Further, a signal broadcasting device/individual moves from vicinity 1612 to vicinity 1606. In vicinity 1606, an observer 1610 has a field of view 1608 that includes at least some of the signal broadcasting devices/individuals in vicinity 1606.

In some embodiments, when a signal broadcasting device/individual moves out of a vicinity, the corresponding signal is generational and later released to others subsequently entering that vicinity. In this manner, a small and easily distinguished signal set may be employed in a plurality of instances on a global scale. Generational signaling further allows each signal broadcasting device/individual to be mapped to multiple vicinities communicating multiple states while maintaining the integrity/uniqueness of the mapping in any given vicinity.

As an example of scenario 1600, an observer may point a camera of a signal observing device toward signaling individuals and entities. The signal observing device receives signals from a plurality of signal broadcasting devices and assigns a location to each signal broadcasting device within a scene. The signal observing device also may correlate observed signals with a signal map associated with the signals as well as with social data. The signal map may be provided, for example, by signal allocation software located on a remote server over a network connection such as in Internet connection. The signal observing device may display social data as an overlay positioned in relation to observed signals in a scene and/or according to rules set by the observer or social overlay visualization system. In scenario 1600, signaling individuals move about intending to broadcast identity bound social and state data to others nearby. The signal broadcasting device within a vicinity receives instructions to broadcast distinct signals for a finite period of time before new signal instructions are given. In some embodiments, signal broadcasting devices may employ generational signaling to convey past, present, and future state information corresponding to past states, past locations, future anticipated states, and/or future anticipated locations.

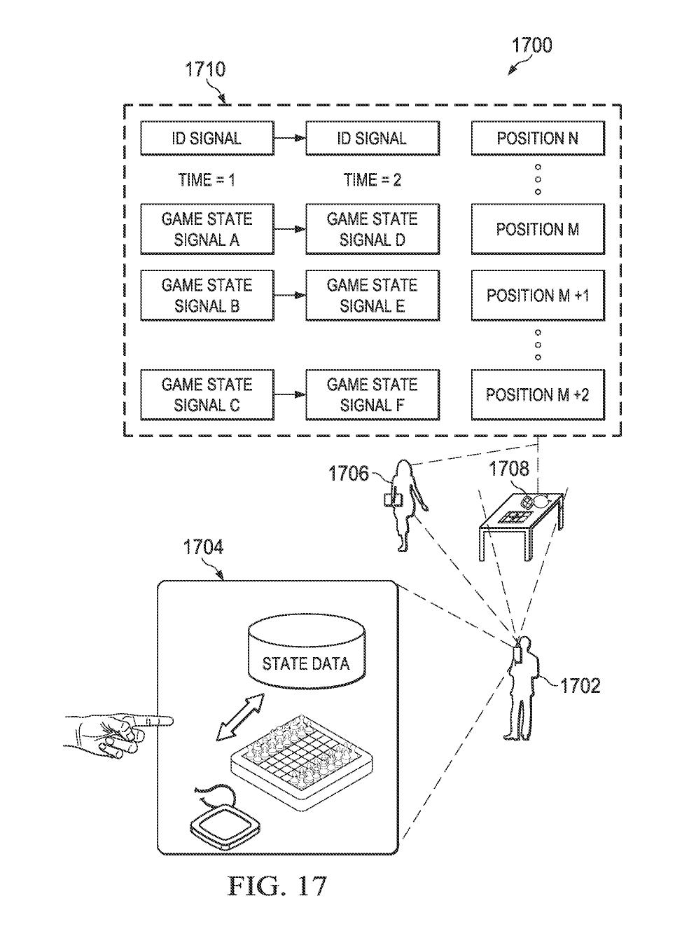

FIG. 17 illustrates a scenario 1700 for managing dynamic visual signals in accordance with an embodiment of the disclosure. In scenario 1700, social overlay visualization is implemented with interactive objects such as games, models, collaborative virtual environments, and other combinations of virtual visualizations and data. For example, individuals may broadcast device identity and social data reflecting updates, changes, and moves with generational dynamic visual signals. As used herein, “generational dynamic visual signals” refer to dynamic visual signals that are based, in part, on previous dynamic visual signaling for an individual. Since generational dynamic visual signals are in the context of a dynamic visual signaling device, there is a benefit that neither datum can be discerned by individuals who lack permission defined by user established rules to access that information. These rules control social data access such that users can protect access to information on the nature and state of their interactive activity while performing these activities in public spaces. A further benefit is that multiple players view the interactive space and objects as if they exists in real space, enabling for example a virtual chess board visible on a real table, a piece of virtual clothing upon a real individual, and any other overlay data and graphical image upon real space.

In scenario 1700, an observer 1702 employs a dynamic visual signaling sensing device to observe a scene containing a dynamic visual signaling device 1708 assigned to an individual 1706 similarly observing the dynamic visual signaling device 1708 and sharing a visualization 1704 customized for their point of view and relationship to the visual and state of the interactive virtual object. Applications may employ gesture control to manipulate and change the state of interactive objects subsequently reflected in the online social state data and distributed according to the rules of the interactive object to those observers 1706 and 1702 with access to the virtual interactive object and social data. State data is transmitted locally and is modified over time according to changes in the online state data using data multiplexing as shown in chart 1710.

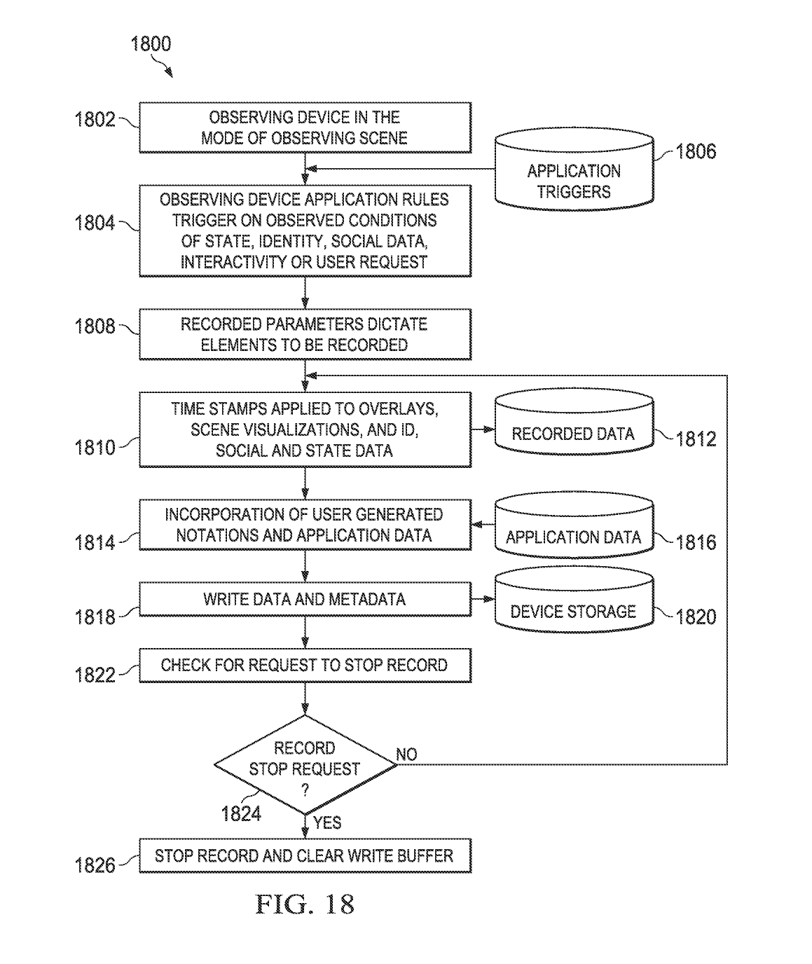

FIG. 18 illustrates a social overlay visualization recording operation 1800 in accordance with an embodiment of the disclosure. In operation 1800, an observing device is in a mode for observing a scene (block 1802). At block 1804, the observing device application rules are triggered on observed conditions of state, identity, social data, interactivity, or user request. The application triggers may be provided by an application triggers database 1806. At block 1808, recorded parameters dictate elements to be recorded. At block 1810, time stamps are application to overlays, scene visualization, identifiers, social data, and state data. The time stamps and/or other information may be stored by a recorded data database 1812. At block 1814, user generated notations and application data is incorporated. The application data may be received from application data database 1816. At block 1818, data and metadata is written. For example, the data and metadata may be written to a device storage 1820. At block 1822, a check is performed to determine if a stop record is requested (block 1822). If a record stop is requested (determination block 1824), recording is stopped and a write buffer is cleared at block 1826. If a record stop is not requested (determination block 1824), the operation 1800 returns to block 1810.

In accordance with at least some embodiments, observing devices record experiences observed and interacted upon by retaining identity, state, and social data and application, sub-routine, and web-application renderings derived from dynamic visual signals and any other overlay data and visualizations upon background scenes. Social data provisioned by social data allocation software not originally visualized is also retained as stored metadata. Recording of scenes with associated dynamic visual signals and generational dynamic visual signals and associated identity, state, and social data has the advantage of allowing secondary and subsequent renderings, alternate scenario playback, search through social data, application-based subsequent construction of social metadata, viewing on remote and secondary displays, and reconstruction of scenes base upon data collected from multiple observing devices. Recording is particularly useful for subsequent mining and interaction with social and state data with the advantage of allowing interaction with identity and state systems of observed individuals. A game entered while observing an individual or fixed location dynamic visual signaling device may be continued by recording and retaining state data and resuming interaction subsequent to initial observation. Recording is enabled by users of observing devices and in accordance to rules established by users and applications based on user input and rule based applications. Recording is automatically initiated by applications designed to retain memories of flagged identities, states, and social data. Application-based rules await data with targeted parameter and initiate recording of all or targeted data with the advantage of selectively finding and organizing observed and received identity, social, and state data for improved categorization, organization, metadata generation, and provision of user notifications and notifications to applications taking as input cues from observation derived from recording and recorded-data processing applications. Playback on observing devices or remote devices is accomplished by displaying visualizations of identity, state, and social data with the original or a modified background scene.

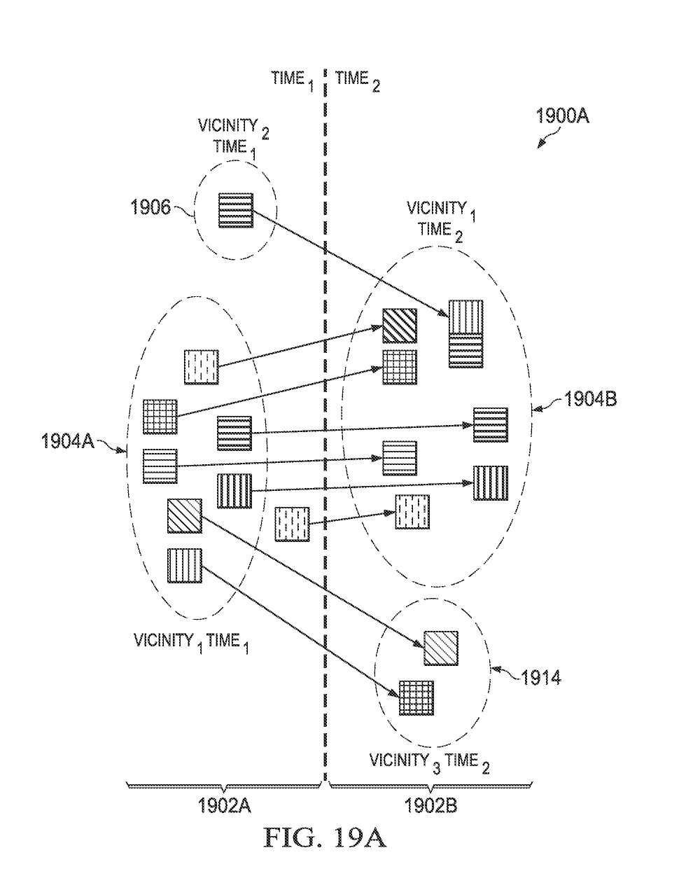

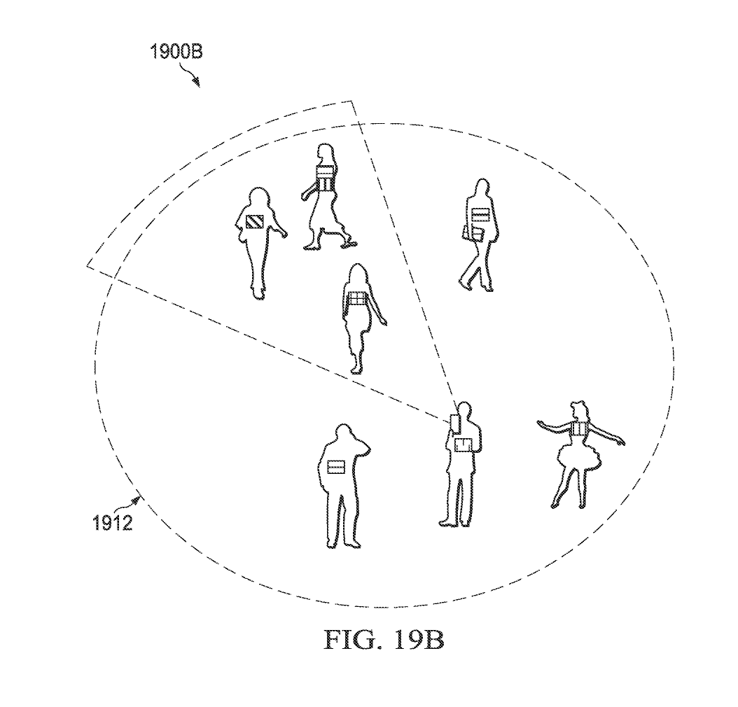

FIGS. 19A and 19B illustrate vicinity change scenarios over time in accordance with embodiments of the disclosure. In scenario 1900A, vicinity 1904A (vicinity₁time₁) and vicinity 1906 (vicinity₂time₁) are shown for a first time period 1902A. In a second time period 1902B, vicinity 1904B (vicinity₁time₂) and vicinity 1914 (vicinity₃time₂) are shown. In scenario 1900A, many of the devices in vicinity 1904A during the first time period 1902A stay in the same vicinity 1904B during the second time period 1902B. In addition, a device in vicinity 1906 during the first time period 1902A joins vicinity 1904B during the second time period 1902B. Further, a stray device during the first time period 1902A joins vicinity 1904B during the second time period 1902B. Further, a couple of devices of vicinity 1904A during the first time period 1902A become part of a vicinity 1914 during the second time period 1902B.

In scenario 1900A, the vicinities adapt in size and shape to accommodate the movement of individuals. Identity mapping is maintained while dynamic visual signaling is modified. Further, updates are provided to observers to maintain social data associations of an identity with new dynamic visual signals. In some embodiments, multiplexing of dynamic visual signals is implemented as individuals move between vicinities. For example, a device may request use of a new dynamic visual signal, an existing signal, or a generational signal when changing from one vicinity to another. Alternatively, movement of a device may be detected by a control system, which may automatically assign a new dynamic visual signal, an existing signal, or a generational signal when a device changes from one vicinity to another. Location information provided by a GPS unit or a user may be used to assign a device to a particular vicinity. As users move outside the range of a vicinity, their identifier and corresponding dynamic visual signal may be reassigned within that vicinity. If available, a user that enters a new vicinity may be able to retain the same identifier and/or the same dynamic visual signal. However, this assignment will only be valid within the current vicinity.

In scenario 1900B, a vicinity 1912 is shown. The vicinity 1912 is based on a system of dynamic visual identification and communication that combines geospatially oriented vicinities with a limited visual signal system which can be replicated across each vicinity. This system has the benefit of visual identification and state communication based upon a small number of highly discernible signals that allow individuals to enter and exit vicinities while retaining the integrity of identity mapping of visual signals. A further benefit is that the vicinity 1912 may move with its constituent members, diminishing refresh requirements and retaining accuracy in social data associations.

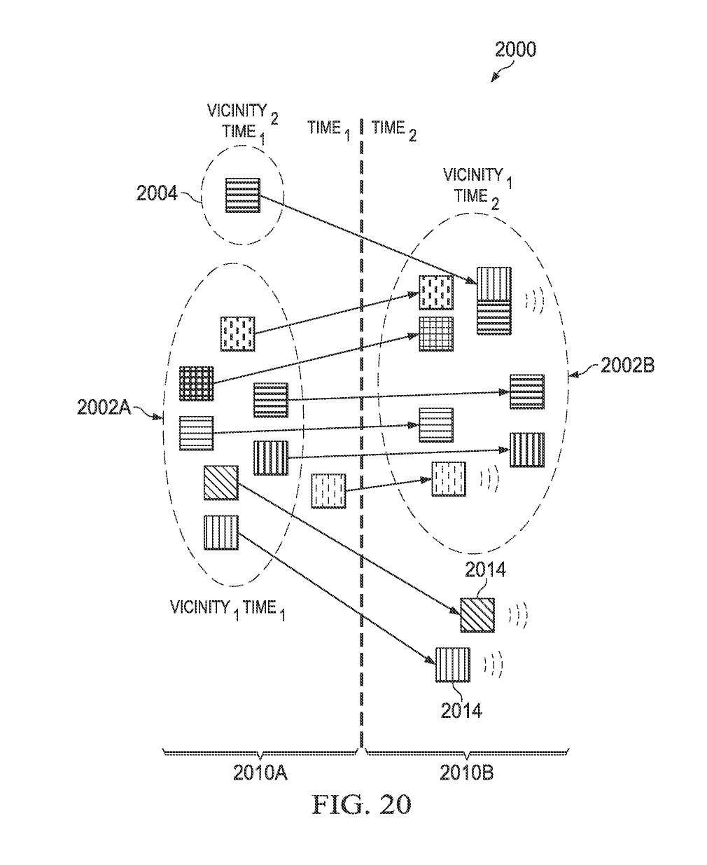

FIG. 20 illustrates a hybrid signaling scenario 2000 in accordance with an embodiment of the disclosure. In scenario 2000, vicinity 2002A (vicinity₁time₁) and vicinity 2004 (vicinity₂time₁) are shown for a first time period 2010A. In a second time period 2010B, vicinity 2002B (vicinity₁time₂) is shown. In hybrid signaling scenario 2000, devices in vicinity 2002A during the first time period 2010A stay in the same vicinity 2002B during the second time period 2010B. Further, some of the devices in vicinity 2002A during the first time period 2010A, are not assigned to vicinity 2002B during the second time period 2010N. In addition, during the second time period 1020B, at least some of the devices utilize radio frequency (RF) communications to set up or adjust dynamic visual signaling and/or signal observation options.

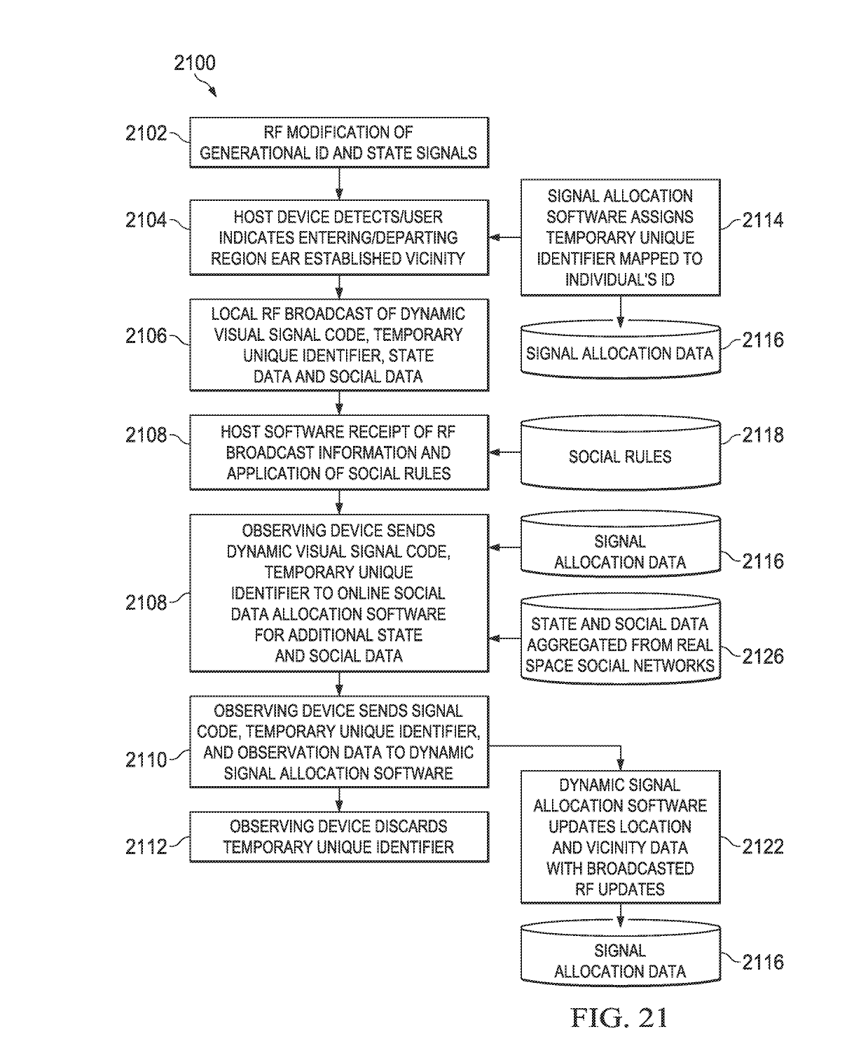

FIG. 21 illustrates a hybrid signaling technique 2100 related to the hybrid signaling scenario 2000 of FIG. 20 in accordance with an embodiment of the disclosure. As shown, the technique 2100 comprises RF modification of generational identifiers and/or state signals (block 2102). At block 2104, a host device detects or a user indicates an entering/departing movement near an established vicinity region. The step of block 2104 may be based, for example, on signal allocation software assigned temporary unique identifiers mapped to individual identifiers (block 2114). The assignments by the signal allocation software at block 2114 may be stored to signal allocation data database 2116. At block 2106, local RF broadcasting is used to transmit dynamic visual signals codes, temporary unique identifiers, state data, and/or social data. At block 2108, host software receives information and social rules by RF broadcast. The social rules may be provided, for example, by a social rules database 2118. At block 2108, an observing device sends dynamic visual signal codes and/or temporary unique identifiers to online social data allocation software for additional state data and social data. The dynamic visual signal codes for block 2108 may be received, for example, from the signal allocation data database 2116. Further, the state data and social data for block 2108 may be received, for example, from a database 2126 that stores state data and social data aggregated from real space social networks. At block 2110, an observing device sends signal codes, temporary unique identifiers, and observation data to dynamic signal allocation software. Thereafter, the observing device may discard any temporary unique identifiers at block 2112. The dynamic signal allocation software may also update location and vicinity data based on broadcast RF updates (block 2122). The updated location and vicinity data for block 2122 may be stored to the signal allocation data database 2116.

In some embodiments, local radio frequency broadcast may be employed to quickly update nearby observing devices on signal, state, and social data with the benefit of diminishing the reliance on local networks or the Internet for connectivity. RF data is useful in announcing new identities within a local area or vicinity by direct broadcast of signal metadata and identifying signal to nearby devices through reservation, selection, and broadcast of an identity signal within the local area. Direct communication may follow identification and interaction with state and social data, with data passing over peer to peer internet broadcast, Wi-Fi local broadcast, or local RF communication. Further, peer-to-peer communication and many kinds of web-based communication may be enabled in the course of interacting with the state and social data associated with ID's conveyed with dynamic visual signals with the advantage that the background scene and context of the interaction substantially enhance the user's context around the broadcasting user. Unlike the anonymity of web-based communication, the interaction in real-space as a starting point for applications to enable rich peer-to-peer and web-interaction experiences has the benefits of location based context, visual associations with broadcasting individuals, and the overall context of the social and physical scene. Wi-Fi broadcast and local RF direct communication are analogous for this discussion as they both offer dynamic signaling devices and their hosts to transmit information to nearby devices bypassing the long leap to the Internet and insertion in Internet based signal allocation software or state & social data allocation software.

Benefits of a dynamic visual state and identity broadcast device with device-to-device RF broadcast include: 1) local RF confirmation of current, past, and future visual tag displays; 2) RF corroboration of visual signal identification and vise versa for improved accuracy, and enhanced spatial tracking by using forward knowledge of upcoming visual signals to remain locked on to the individual as they or the point of view changes; 3) decreasing reliance on cloud-based communications and bandwidth primarily for local interaction applications; 4) confirmation of surrounding agents as a spatial indicator for use as an input to vicinity mapping; and 5) triangulation mapping augmented by visual signals. As an example, RF may be employed for triangulation between observing devices while position and visual signal information provides additional support for absolute position and motion tracking.

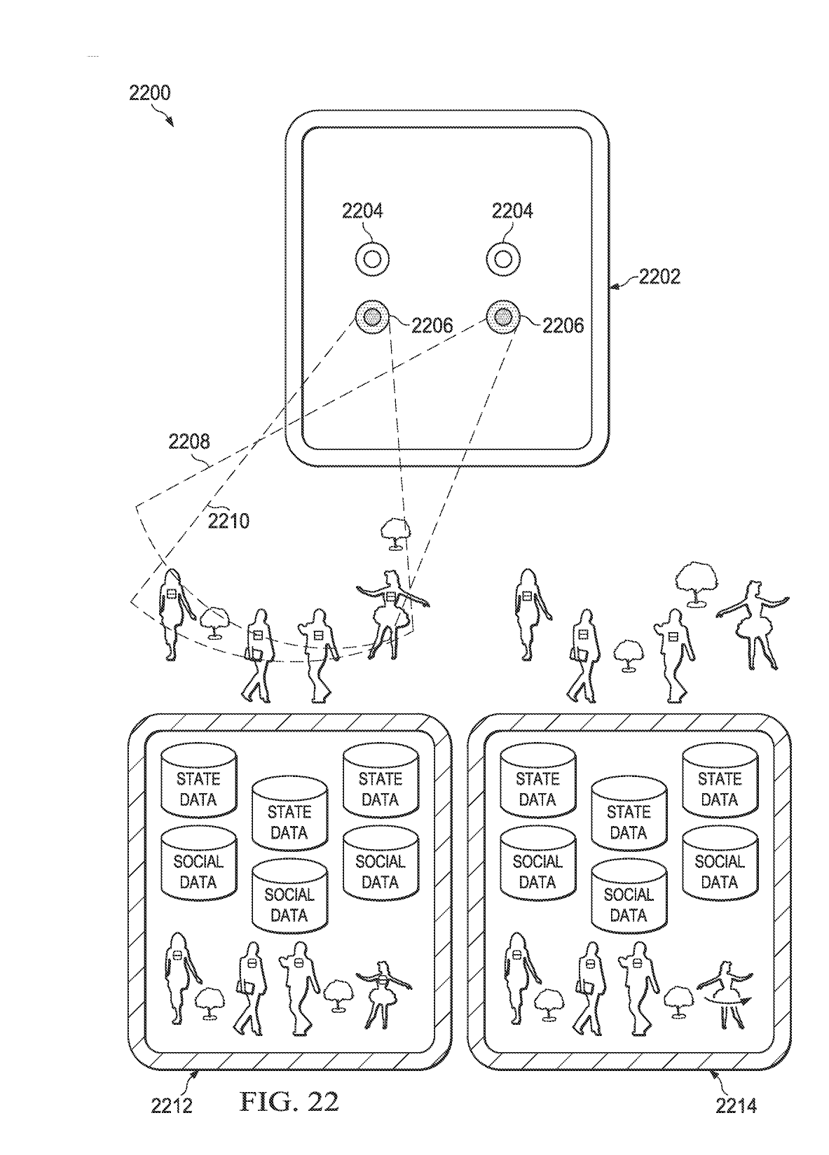

FIG. 22 illustrates an infrared use scenario 2200 in accordance with an embodiment of the disclosure. In scenario 2200, an observing device 2202 employs camera sensors 2204 and/or infrared sensors 2206 to observe different fields of view 2208 and 2210. A social overlay visualization view 2212 and 2214 is displayed on the observing device 2202 depending on the field of view with state data, social data, and/or graphics added to the corresponding field of view.

In some embodiments, the collection of infrared scenes by an IR sensor array 2206 of an the observing device 2202 enhances the detection of dynamic visual signals through the presentation of an image layer where body form may be readily detected and may be used to narrow the search region for dynamic visual signals from other visual data collected by a visual sensor array 2204 or 2206. Images extracted as body forms by an IR extraction algorithm are geometrically defined and aligned to the image layer of the collected visual array defining regions for dynamic visual signal detection with the benefits such as: 1) setting priorities for frame regions of analysis for signal extraction; 2) reducing computational load for signal detection of mammals (dogs may wear signaling devices); 3) providing regional specificity when broadcasting device signal metadata provides information on signaling device type or worn location (wrist, neck, ankle); 4) aiding in the visual placement of identity, social, and application state by providing body regions geometry allowing precise placement of data around or upon the body form of the observed body form and an associated dynamic visual signal; 5) depth data based upon relative size of IR body form permitting incorporation of depth to size and place visualizations; and 6) creating data for frame to frame comparisons. Subsequent frame captures in subsequent time permit body tracking such that occlusion of the visual signaling devices may occur due to changes in body position relative to the observing device or line-of-sight interfering object while maintaining an identity map to the body form tracked from frame to frame and continuous presentation of subsequent scenes and visualizations associated with the tracked identity, social data, and application states.

In some embodiments, augmentation with 3D IR data via stereoscopic imaging permits additional depth and positional data for visualization presentation and visualization. Augmentation with 3D visual presentation permits point-of-view specific visual representation and 3D visualization of visualizations sourced obtained from dynamic visual signal identity, social data and application state data.

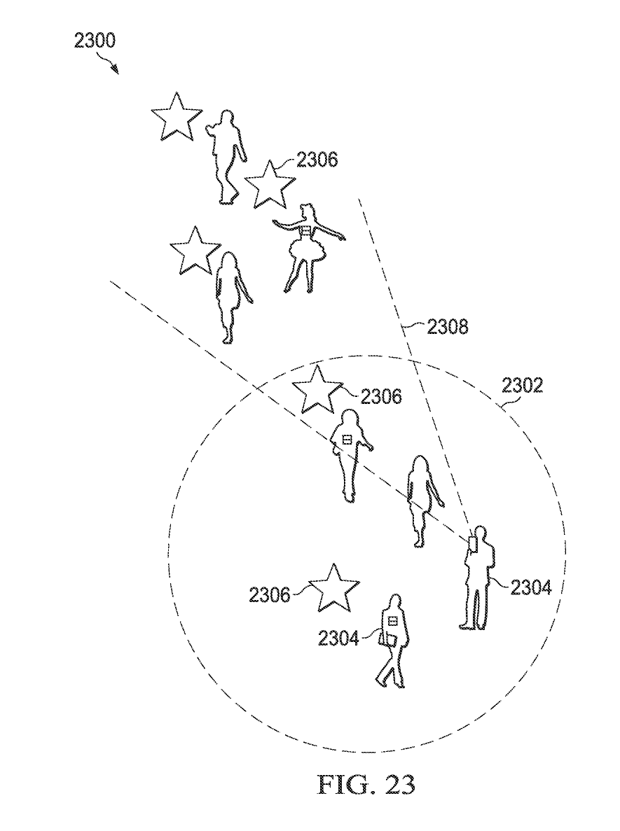

FIG. 23 illustrates a check-in data scenario 2300 in accordance with an embodiment of the disclosure. In the scenario 2300, an observer 2304 in vicinity 2302 has a field of view 2308 that includes user provided check-in data 2306.

In accordance with embodiments, observing devices are able to utilize and provide social network data based on user provided location data referred to herein as “check-in” data 2306. In the case that observed dynamic visual devices are observed and identified, data associating observed individuals with the check-in data 2306 of other observed individuals forms social data on presence in and around named locations based upon the check-in location of those observed. Check-in data 2306 also is employed to compose vicinities to ensure those users identified in a named location have metadata available for social overlay for observing devices when: 1) the observing user has manually checked into a named location; 2) social data accumulated for observed individuals has created automated associations with named locations; and/or 3) social data for observing individuals indicates their proximity to a named location.

In some embodiments, check-in data 2306 is automatically available to social data sources without the need for an observed individual to enter that data. The automatic incorporation of user-provided location data for dynamic signaling and non-signaling users indicates presence or proximity in relation to check-in locations. Location check-in data 2306 can serve as a proxy for GPS data to establish the membership, geospatial size, quantity of signal sending devices contained, velocity, and shape of vicinities.

User identified location data includes check-in data 2306 such as an individual person stating they are at a specific location, such as “The Pub” or “Yankee's Stadium” or “Jo's Café” in South Austin on S. Congress Avenue. Automated or pre-populated check-in data 2306 includes fixed location data assigned to dynamic visual signaling devices, in the case that a signal sending device is employed in a fixed location such as under a doorbell, integrated into a sign, placed in a window, fixed to a vehicle, and other placements where check-in location and associated social data are assigned by users to a dynamic visual signaling device.

A system which utilizes check-in data 2306 in conjunction with dynamic visual signaling has the advantage of accurate overlay of identity information upon the background scene of the check-in location, a more complete data set associated with a vicinity or location, and the ability to overlay check-in information on a background scene accurately placing identity and that state data in visual alignment with the checked-in individual. Without this system, social overlay would require another solution to accomplish an overlay of identity information, including hypothetical solutions such as large scale facial recognition systems or a highly accurate, large scale directional RF systems. The observing device has the added advantage of including data for individuals checked into a location but who do not possess visual signal devices or individuals who are broadcasting with dynamic visual signaling devices but may not currently be within the observed background frame or may not yet have been observed and detected by the observing device. This data augments the overlay created by the dynamic visual identity system by providing a list and navigation within the overlay for social data of individuals whose check-in or GPS data is known but whose precise location relative the overlay of the background scene is unknown or outside of the current field of observation.

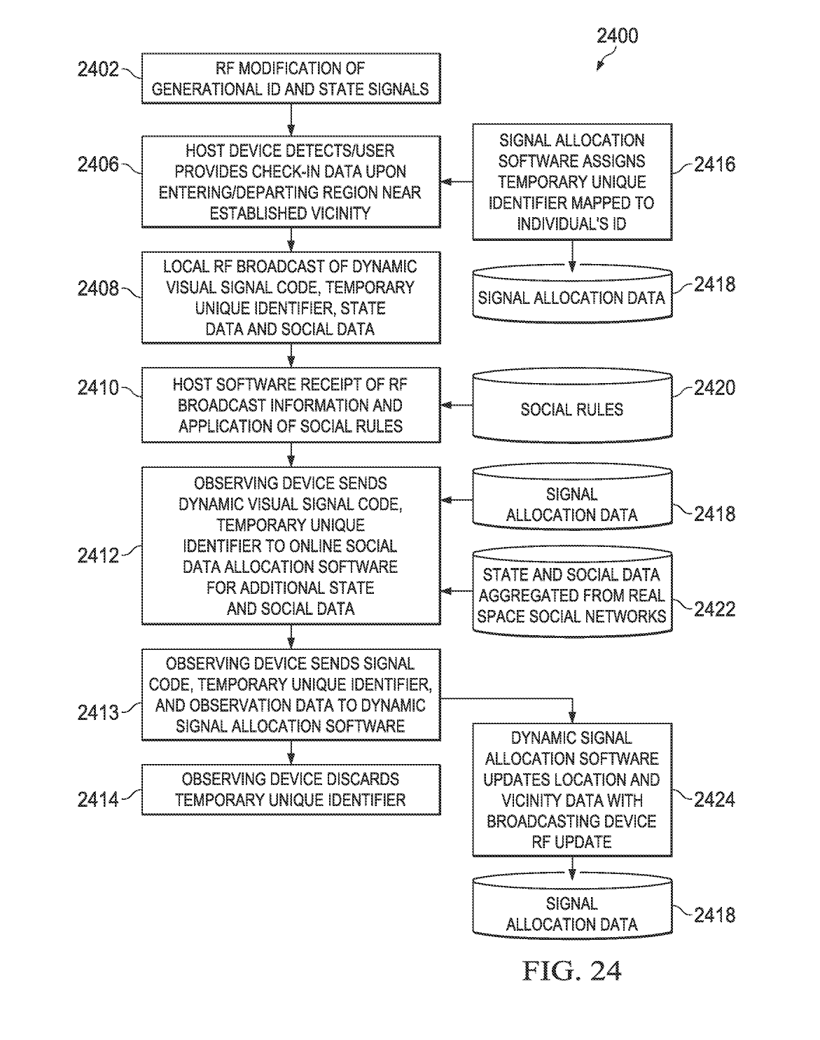

FIG. 24 illustrates a check-in data technique 2400 related to the check-in data scenario of FIG. 23 in accordance with an embodiment of the disclosure. In technique 2400, RF modification of generational identifiers and state signals occurs at block 2402. At block 2406, a host device detects or a user provides check-in data upon entering/departing a region near an established vicinity. The step of block 2406 may be based, for example, on signal allocation software assigned temporary unique identifiers mapped to individual identifiers (block 2416). The assignments by the signal allocation software at block 2416 may be stored to signal allocation data database 2418. At block 2408, local RF broadcasting is used to transmit dynamic visual signals codes, temporary unique identifiers, state data, and/or social data. At block 2410, host software receives information and social rules by RF broadcast. The social rules may be provided, for example, by a social rules database 2420. At block 2412, an observing device sends dynamic visual signal codes and/or temporary unique identifiers to online social data allocation software for additional state data and social data. The dynamic visual signal codes for block 2412 may be received, for example, from the signal allocation data database 2418. Further, the state data and social data for block 2412 may be received, for example, from a database 2422 that stores state data and social data aggregated from real space social networks. At block 2413, an observing device sends signal codes, temporary unique identifiers, and observation data to dynamic signal allocation software. Thereafter, the observing device may discard any temporary unique identifiers at block 2414. The dynamic signal allocation software may also update location and vicinity data based on broadcast RF updates (block 2424). The updated location and vicinity data for block 2424 may be stored to the signal allocation data database 2418.

In the instance that a host device or online service provides access to check-in data this data may be harvested by signal and social data allocation software for incorporation in: 1) the definition of a vicinity; 2) allocation of signals within a vicinity; 3) dissemination of social data to observing devices; and 4) composition of state data for individuals within a check-in vicinity employed as an overlay based upon the visual cue provided by a dynamic visual signaling device. Check-in data collected from online sources contributes to vicinity definition for social data allocation software even when no GPS or other location data is currently available. Comparison of check-in data with existing known location data allows algorithmically incorporating or rejecting any given location datum (including check-in data) by the signal and social data allocation system. More data generally reduces error rates and forms a better vicinity and signal allocation, and conflicting or redundant data may be excluded from the final composition of any given vicinity and signal allocation. This makes it possible to incorporate check-in data with the benefit of improving the accuracy of vicinity assignment. In addition, non-individuals, including a place of business or home, may also have their own dynamic visual broadcasting devices included in the final composition of a vicinity without the requirement of check-in, or they may be checked-in and therefore have a reduced or non-requirement for any other location data. Check-in data may be redundant, but redundant data can be useful in improving vicinity composition to include all similarly located individuals within a vicinity.

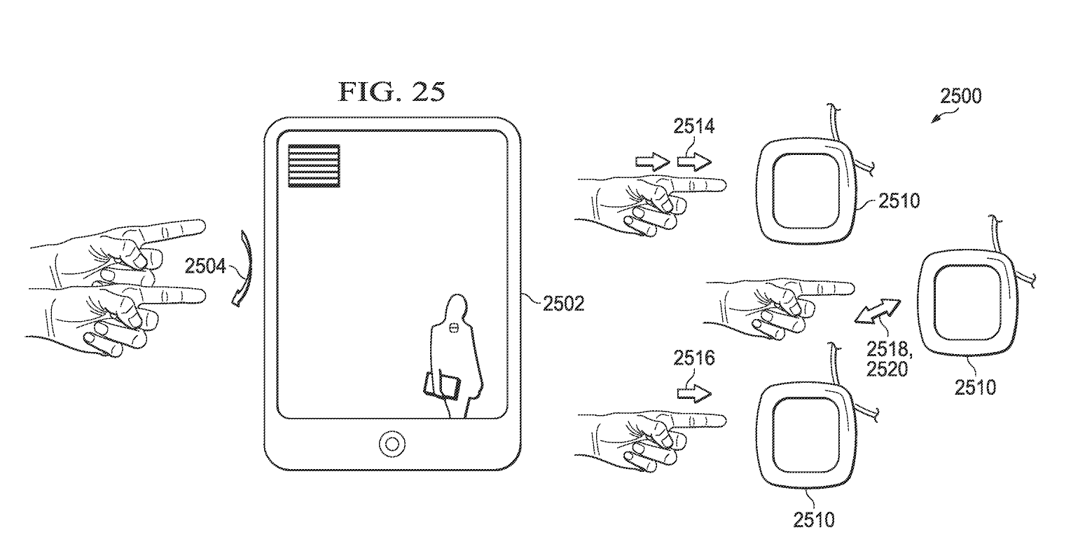

FIG. 25 illustrates a user interface scenario 2500 for signal generation units in accordance with an embodiment of the disclosure. In the scenario 2500, a signal broadcasting device 2502 is shown, where a swipe action 2504 is used to perform at least one function. Additionally, scenario 2500 shows another signal broadcasting device 2510, where a tap action 2516, a double-tap action 2514, a pinch-in action 2518, and/or a pinch-out action 2520 may be employed to perform at least one function.

A dynamic signal broadcasting device such as devices 2502 or 2510 may comprise a touch screen with near proximity sensitivity on its signaling element or case surface or elsewhere on its containing case to modulate dynamic signal broadcasting modes. Gestures may be employed with a stand-alone signal broadcasting device or with integrated devices. Signaling modes modulated by gestures have the advantages of pausing signal broadcasting functionality, limiting social data broadcast to a subset of potential observes such as friends or friends of friends, switching to non-signal broadcasting functions, and modulating the location of broadcast signal within a display as in the case with a transparent display tablet where a large amount of area is available. A further advantage is rapidly and easily transitioning between public and private modes, where in public modes one is broadcasting dynamic signals with the intent of communicating user defined social data and private modes where only a subset of social data is provided, or in the case of completely halting dynamic signaling, no signal, identity or social data is provided at all. These signaling modes are pre-programmed such that defined touch gestures are programmed by the user or alternately defined as a group in a pre-defined as a profile. In operation, touch modes are detected, decoded, and interpreted as commands for execution by the dynamic signal broadcasting device.

Without limitation to other embodiments, touch/near proximity modes include the swipe action 2504, the tap action 2516, the double tap action 2514, the pinch-in action 2518, and the pinch-out action 2520. As an example, the tap action 2516 may correspond to a privacy toggle, the double tap action 2514 may correspond to a silent signal toggle, the pinch-in action 2518 may correspond to a reveal less social data operation, and the pinch-out action 2520 may correspond to a reveal more social data function. The ability to rapidly and easily transition via touch is an important benefit to management of privacy as well as managing and manipulating state data and social rules in social uses and contexts where dynamic signaling is employed to convey identity, social information and state data.

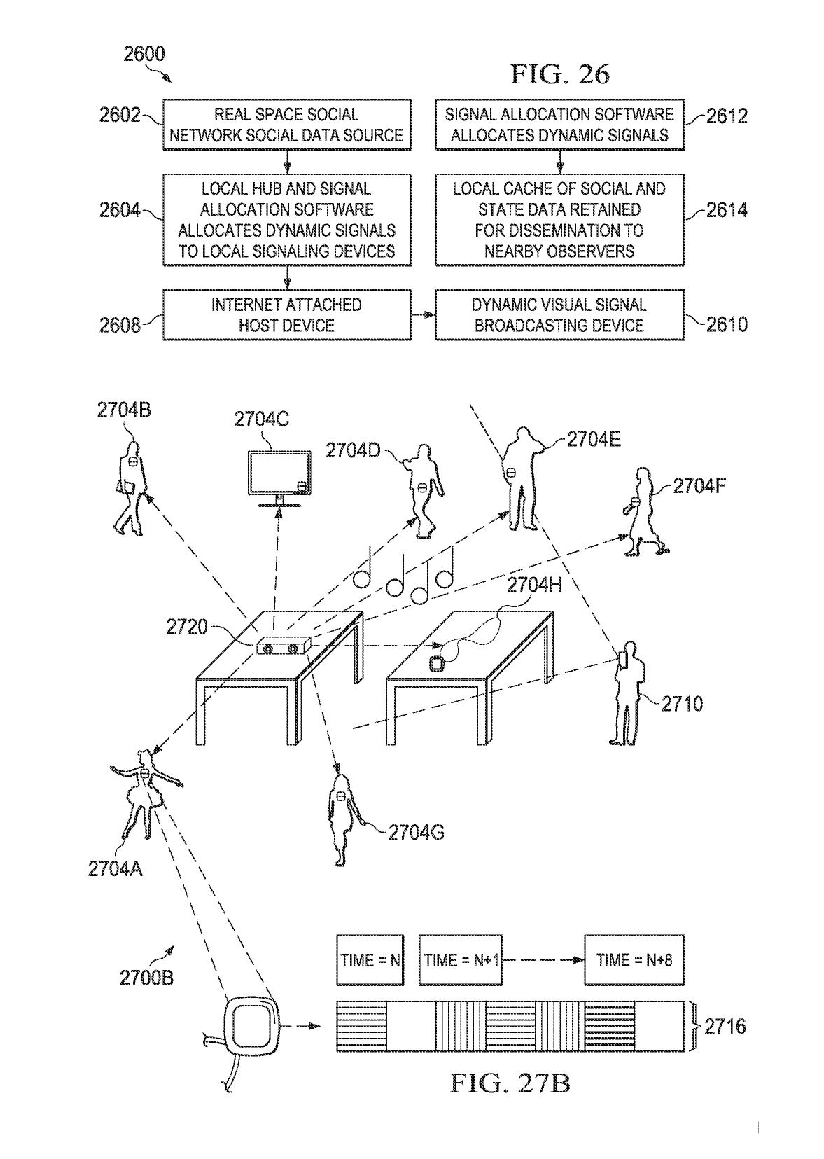

FIG. 26 illustrates a dynamic signal broadcasting hub technique 2600 in accordance with an embodiment of the disclosure. In technique 2600, a real space social network operates as a social data source (block 2602). Further, signal allocation software allocation dynamic signals (block 2612). A local hub and the signal allocation software allocate dynamic signals to local signal devices at block 2604. Further, a local cache of social and state data is retained for dissemination to nearby observers at block 2614. The dynamic signals are allocation, for example, to an internet-attached host device 2608 and/or a dynamic visual signal broadcasting device 2610.

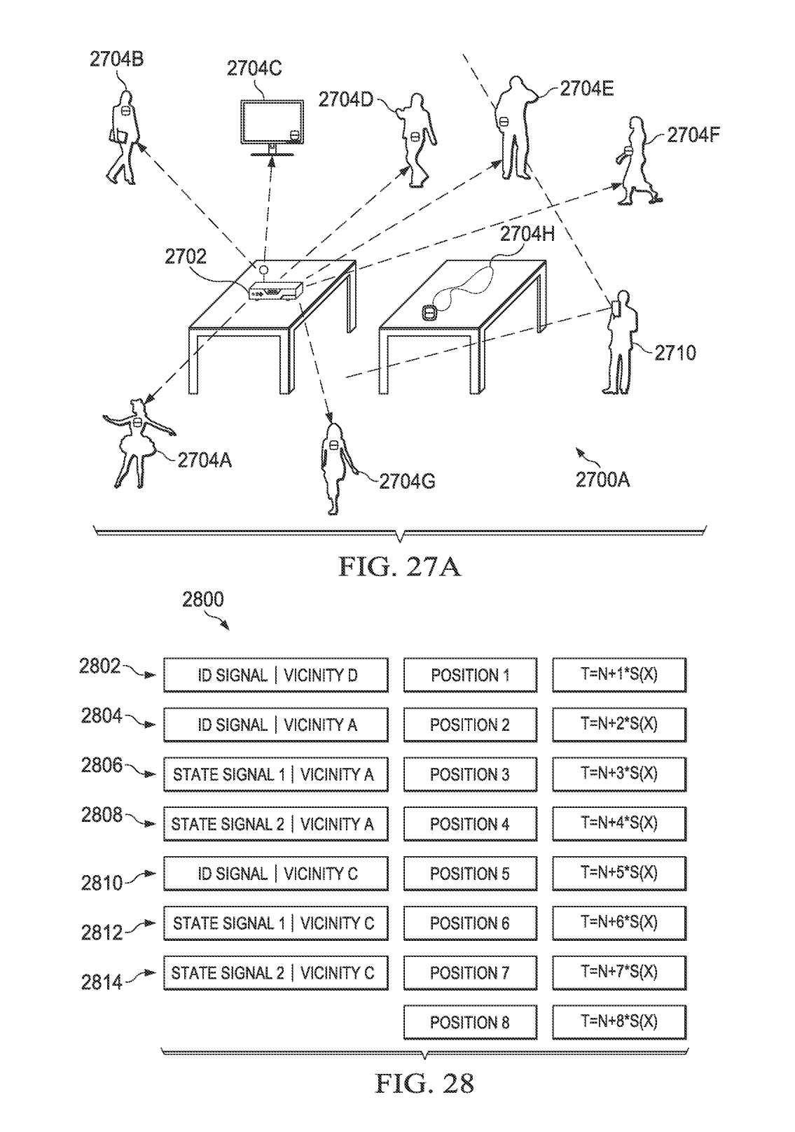

FIG. 27A illustrates a dynamic signal broadcasting hub scenario 2700A related to the dynamic signal broadcasting hub technique of FIG. 26 in accordance with an embodiment of the disclosure. In scenario 2700A, a broadcasting hub 2702 broadcasts dynamic visual signal coding to nearby dynamic visual broadcasting devices 2704A-2704H. Meanwhile, an observing device 2710 is able to detect signaling from the dynamic visual broadcasting devices 2704A-2704H.

In some embodiments, the broadcasting hub 2702 allocates dynamic signals to nearby dynamic visual signal broadcasting devices 2704A-2704H over a local wireless network while maintaining a local database of identity and state data with the advantage of augmenting or replacing connectivity to an outside network. Identity and state data is allocated locally. The local database is a subset of a subset of a larger state and identity database providing state and identity data to those individuals and objects designated for local signal allocation. A further advantage is the ease of deploying a local state and identity solution to a location with lower internet bandwidth utilization since data is maintained and updated locally.

FIG. 27B illustrates another dynamic signal broadcasting hub scenario 2700B related to the dynamic signal broadcasting hub technique of FIG. 26 in accordance with an embodiment of the disclosure. In scenario 2700B, a broadcasting hub 2720 broadcasts dynamic visual signal coding to nearby dynamic visual broadcasting devices 2704A-2704H. Meanwhile, an observing device 2710 is able to detect signaling from the dynamic visual broadcasting devices 2704A-2704H.

In some embodiments, the dynamic visual signal broadcasting devices 2704A-2704H may synchronize visual signals in response to local external cues including sound or host device detected cues. The external cues effectively define a shared state system instantiated across multiple dynamic visual signaling devices where the dynamic visual signals themselves are synchronized and generationalized according to an external signal, signal allocation software rules, and state rules specific to the method of the synchronizing cue. A benefit of synchronizing visual signals is aesthetically pleasing visualizations as in the case of a loudspeaker broadcasting music detected by host devices or dynamic visual signaling devices which in response to music produce time sequenced and generational colored and shaped patterns spanning multiple dynamic visual signaling devices and generationalized with identity and state defining signals. Similarly in response to detection of a detected musical beat, local cues can include another cueing dynamic visual signaling device, a detected light pattern, a detected static tag, or a non-musical audio cue. A further benefit of synchronizing visual signals locally is ensuring generational signals are temporally aligned simplifying decode by observing devices. A further benefit is signals are introduced into a generational signal flow in the same manner as a state system, making visually aesthetic signals coexist with visual signals intended primarily for interpretation by observing dynamic visual signal receiving devices.

FIG. 28 illustrates dynamic signaling bandwidth and frame acquisition information 2800 in accordance with an embodiment of the disclosure. As shown, the information 2800 includes a set of signals 2802, 2804, 2806, 2808, 2810, 2812, and 2814 associated with identifiers, vicinities, state signals, positions, and acquisition rates.

In some embodiments, dynamic visual signal allocation in a multiplex queue with a function S(x) provides the minimum time-per-sequenced signals for point-to-point broadcaster-to-observer transfer of generational signals. The time-per-sequenced signals are stored by signal allocation software as a part of the broadcasting devices signal allocation data and provided to signal observing devices. When the observing device meets the O_{fps} and Oaf assumptions of the signaling device the bandwidth of data transfer can be interpreted as bytes of data transfer according the function B(x) starting at time N yielding the point to point, broadcaster to observer signal data transfer rate for one second of observation.

In at least some embodiments, S(x) corresponds to the formula:

$$S ( x ) = \frac{1}{[ \frac{( Ofps )}{( Osar )} + Odf + 1 ]} + sftf ,$$

where Ofps=anticipated observing device frame per second acquisition rate (e.g., 30 frames per second);
Osar=desired observing device minimum frames per sequenced signal acquisition rate (e.g., 2 frames per signal); and
Odf=anticipated observing device drop frame rate (e.g., 2 frames per second).

In the case where Ofps=30, Osar=2, Odf=0, Sftf=0.01, then:

$$S ( x ) = \frac{1}{[ \frac{30}{2} + 0 + 1 ]} + 0.01$$

Further, B(X) is the point-to-point, broadcaster-to-observer signaling data transfer rate (expressed as bytes) with 1 second observation frame

$$B ( x ) = \frac{1}{S ( x )} * V / 8 ,$$

where V=size of signal vocabulary.

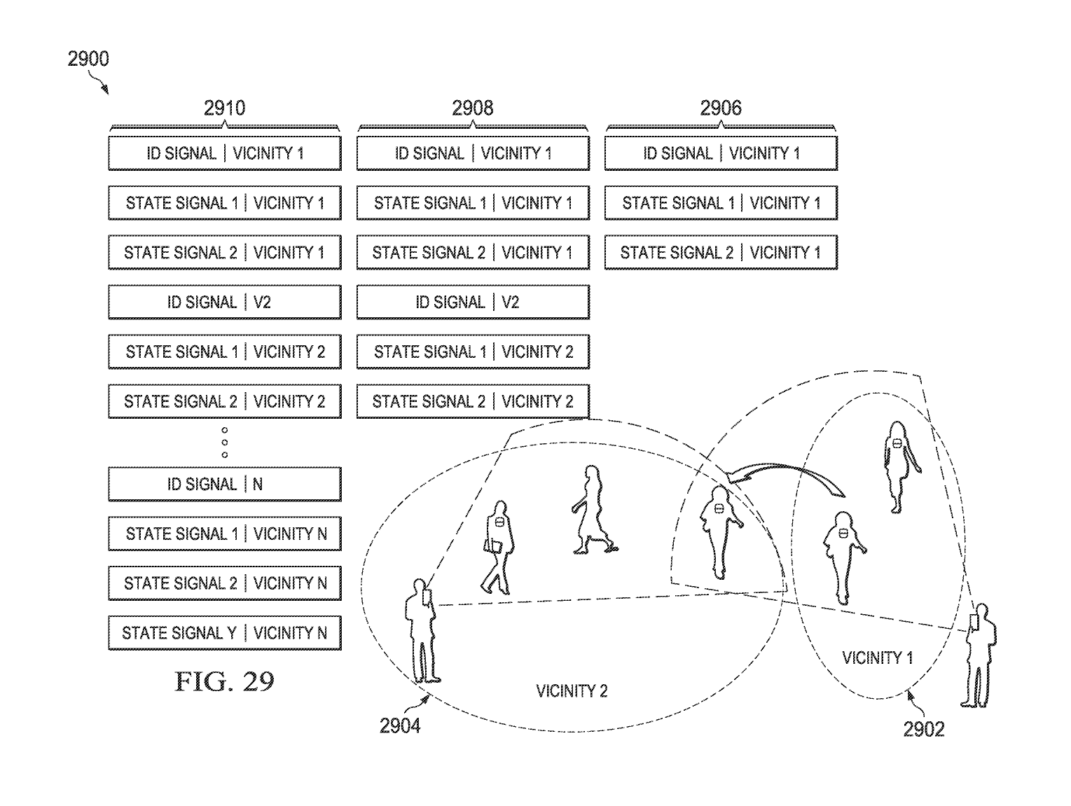

FIG. 29 illustrates a scenario 2900 for addition of generational dynamic visual signals in accordance with an embodiment of the disclosure. In scenario 2900, various signals for N vicinities are placed in a multiplex queue 2910. The signals in multiplex queue 2910, for example, may correspond to accumulated signals 2908 for vicinity 2904 or accumulated signals 2906 for vicinity 2902. For scenario 2900, generational data is retained by signal allocation software and is distributed to signal receiving devices along with social data. In some embodiments, non-regional generational data may provide confirmation of correct identifier assignment.

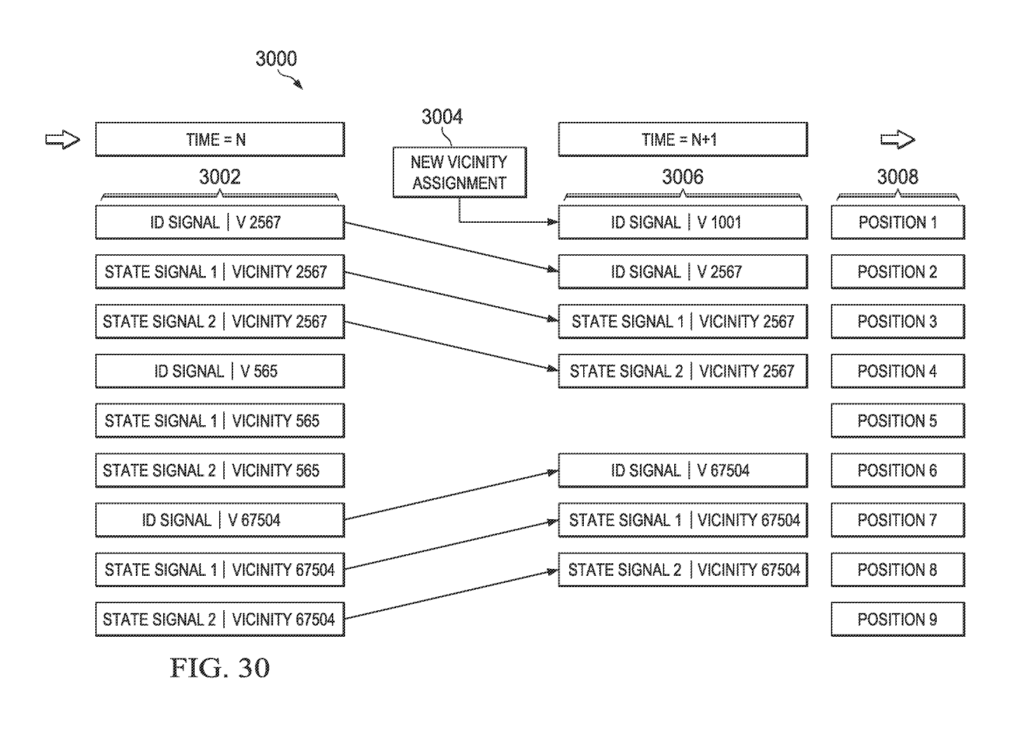

FIG. 30 illustrates a scenario 3000 for addition, subtraction, and re-queuing of generational dynamic visual signals in accordance with an embodiment of the disclosure. In scenario 3000, accumulated signals 3002 for time N pass through a new vicinity assignment operation 3004. At time N+1, another grouping of accumulated signals 3006 has been formed based on the new vicinity assignment operation 3004. The accumulated signals 3006 may correspond to various available positions 3008 for the new vicinity.

The scenario 3000 demonstrates an exchange of positions in a multiplex queue associated with a single dynamic signal broadcasting device executed by dynamic signal allocation software and distributed to host and/or signaling devices. When a new primary vicinity (vicinity 1001) is assigned, a identifiers and state signals for a prior primary vicinity (vicinity 2567) are bumped down, and an intermediate vicinity (vicinity 565) is eliminated from the multiplex queue.

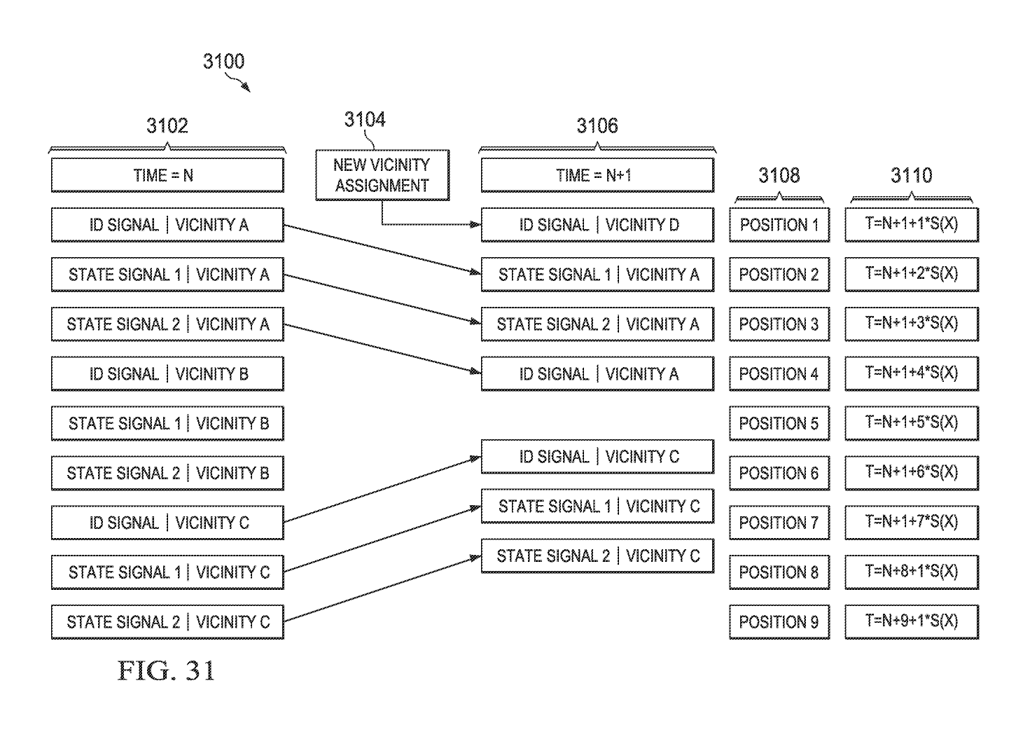

FIG. 31 illustrates a scenario 3100 for time sequencing and scheduling of generational dynamic visual signals in accordance with an embodiment of the disclosure. In scenario 3100, accumulated signals 3102 for time N pass through a new vicinity assignment operation 3104. At time N+1, another grouping of accumulated signals 3106 has been formed based on the new vicinity assignment operation 3104. The accumulated signals 3106 may correspond to various available positions 3108 and time sequences 3110 for the new vicinity.

In at least some embodiments, dynamic visual signals may be generational through spatial or geometric arrangement incorporating multiple identity to vicinity mappings with the advantage of enabling users to move from vicinity to vicinity without interrupting identity mapping relative to prior vicinities and phasing in mappings to new and potential vicinities. Observing devices parse signals and seek signals within local vicinity mappings for identity mapping to state and social data. As signaling users and devices are allocated to a new vicinity by signal allocation systems they receive new signal allocations for their new vicinity while retaining, through multiplexing, prior assignments. Dynamic visual signals are given a position within a generational sequence and the full array of positions and signals forms the full dynamic visual generational signal. New assignments are made which modify the position of signals within the generational sequence forming a new time sequence and geometric configuration (for spatially generational signals) and the mapping stored as signal allocation data. Signal allocation data contains the signal map which permits observing devices to parse signal to vicinity assignments. Furthermore, observing devices are able to employ prior vicinity to signal mapping assignments to corroborate accurate assignment of identity and corresponding social and state data. The signals for prior vicinity assignments form a digital code which employed with current vicinity assignment has the benefit of significantly increasing the number of signals available for verification of identity. A further benefit is that subsequent observations by an observer may flexibly employ current or prior vicinity mapping and signals improving the ability to maintain a lock on the identity of a signaling device. Visual interference and obstruction may prevent observation of the entire signal, but with the entire generational signal it is possible to retain visual tracking and identity assignment of observed dynamic visual signaling devices.

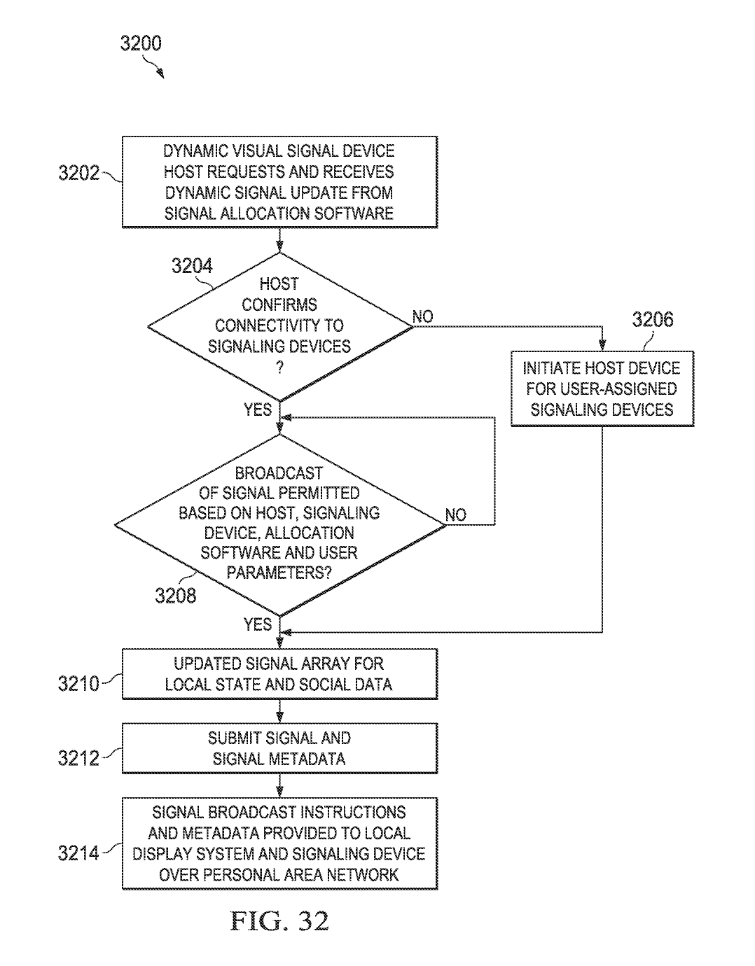

FIG. 32 illustrates a dynamic visual signal broadcasting method 3200 in accordance with an embodiment of the disclosure. In method 3200, a dynamic visual signal device host requests and receive a dynamic signal update from signal allocation software (block 3202). If the host does not confirm connectivity to signaling devices (determination block 3204), a host device is initiated for user-assigned signaling devices (block 3206). If the host confirms connectivity to signaling devices (determination block 3204), a determination is made whether a broadcast of signal is permitted based on host, signaling device, allocation software, and user parameters (determination block 3208). If not (determination block 3208), the method 3200 returns to determination block 3208. If so (determination block 3208), an signal array is updated for local state and social data 3210. At block 3212, a signal and signal metadata is submitted. At block 3214, signal broadcast instructions and metadata are provided to a local display system and signal device over a personal area network.

In the method 3200, signal allocation software provisions signals to dynamic visual signaling hosts and ultimately signaling devices which may modify signal streams to reflect local state and social data. This update maintains the integrity of the signal metadata provided to observing devices with the advantage that observing devices are able to associate a signal with an identity and parse data based on the anticipated sequence of signals yet state and social data may be updated locally and directly between broadcasting and observing devices. A number of controls on actual signal broadcast permit users and applications to enable or disable broadcast. Benefits of disabling broadcast include maintaining privacy, preventing visual distraction, conservation of power on the signaling device, or manual interruption of social and state applications.

Host applications in conjunction with signal allocation software may enable or disabling broadcast in connection with the likelihood of observation. If no observing devices are present or probability of observation is low based on nearby activity, signal allocation software provides metadata to host devices enabling those devices to insert the probability of observation and any known local activity into the functions of applications which determine whether or not to broadcast signals with weightings provided by user and device parameters.

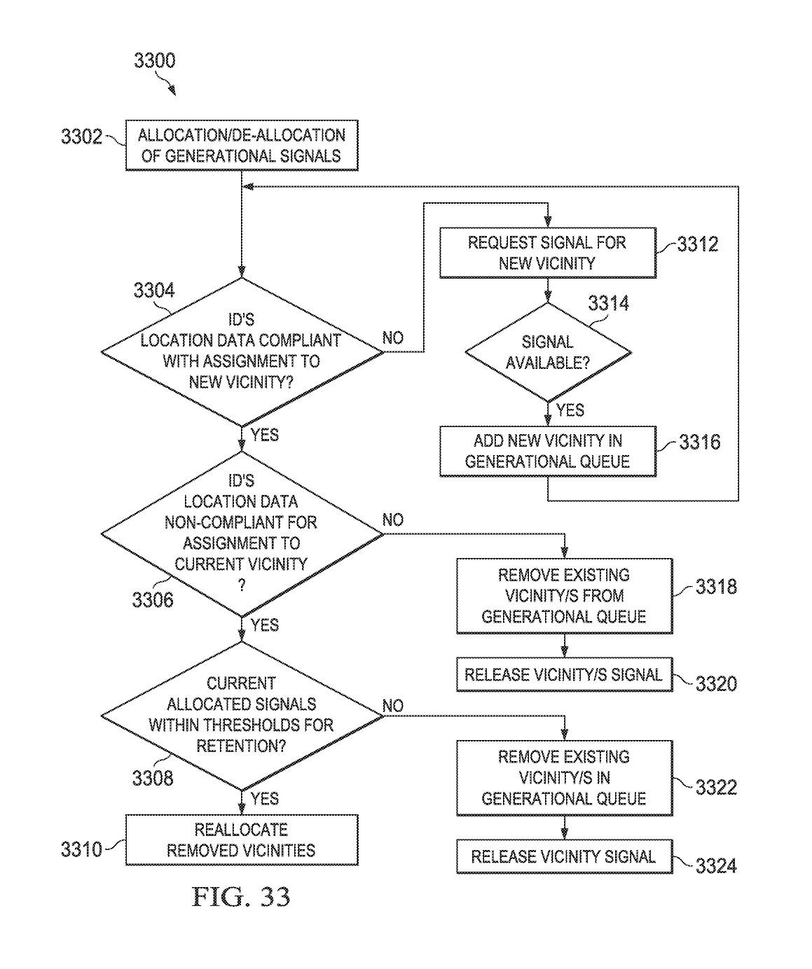

FIG. 33 illustrates a dynamic signal allocation method 3300 in accordance with an embodiment of the disclosure. In method 3300, allocation or de-allocation of generational signals occurs at block 3302. If an identifier's location data is compliant with an assignment to a new vicinity (determination block 3304), a determination is made regarding whether the identifier's location data is non-compliant for assignment to a current vicinity (determination block 3306). If the identifier's location data is non-compliant for assignment to a current vicinity (determination block 3306), a determination is made regarding whether current allocated signals are within threshold for retention (determination block 3308). If so, removed vicinities are reallocated at block 3310. If not, an existing vicinity or vicinities in the multiplex queue are removed (block 3322). At block 3324, a vicinity signal is released.

Returning to decision block 3304, if an identifier's location data is not compliant with an assignment to a new vicinity (determination block 3304), a signal for a new vicinity is requested (block 3312). If a signal is available (determination block 3314), a new vicinity is added in the multiplex queue (block 3316), and the method 3300 returns to decision block 3304.

Returning to decision block 3306, if the identifier's location data is compliant for assignment to a current vicinity (determination block 3306), an existing vicinity or vicinities are removed from the multiplex queue (block 3318) and the vicinity signal is released at block 3320.

For the method 3300, data on generational position is retained by signal allocation software and is distributed to signal receiving devices along with social data. Non-regional multiple data is additional confirmation of correct identifier assignment in observed region. Further, generational or primary vicinity state data may provide additional identifier conformation while its underlying meaning can be withheld according to user rules. Further, released signals are available for reallocation by signal allocation software. Further, queued signals are removed from the pool of available signals for a given vicinity.

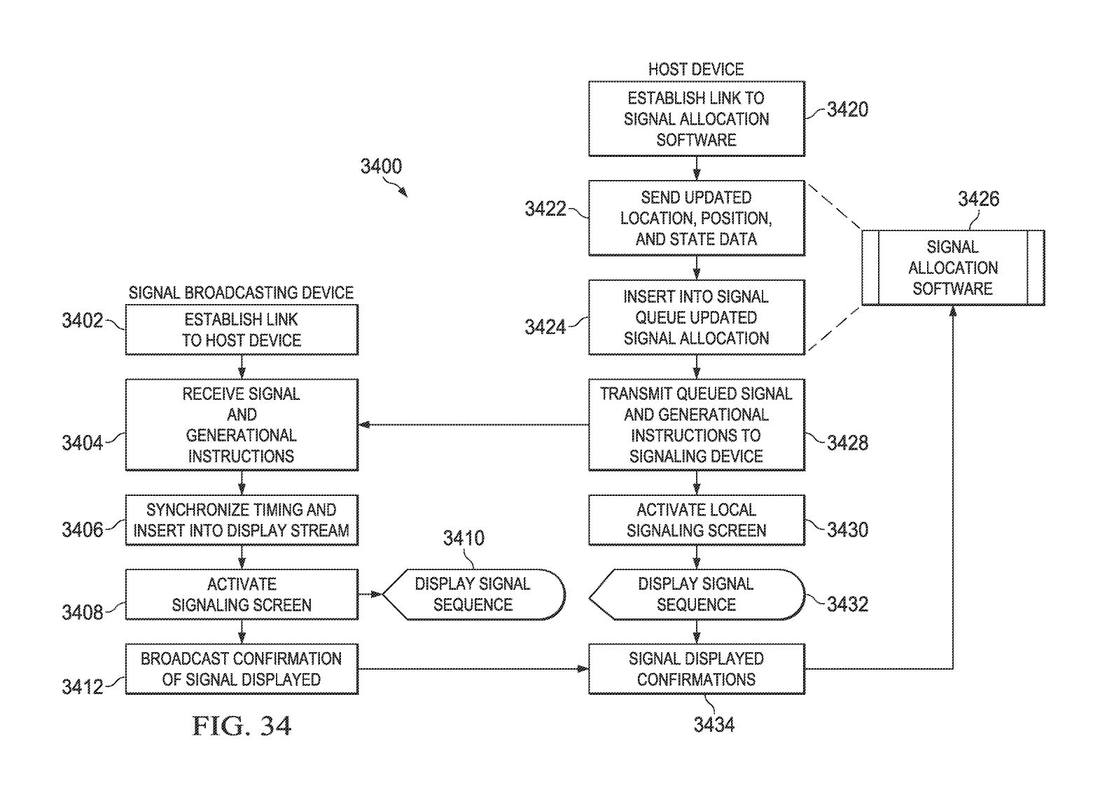

FIG. 34 illustrates another dynamic signal broadcasting method 3400 in accordance with an embodiment of the disclosure. In method 3400, a signal broadcasting device performs steps 3402, 3404, 3406, 3408, 3410, 3412. Meanwhile, a host device performs steps 3420, 3422, 3424, 3426, 3428, 3430, 3432, and 3434. At block 3402, a signal broadcasting device establishes a link to a host device. At block 3404, the signal broadcasting device receives signal and multiplex instructions. At block 3406, the signal broadcasting device synchronizes the timing and inserts signaling data into a display data stream. At block 3408, the signal broadcasting device activates the signaling screen. At block 3410, the signal broadcasting device displays the signal sequence. At block 3412, the signal broadcasting device broadcasts confirmation that the signal was displayed.

Meanwhile, the host device establishes a link to signal allocation software 3426 at block 3420. At block 3422, the host device sends updated location, position, and state data to the signal allocation software 3426. At block 3424, the host device inserts into a signal queue updated signal allocation information. At block 3428, the host device transmits queued signal and multiplex instructions to the signal broadcasting device. As shown, the host device operations of block 3428 affect the signal broadcasting device operations of block 3404.

In some embodiments, the host device as well as the signal broadcasting device may display a dynamic visual signal as described herein. In such case, the host device may activate a local signaling screen at block 3430. Further, the host device displays a signal sequence at block 3432. Further, the host device sends a signal displayed confirmation at block 3434. The signal displayed confirmations sent by the signal broadcasting device (block 3412) and the host device (block 3434) may be sent to the signal allocation software 3426 or other management software for the social overlay visualization system described herein.

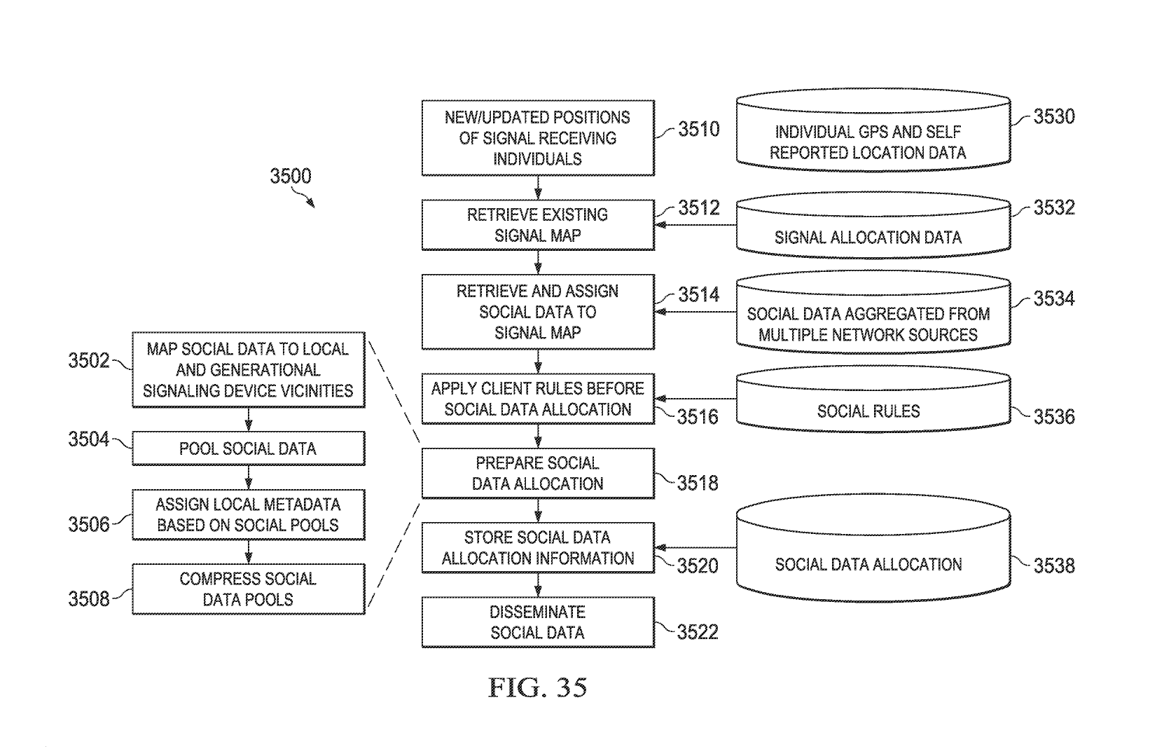

FIG. 35 illustrates a social data dissemination method 3500 in accordance with an embodiment of the disclosure. The method 3500 may be performed, for example, by the signal allocation software or other management software/servers described herein. In method 3500, new/updated positions of signal receiving individuals are determined at block 3510. The new/updated positions for block 3510 may be provided by a database 3530 that stores individual GPS and/or self reported location data. At block 3512, an existing signal map is retrieved. The existing signal map for block 3512 may be based on information retrieved from a signal allocation data database 3532. At block 3514, social data is retrieved and assigned to the signal map. The social data for block 3514 may be retried, for example, from a database 3534 that stores social data aggregated from multiple network sources. At block 3516, client rules are applied before social data allocation. The social rules for block 3516 may be retrieved, for example, from a database 3536 that stores social rules. At block 3518, social data allocation is prepared.

In some embodiments, the preparation of social data allocation for block 3518 may be based on various steps such as those shown for blocks 3502, 3504, 3506, and 3508. More specifically, at block 3502, social data is mapped to local and generational signaling device vicinities. At block 3504, social data is pooled. At block 3506, local metadata is assigned based on social pools. At block 3508, social data pools are compressed. At block 3520, social data allocation information is stored. The storage of social data allocation information for block 3520 may involve a database 3538 for social data allocation information. At block 3522, social data is disseminated.

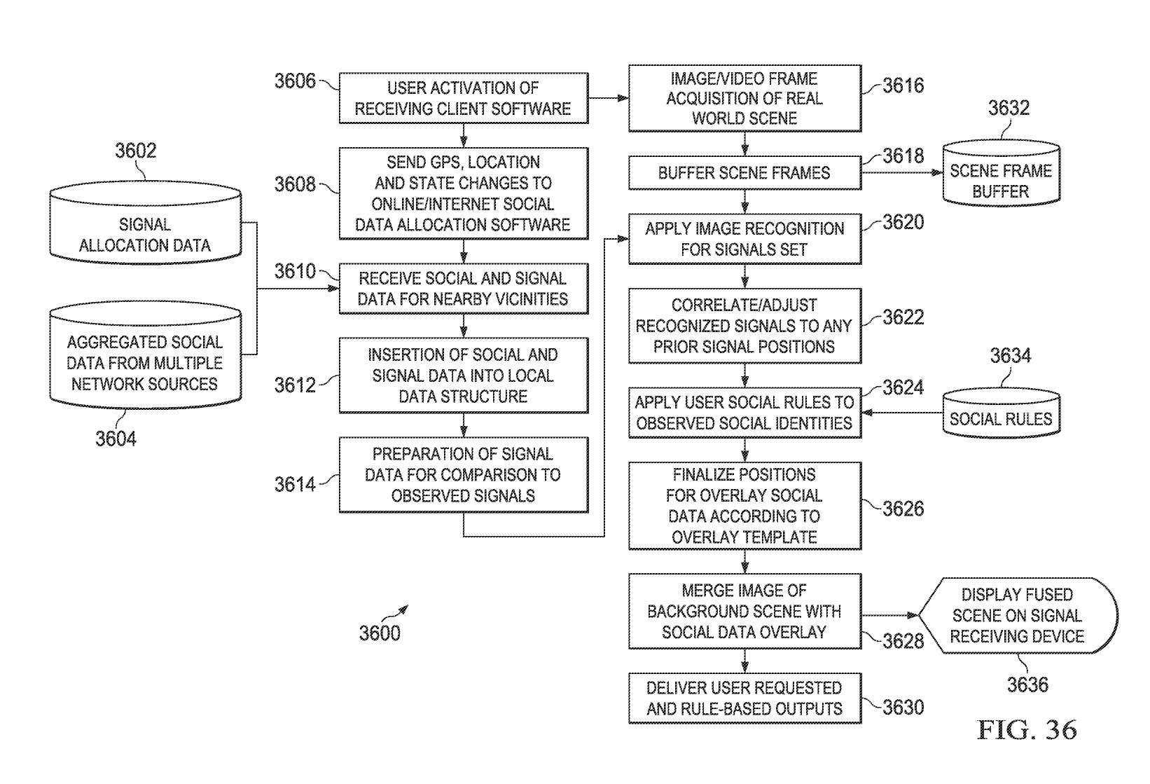

FIG. 36 illustrates a social data overlay method 3600 in accordance with an embodiment of the disclosure. The method 3600 may be performed, for example, by a signal receiving device or social overlay visualization interface unit as described herein. In the method 3600, user activation of receiving client software occurs at block 3606. At block 3608, GPS, location, and/or state changes are sent to online/internet social data allocation software. At block 3610, social data and signaling data are received for nearby vicinities. The social data for block 3610 may be received, for example, from a database 3604 that stores aggregated social data from multiple network sources. Meanwhile, the signaling data for block 3610 may be received, for example, from a database 3602 that stores signal allocation data. At block 3612, social data and signaling data is inserted into a local data structure. At block 3614, signaling data is prepared for comparison to observed signals.

At block 3616, image/video frame acquisition of real world scene occurs. At block 3618, the real world scene frames are buffered. For example, the scene frame for block 3618 may be buffered to scene frame buffer 3632. At block 3620, image recognition is applied for a signal set. The signal set for block 3620 may be based on the signal data preparation operations for block 3614. At block 3622, recognized signals are correlated/adjusted to any prior signal positions. At block 3624, social rules are applied to observed social identities. The social rules for block 3624 may be provided by a social rules database 3634. At block 3626, positions for overlay social data are finalized according to an overlay template. At block 3628, an image of a background scene is merged with the social data overlay. At block 3636, the fused scene may be displayed on a signal receiving device. At block 3630, user requested and rule-based outputs are delivered.

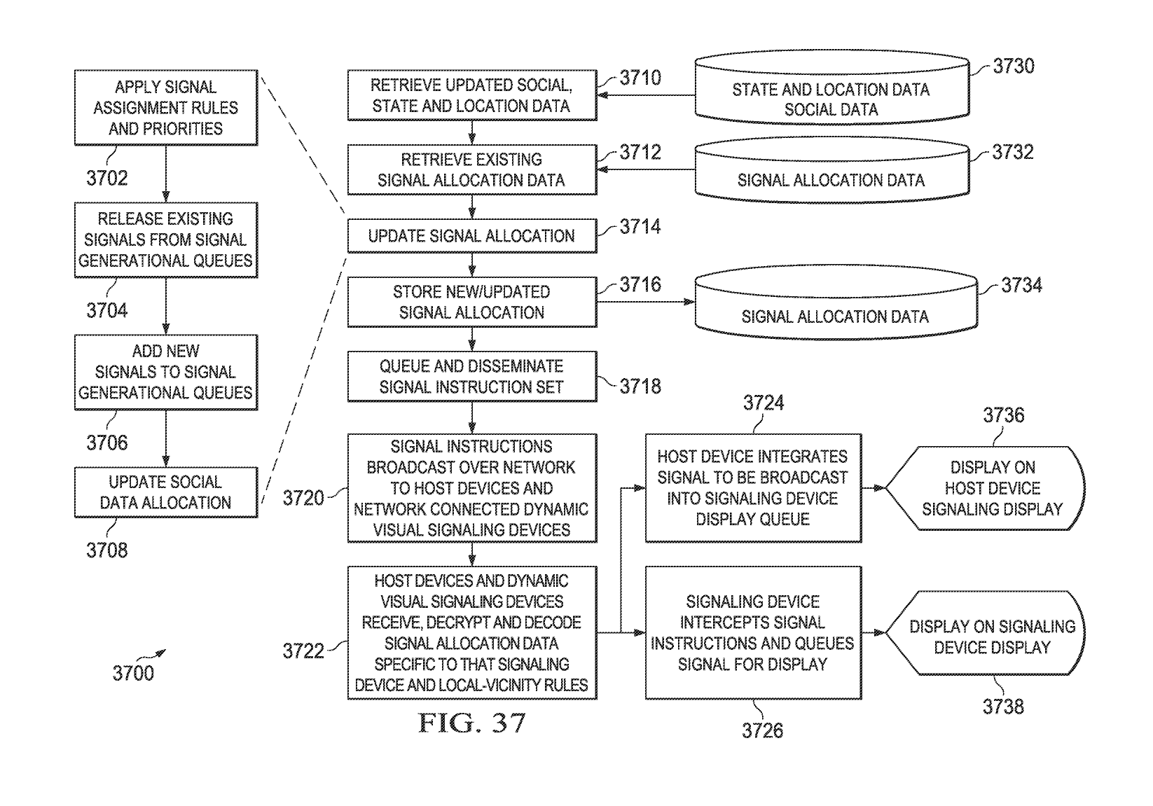

FIG. 37 illustrates a method 3700 for dissemination of dynamic visual signal instructions in accordance with an embodiment of the disclosure. The method 3700 may be performed, for example, by signal allocation software and/or other management software/servers provided for the social overlay visualization system described herein. In method 3700, updated social data, state data, and location data are retrieved at block 3710. The updated data for block 3710 may be retrieved, for example, from a database 3730 that stores state data, location data, and social data. At block 3712, existing signal allocation data is retrieved. The signal allocation data for block 3712 may be retrieved, for example, from a signal allocation data database 3732. At block 3714, signal allocation is updated. In some embodiments, the signal allocation updates for block 3714 may be based on various steps such as steps 3702, 3704, 3706, and 3708. More specifically, signal assignment rules and priorities may be applied at block 3702. Further, existing signals may be released from signal multiplex queues at block 3704. Further, new signals are added to signal multiplex queues at block 3706. Further, social data allocation may be updated at block 3708.

At block 3716, new/updated signal allocation information is stored. The store operation of block 3716 may be to a signal allocation data database 3734. At block 3718, a signal instruction set is queued and disseminated. At block 3720, signal instructions are broadcast over a network to host devices and/or network connected dynamic visual signaling devices. At block 3722, host devices and/or network connected dynamic visual signaling devices receive, decrypt, and decode signal allocation data specific to that signaling device and local vicinity rules. At block 3724, a host device may integrate a signal to be broadcast into a signaling device display queue. For example, the signal may be displayed on a host device signaling display at block 3736. Alternatively, at block 3726, a signaling device may intercept signal instructions and queue a signal for display. In such case, a signal may be displayed on a signaling device display at block 3738.

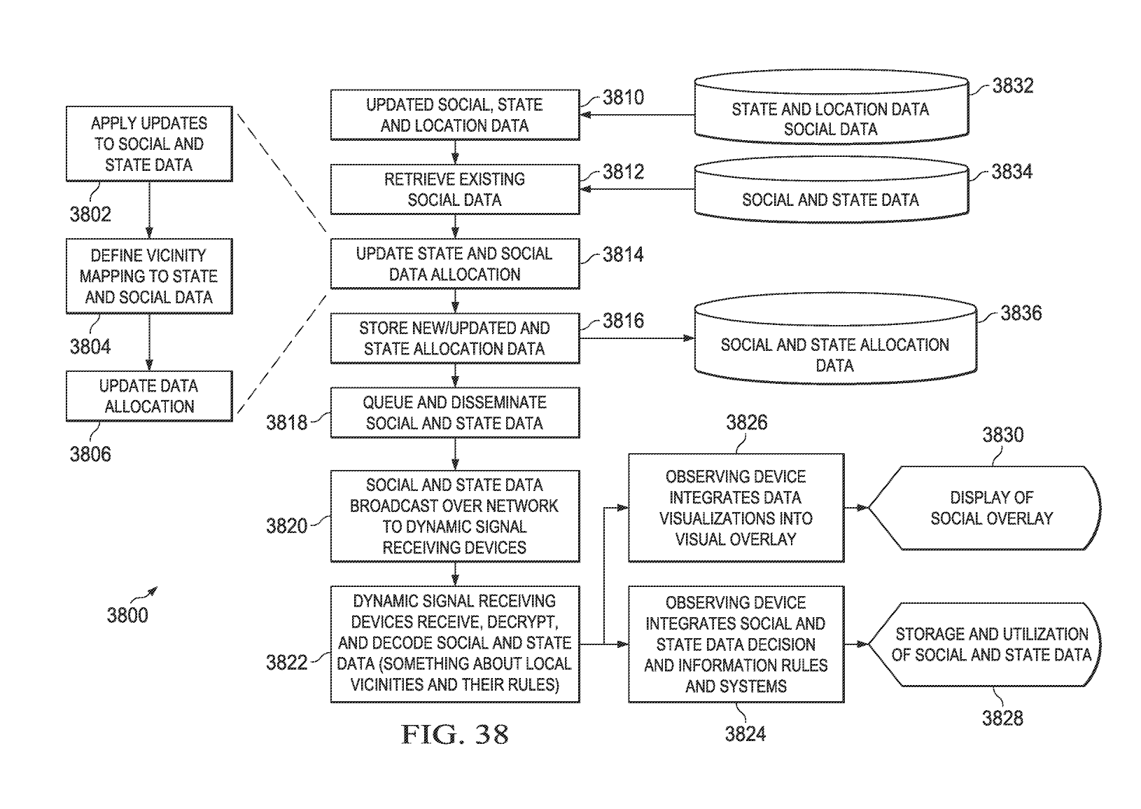

FIG. 38 illustrates another method 3800 for dissemination of social data in accordance with an embodiment of the disclosure. The method 3800 may be performed, for example, by social allocation software, signal allocation software, and/or other management software/servers for the social overlay visualization system described herein. In method 3800, updated social data, state data, and location data are retrieved at block 3810. The updated data for block 3810 may be retrieved, for example, from a database 3832 that stores state data, location data, and social data. At block 3812, existing social data is retrieved. The social data for block 3812 may be retrieved, for example, from a database 3834 that stores social data and state data. At block 3814, state data and social data allocation is updated. In some embodiments, the allocation updates for block 3814 may be based on various steps such as steps 3802, 3804, and 3806. More specifically, state data and social data updates may be applied at block 3802. Further, vicinity mapping to social data and state data may be defined at block 3804. Further, data allocation is updated at block 3806.

At block 3816, new/updated social data and state data allocation information is stored. The store operation of block 3816 may be to a database 3836 that stores social data allocation and state data allocation information. At block 3818, social data and/or state data is queued and disseminated. At block 3820, social data and/or state data is broadcast over a network to dynamic signal receiving devices. At block 3822, dynamic signal receiving devices receive, decrypt, and decode social data and/or state data (e.g., something about local vicinities and their rules). At block 3826, an observing device integrates data visualizations into a visual overlay. The visual overlay may be displayed at block 3730. Alternatively, at block 3824, an observing device may integrate social data and/or state data into decisions, information rules, and systems. In such case, social data and/or state data is stored and utilized at block 3828.

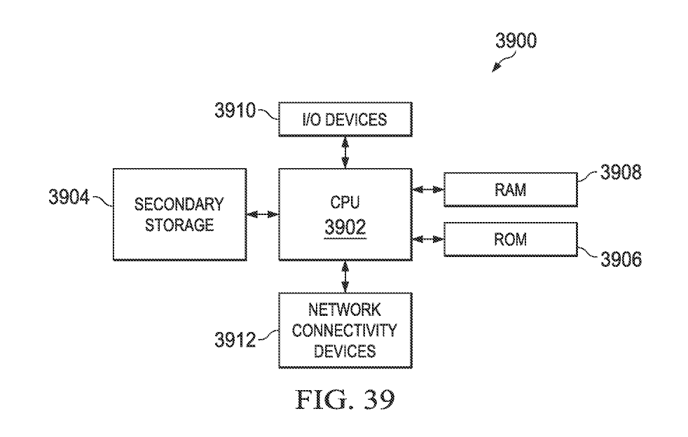

FIG. 39 shows components of a computer system 3900 in accordance with an embodiment of the disclosure. The computer system 3900 may perform various operations to support the social overlay visualization techniques described herein. Without limitation to other embodiments, the computer system 3900 may correspond to components of a global dynamic visual signal control system 102 or servers 500, a communication intermediary unit 106 or 200, a social overlay visualization interface unit 108 or 400, and/or a signal generation unit 104 or 300.

As shown, the computer system 3900 includes a processor 3902 (which may be referred to as a central processor unit or CPU) that is in communication with memory devices including secondary storage 3904, read only memory (ROM) 3906, random access memory (RAM) 3908, input/output (I/O) devices 3910, and network connectivity devices 3912. The processor 3902 may be implemented as one or more CPU chips.

It is understood that by programming and/or loading executable instructions onto the computer system 3900, at least one of the CPU 3902, the RAM 3908, and the ROM 3906 are changed, transforming the computer system 3900 in part into a particular machine or apparatus having the novel functionality taught by the present disclosure. In the electrical engineering and software engineering arts functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. For example, a design that is still subject to frequent change may be implemented in software, because re-spinning a hardware implementation is more expensive than re-spinning a software design. Meanwhile, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

The secondary storage 3904 may be comprised of one or more disk drives or tape drives and is used for non-volatile storage of data and as an over-flow data storage device if RAM 3908 is not large enough to hold all working data. Secondary storage 3904 may be used to store programs which are loaded into RAM 3908 when such programs are selected for execution. The ROM 3906 is used to store instructions and perhaps data which are read during program execution. ROM 3906 is a non-volatile memory device which typically has a small memory capacity relative to the larger memory capacity of secondary storage 3904. The RAM 3908 is used to store volatile data and perhaps to store instructions. Access to both ROM 3906 and RAM 3908 is typically faster than to secondary storage 3904. The secondary storage 3904, the RAM 3908, and/or the ROM 3906 may be referred to in some contexts as computer readable storage media and/or non-transitory computer readable media.

I/O devices 3910 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 3912 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards such as code division multiple access (CDMA), global system for mobile communications (GSM), long-term evolution (LTE), worldwide interoperability for microwave access (WiMAX), and/or other air interface protocol radio transceiver cards, and other well-known network devices. These network connectivity devices 3912 may enable the processor 3902 to communicate with the Internet or one or more intranets. With such a network connection, it is contemplated that the processor 3902 might receive information from the network, or might output information to the network in the course of performing the above-described method steps. Such information, which is often represented as a sequence of instructions to be executed using processor 3902, may be received from and outputted to the network, for example, in the form of a computer data signal embodied in a carrier wave.

Such information, which may include data or instructions to be executed using processor 3902 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods known to one skilled in the art. The baseband signal and/or signal embedded in the carrier wave may be referred to in some contexts as a transitory signal.

The processor 3902 executes instructions, codes, computer programs, scripts which it accesses from hard disk, floppy disk, optical disk (these various disk based systems may all be considered secondary storage 3904), ROM 3906, RAM 3908, or the network connectivity devices 3912. While only one processor 3902 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 3904, for example, hard drives, floppy disks, optical disks, and/or other device, the ROM 3906, and/or the RAM 3908 may be referred to in some contexts as non-transitory instructions and/or non-transitory information.

In an embodiment, the computer system 3900 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 3900 to provide the functionality of a number of servers that is not directly bound to the number of computers in the computer system 3900. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third party provider. Some cloud computing environments may comprise cloud computing resources owned and operated by the enterprise as well as cloud computing resources hired and/or leased from a third party provider.

In an embodiment, some or all of the social overlay visualization techniques disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 3900, at least portions of the contents of the computer program product to the secondary storage 3904, to the ROM 3906, to the RAM 3908, and/or to other non-volatile memory and volatile memory of the computer system 3900. The processor 3902 may process the executable instructions and/or data structures in part by directly accessing the computer program product, for example by reading from a CD-ROM disk inserted into a disk drive peripheral of the computer system 3900. Alternatively, the processor 3902 may process the executable instructions and/or data structures by remotely accessing the computer program product, for example by downloading the executable instructions and/or data structures from a remote server through the network connectivity devices 3912. The computer program product may comprise instructions that promote the loading and/or copying of data, data structures, files, and/or executable instructions to the secondary storage 3904, to the ROM 3906, to the RAM 3908, and/or to other non-volatile memory and volatile memory of the computer system 3900.

In some contexts, the secondary storage 3904, the ROM 3906, and the RAM 3908 may be referred to as a non-transitory computer readable medium or a computer readable storage media. A dynamic RAM embodiment of the RAM 3908, likewise, may be referred to as a non-transitory computer readable medium in that while the dynamic RAM receives electrical power and is operated in accordance with its design, for example during a period of time during which the computer 3900 is turned on and operational, the dynamic RAM stores information that is written to it. Similarly, the processor 3902 may comprise an internal RAM, an internal ROM, a cache memory, and/or other internal non-transitory storage blocks, sections, or components that may be referred to in some contexts as non-transitory computer readable media or computer readable storage media.

In some examples, a non-transitory computer-readable storage medium may store a program or instructions that cause the processor 3902 to generate information for social overlay visualization based on dynamic visual signals. Further, a non-transitory computer-readable storage medium may store a program or instructions that cause the processor 3902 to generate dynamic visual signal coding for a participant of social overlay visualization based on a dynamic vicinity designation and a light signal generation unit interface associated with the participant. Further, a non-transitory computer-readable storage medium may store a program or instructions that cause the processor 3902 to generate socialization overlay data for a participant of social overlay visualization based on observed dynamic visual signals and a social overlay visualization interface unit associated with the participant. Further, a non-transitory computer-readable storage medium may store a program or instructions that cause the processor 3902 to forward information between a dynamic signaling control system and a signal generation unit. Further, non-transitory computer-readable storage medium may store a program or instructions that cause the processor 3902 capture images and decode a dynamic visual signal related to said social overlay visualization.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

1. A computer system, comprising:
a processor;
a camera;
a storage device coupled to the processor and storing a program that, when executed, causes the processor to generate information for social overlay visualization based on images captured by the camera;
wherein the information comprises:
a background scene captured by the camera that includes a signaling device participating in social overlay visualization; and
data derived from dynamic visual signals generated by the signaling device overlaid on the background scene.

2. The computer system of claim 1, wherein the program, when executed, causes the processor to generate dynamic visual signal coding for a participant of social overlay visualization based on a dynamic vicinity designation and a light signal generation unit interface associated with the participant.

3. The computer system of claim 1, wherein the program, when executed, causes the processor to generate socialization overlay data for a participant of social overlay visualization based on observed dynamic visual signals and a social overlay visualization interface unit associated with the participant.

4. The computer system of claim 1, wherein the program, when executed, causes the processor to forward information between a dynamic signaling control system and a signal generation unit.

5. The computer system of claim 1, wherein the program, when executed, causes the processor to capture images and decode a dynamic visual signal related to said social overlay visualization.

6. A non-transitory computer-readable medium storing a program that, when executed, causes a processor to generate information for social overlay visualization based on images captured by a camera; wherein the information comprises:
a background scene captured by the camera that includes a signaling device participating in social overlay visualization; and
data derived from dynamic visual signals generated by the signaling device overlaid on the background scene.

7. The non-transitory computer-readable medium of claim 6, wherein the program, when executed, causes the processor to generate dynamic visual signal coding for a participant of social overlay visualization based on a dynamic vicinity designation and a light signal generation unit interface associated with the participant.

8. The non-transitory computer-readable medium of claim 6, wherein the program, when executed, causes the processor to generate socialization overlay data for a participant of social overlay visualization based on observed dynamic visual signals and a social overlay visualization interface unit associated with the participant.

9. The non-transitory computer-readable medium of claim 6, wherein the program, when executed, causes the processor to forward information between a dynamic signaling control system and a signal generation unit.

10. The non-transitory computer-readable medium of claim 6, wherein the program, when executed, causes the processor to capture images and decode a dynamic visual signal related to said social overlay visualization.

11. A method, comprising:
receiving, by a processor, a request related to social overlay visualization; and
generating, by the processor, information for social overlay visualization based on images captured by a camera; wherein the information comprises:
a background scene captured by the camera that includes a signaling device participating in social overlay visualization; and
data derived from dynamic visual signals generated by the signaling device overlaid on the background.

12. The method of claim 11, further comprising generating dynamic visual signal coding for a participant of social overlay visualization based on a dynamic vicinity designation and a light signal generation unit interface associated with the participant.

13. The method of claim 11, further comprising generating socialization overlay data for a participant of social overlay visualization based on observed dynamic visual signals and a social overlay visualization interface unit associated with the participant.

14. The method of claim 11, further comprising forward information between a dynamic signaling control system and a signal generation unit.

15. The method of claim 11, further comprising capturing images and decoding a dynamic visual signal related to said social overlay visualization.
